(19) United States
(12) Patent Application Publication
(10) Pub. No.: US 2014/0118333 A1
(43) Pub. Date: May 1, 2014

(54) INFORMATION PROCESSING APPARATUS, DISPLAY APPARATUS, CONTROL METHOD FOR AN INFORMATION PROCESSING APPARATUS, AND PROGRAM

(71) Applicant: Sony Corporation, Tokyo (JP)

(72) Inventor: Minoru Ishida, Tokyo (JP)

(73) Assignee: SONY CORPORATION, Tokyo (JP)

(21) Appl. No.: 14/061,790

(22) Filed: Oct. 24, 2013

(30) Foreign Application Priority Data
Oct. 26, 2012 (JP) 2012-236784

(51) Int. Cl. G09G 3/20

(52) U.S. Cl. CPC G09G 3/20
USPC 345/214

(57) ABSTRACT

An information processing apparatus includes imaging units and a display control unit. The imaging units are arranged, on a surface almost parallel to a display surface of a display unit, in a direction almost orthogonal to a long side of the display unit. The display control unit controls, in a state in which the long side of the display unit is almost parallel to a direction of gravitational force, the display unit to display a plurality of areas of a horizontally long image, which is obtained by connecting images generated by the imaging units, in rows in a longitudinal direction of the display unit. The display control unit controls the display unit to display, as those areas, first and second images including areas of both end portions in a longitudinal direction of the horizontally long image, and a third image including an area present between the both end portions.

### CROSS REFERENCE TO RELATED APPLICATIONS

This application claims the benefit of Japanese Priority Patent Application JP 2012-236784 filed Oct. 26, 2012, the entire contents of which are incorporated herein by reference.

### BACKGROUND

The present disclosure relates to an information processing apparatus. More particularly, the present disclosure relates to an information processing apparatus that displays an image, a display apparatus, and a control method for such an information processing apparatus, and a program that causes a computer to execute such a method.

Imaging apparatuses such as a digital still camera and a digital video camera (e.g., camera-integrated recorder) have prevailed in recent years. The imaging apparatus includes an imaging system that images a subject such as a person, and records an image generated by the imaging system as an image file.

Further, an imaging apparatus capable of generating an image (e.g., panoramic image) taken in an imaging area relatively widened in a specific direction by combining a plurality of images has been proposed. For example, the following imaging apparatus has been proposed. The imaging apparatus includes three imaging systems and generates a panoramic image by arranging and combining images output from the respective imaging systems (see, for example, Japanese Patent Application Laid-open No. 2007-166317, for example).

### SUMMARY

With the above-mentioned apparatuses in the related art, it is possible to easily take a panoramic image.

When a person stands upright on the ground, eyes of the person are horizontal to the ground. Therefore, an area that the person can view is wide in left- and right-hand directions (horizontal direction (direction parallel to ground, direction perpendicular to direction of gravitational force)) and narrow in upper and lower directions (vertical direction (direction perpendicular to ground, direction parallel to direction of gravitational force)). When the person captures a panoramic image, an image (image long in horizontal direction) reflecting a vision of the person that is wide in the left- and right-hand directions is often recorded. However, an information processing apparatus such as a smart phone and a cell phone including an imaging unit is often used in a vertical state (with longitudinal direction thereof being parallel to direction of gravitational force). Therefore, it is assumed that, when the information processing apparatus is used in the vertical state, a panoramic image cannot be appropriately displayed on the display unit in the vertical state and it is difficult to view the panoramic image.

In view of the above-mentioned circumstances, it is desirable to appropriately display an image.

According to a first embodiment of the present disclosure, there is provided an information processing apparatus including: a plurality of imaging units that are arranged, on a surface almost parallel to a display surface of a display unit, in a direction almost orthogonal to a long side of the display unit; and a display control unit configured to control, in a state in which the long side of the display unit is almost parallel to a direction of gravitational force, the display unit to display a plurality of areas of a horizontally long image in a plurality of rows in a longitudinal direction of the display unit, the horizontally long image being obtained by connecting a plurality of images generated by the plurality of imaging units, the display control unit being configured to control the display unit to display, as the plurality of areas of the horizontally long image, a first image and a second image being two images including areas of both end portions in a longitudinal direction of the horizontally long image, and a third image being an image including an area present between the both end portions. In addition, there are provided a control method for such an information processing apparatus and a program that causes a computer to execute such a method. This provides an effect of displaying, in the state in which the long side of the display unit is almost parallel to the direction of gravitational force, the plurality of areas of the horizontally long image in the plurality of rows in the longitudinal direction of the display unit, and of displaying, as the plurality of areas of the horizontally long image, the two images (first image and second image) including the areas of the both end portions in the longitudinal direction of the horizontally long image, and the image (third image) including the area present between the both end portions.

Further, according to a second embodiment of the present disclosure, there is provided an information processing apparatus including: a plurality of imaging units that are housed in a second casing being a casing attached to a first casing that houses a display unit and rotatable about an axis of rotation almost parallel to a short side of the display unit, and that are arranged on a surface of the second casing in a direction almost parallel to the axis of rotation; and a display control unit configured to control, in a state in which a long side of the display unit is almost parallel to a direction of gravitational force, the display unit to display a plurality of areas of a horizontally long image in a plurality of rows in a longitudinal direction of the display unit, the horizontally long image being obtained by connecting a plurality of images generated by the plurality of imaging units, the display control unit being configured to control the display unit to display, as the plurality of areas of the horizontally long image, a first image and a second image being two images including areas of both end portions in a longitudinal direction of the horizontally long image, and a third image being an image including an area present between the both end portions. In addition, there are provided an information processing method having such a configuration and a program that causes a computer to execute such a method. This provides an effect of displaying, in the state in which the long side of the display unit is almost parallel to the direction of gravitational force, the plurality of areas of the horizontally long image in the plurality of rows in the longitudinal direction of the display unit, and of displaying, as the plurality of areas of the horizontally long image, the two images (first image and second image) including the areas of the both end portions in the longitudinal direction of the horizontally long image, and the image (third image) including the area present between the both end portions.

Further, in the first and second embodiments, the display control unit may be configured to control the display unit to display the first image and the second image in the same row and the third image in another row. This provides an effect of displaying the first image and the second image in the same row and the third image in the other row.

Further, in the first and second embodiments, the display control unit may be configured to control the display unit to display the third image in a row above a row in which the first image and the second image are displayed. This provides an effect of displaying the third image in the row above the row in which the first image and the second image are displayed.

Further, in the first and second embodiments, the display unit may be configured to control the display unit to display the first image to the third image such that the third image has a horizontal size larger than a horizontal size of each of the first image and the second image. This provides an effect of displaying the first image to the third image such that the third image has the horizontal size larger than the horizontal size of each of the first image and the second image.

Further, in the first and second embodiments, the display control unit may be configured to control the display unit to display an image in an area other than display areas of the first image to the third image, the image being obtained by reducing a whole of the horizontally long image. This provides an effect of displaying the image in the area other than display areas of the first image to the third image, the image being obtained by reducing the whole of the horizontally long image.

Further, in the first and second embodiments, the information processing apparatus may further include an attitude detection unit configured to detect an attitude of the information processing apparatus, in which the display control unit may be configured to control, when the long side of the display unit is almost perpendicular to the direction of gravitational force, the display unit to display the first image to the third image in a smaller number of rows than the number of rows when the long side of the display unit is almost parallel to the direction of gravitational force. This provides an effect of displaying, when the long side of the display unit is almost perpendicular to the direction of gravitational force, the first image to the third image in a smaller number of rows than the number of rows when the long side of the display unit is almost parallel to the direction of gravitational force.

Further, in the first and second embodiments, the display control unit may be configured to control, when controlling the display unit to display an image being a display target that has a ratio of a horizontal size to a vertical size smaller than a ratio of a horizontal size to a vertical size of the horizontally long image, the display unit to display the first image to the third image in a smaller number of rows than the number of rows when the horizontally long image is displayed. This provides an effect of displaying, when displaying the image being the display target that has the ratio of the horizontal size to the vertical size smaller than the ratio of the horizontal size to the vertical size of the horizontally long image, the first image to the third image in the smaller number of rows than the number of rows when the horizontally long image is displayed.

Further, in the first and second embodiments, the information processing apparatus may further include a specific-target detection unit configured to detect a specific target included in the horizontally long image, in which the display control unit may be configured to control the display unit to display an image including an area in which the detected specific target is present, as the third image. This provides an effect of displaying the image including the area in which the detected specific target is present, as the third image.

Further, in the first and second embodiments, the information processing apparatus may further include a record control unit configured to record, when recording the horizontally long image, specific-target information on a recording medium in association with the horizontally long image, the specific-target information relating to the area in which the specific target is present, in which the display control unit may be configured to control, when controlling the display unit to display the horizontally long image recorded on the recording medium, the display unit to display an image relating to the area in which the specific target is present using the specific-target information recorded in association with the horizontally long image. This provides an effect of displaying, when displaying the horizontally long image recorded on the recording medium, the image relating to the area in which the specific target is present using the specific-target information recorded in association with the horizontally long image.

Further, in the first and second embodiments, the display control unit may be configured to control the display unit to display the third image while moving an area displayed as the third image from one end portion to the other end portion of the both end portions. This provides an effect of displaying the third image while moving the area displayed as the third image from the one end portion to the other end portion of the both end portions of the horizontally long image.

Further, in the first and second embodiments, the information processing apparatus may further include an operation receiving unit configured to receive a switching instruction operation from a user that relates to a display method for the third image, in which the display control unit may be configured to select, based on the switching instruction operation, either one of a display method of displaying the third image while moving an area displayed as the third image from one end portion to the other end portion of the both end portions, and a display method of displaying a certain area as the third image without moving the area displayed as the third image, and to control the display unit to display the third image. This provides an effect of selecting, based on the switching instruction operation that relates to the display method for the third image, either one of the display method of displaying the third image while moving the area displayed as the third image from the one end portion to the other end portion of the both end portions, and the display method of displaying the certain area as the third image without moving the area displayed as the third image, and of displaying the third image.

Further, in the first and second embodiments, when the display method for the third image is switched, a display method according to the switching may be stored by the time a display of the third image based on the switching is completed, and when the horizontally long image is newly displayed after the display of the third image based on the switching is completed, the third image in the horizontally long image may be displayed using the stored display method. This provides an effect of storing, when the display method for the third image is switched, the display method according to the switching by the time the display of the third image based on the switching is completed, and of displaying, when the horizontally long image is newly displayed after the display of the third image based on the switching is completed, the third image in the horizontally long image using the stored display method.

Further, in the first and second embodiments, the information processing apparatus may further include an operation receiving unit configured to receive, when a reduced image obtained by reducing a whole of the horizontally long image is displayed in an area other than display areas of the first image to the third image, a designation operation for designating a position in the reduced image, in which the display control unit may be configured to control, if the third image is displayed by a display method of displaying the third image while moving an area displayed as the third image from one end portion to the other end portion of the both end portions of the horizontally long image when the designation operation is performed, the display unit to display an image including the position in the reduced image designated by the designation operation and a peripheral area thereof as a new third image, and perform a display of the third image while performing the movement with the position being a start point, and control, if the third image is displayed by a display method of displaying a certain area as the third image without moving the area displayed as the third image when the designation operation is performed, the display unit to display an image including the position and a peripheral area thereof as a new third image. This provides an effect of displaying, if the third image is displayed by the display method of displaying the third image while moving the area displayed as the third image from the one end portion to the other end portion of the both end portions when the designation operation is performed, the image including the position in the reduced image designated by the designation operation and the peripheral area thereof as the new third image, and performing the display of the third image while performing the movement with the position being the start point, and of displaying, if the third image is displayed by the display method of displaying the certain area as the third image without moving the area displayed as the third image when the designation operation is performed, the image including the position and the peripheral area thereof as the new third image.

Further, in the first and second embodiments, the display control unit may be configured to switch, during live view or during postview in accordance with a user operation, between a first display method of displaying the third image with a position of the third image in the horizontally long image being fixed and a second display method of displaying an image including an area in which a specific target included in the horizontally long image is present as the third image, and switch, during reproduction in accordance with a user operation, between a third display method of displaying the third image while moving an area displayed as the third image from one end portion to the other end portion of the both end portions and the second display method. This provides an effect of switching, during the live view or during the postview in accordance with the user operation, between the first display method and the second display method, and of switching, during the reproduction in accordance with the user operation, between the third display method and the second display method.

Further, in the first and second embodiments, the display control unit may be configured to switch, during live view in accordance with a user operation, between a first display method of displaying the third image with a position of the third image in the horizontally long image being fixed and a second display method of displaying an image including an area in which a specific target included in the horizontally long image is present as the third image, and switch, during postview or reproduction in accordance with a user operation, between a third display method of displaying the third image while moving an area displayed as the third image from one end portion to the other end portion of the both end portions and the second display method. This provides an effect of switching, during the live view in accordance with the user operation, between the first display method and the second display method, and of switching, during the postview or the reproduction in accordance with the user operation, between the third display method and the second display method.

Further, in the first and second embodiments, the display control unit may be configured to control, when the information processing apparatus is shipped from a factory or when a user uses the information processing apparatus, if an image display method by a live view operation of displaying an image generated by the imaging unit on the display unit before the user records the image, an image display method by a postview operation of displaying the recorded image on the display unit immediately after the user records the image, and an image display method by a reproduction operation of displaying an image specified by the user on the display unit are individually set, the display unit to display each image based on the setting. This provides an effect of displaying, when the information processing apparatus is shipped from the factory or when the user uses the information processing apparatus, if the image display method by the live view operation, the image display method by the postview operation, and the image display method by the reproduction operation are individually set, each image based on the setting.

Further, according to a third embodiment of the present disclosure, there is provided a display apparatus including: a display unit configured to display an image; and a display control unit configured to control, when controlling the display unit to display a horizontally long image in a state in which a long side of the display unit is almost parallel to a direction of gravitational force, the display unit to display a plurality of areas of the horizontally long image in a plurality of rows in a longitudinal direction of the display unit, the display control unit being configured to control the display unit to display, as the plurality of areas of the horizontally long image, a first image and a second image being two images including areas of both end portions in a longitudinal direction of the horizontally long image, and a third image being an image including an area present between the both end portions. In addition, there are provided a control method for such a display apparatus and a program that causes a computer to execute such a method. This provides an effect of displaying, when displaying the horizontally long image in the state in which the long side of the display unit is almost parallel to the direction of gravitational force, the plurality of areas of the horizontally long image in the plurality of rows in the longitudinal direction of the display unit, and of displaying, as the plurality of areas of the horizontally long image, the two images (first image and second image) including the areas of the both end portions in the longitudinal direction of the horizontally long image, and the image (third image) including the area present between the both end portions.

Further, in the third embodiment, the display control unit may be configured to control the display unit to display the first image and the second image in the same row and the third image in another row. This provides an effect of displaying the first image and the second image in the same row and the third image in the other row.

Further, in the third embodiment, the display control unit may be configured to control the display unit to display the third image in a row above a row in which the first image and the second image are displayed. This provides an effect of displaying the third image in the row above the row in which the first image and the second image are displayed.

Further, in the third embodiment, the display unit may be configured to control the display unit to display the first image to the third image such that the third image has a horizontal size larger than a horizontal size of each of the first image and the second image. This provides an effect of displaying the first image to the third image such that the third image has the horizontal size larger than the horizontal size of each of the first image and the second image.

Further, in the third embodiment, the display control unit may be configured to control the display unit to display an image in an area other than display areas of the first image to the third image, the image being obtained by reducing a whole of the horizontally long image. This provides an effect of displaying the image in the area other than the display areas of the first image to the third image, the image being obtained by reducing a whole of the horizontally long image.

Further, in the third embodiment, the display apparatus may further include an attitude detection unit configured to detect an attitude of the display apparatus, in which the display control unit may be configured to control, when the long side of the display unit is almost perpendicular to the direction of gravitational force, the display unit to display the first image to the third image in a smaller number of rows than the number of rows when the long side of the display unit is almost parallel to the direction of gravitational force. This provides an effect of displaying, when the long side of the display unit is almost perpendicular to the direction of gravitational force, the first image to the third image in a smaller number of rows than the number of rows when the long side of the display unit is almost parallel to the direction of gravitational force.

Further, in the third embodiment, the display control unit may be configured to control, when controlling the display unit to display an image being a display target that has a ratio of a horizontal size to a vertical size smaller than a ratio of a horizontal size to a vertical size of the horizontally long image, the display unit to display the first image to the third image in a smaller number of rows than the number of rows when the horizontally long image is displayed. This provides an effect of displaying, when displaying the image being the display target that has the ratio of the horizontal size to a the vertical size smaller than the ratio of the horizontal size to the vertical size of the horizontally long image, the first image to the third image in a smaller number of rows than the number of rows when the horizontally long image is displayed.

According to the embodiments of the present disclosure, it is possible to exert an excellent effect that an image can be appropriately displayed.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram of an outer-appearance configuration example of the information processing apparatus 100 in a first embodiment of the present disclosure;

FIG. 2 is a diagram of an internal configuration example of the information processing apparatus 100 in the first embodiment of the present disclosure;

FIG. 3 is a diagram of an internal configuration example of an imaging unit 130 in the first embodiment of the present disclosure;

FIG. 4 is a diagram of arrangement configuration examples of imaging devices 134 to 136 constituting the imaging unit 130 in the first embodiment of the present disclosure;

FIG. 5 is a diagram showing a relation among images focused on the imaging devices 134 to 136 in the first embodiment of the present disclosure and a method of reading out image data;

FIG. 6 is a diagram showing the relation among the images focused on the imaging devices 134 to 136 in the first embodiment of the present disclosure and the method of reading out image data;

FIG. 7 is a block diagram of an internal configuration example of a DSP 200 in the first embodiment of the present disclosure;

FIG. 8 is a block diagram of an internal configuration example of an image-signal processing unit 220 in the first embodiment of the present disclosure;

FIG. 9 is a block diagram of an internal configuration example of a clock generating circuit 270 in the first embodiment of the present disclosure;

FIG. 10 is a block diagram of a modified example of the clock generating circuit 270 in the first embodiment of the present disclosure;

FIG. 11 is a block diagram of a modified example of the clock generating circuit 270 in the first embodiment of the present disclosure;

FIG. 12 is a diagram of an internal configuration example of an imaging device in the first embodiment of the present disclosure;

FIG. 13 is a schematic diagram of stored contents of registers 370 and 380 of the imaging device 134 in the first embodiment of the present disclosure;

FIG. 14 is a schematic timing chart of states of control signals into pixels in the imaging device 134 in the first embodiment of the present disclosure and data output from the pixels;

FIG. 15 is a schematic timing chart of states of control signals into pixels in the imaging device 134 in the first embodiment of the present disclosure and data output from the pixels;

FIG. 16 is a schematic timing chart of states of control signals into pixels in the imaging device 134 in the first embodiment of the present disclosure and data output from the pixels;

FIG. 17 is a schematic diagram of an example of a scanning circuit for performing thinning-out of the imaging device 134 in the first embodiment of the present disclosure;

FIG. 18 is a diagram showing a relation between the imaging unit 130 and a subject in the first embodiment of the present disclosure;

FIG. 19 is a schematic diagram showing a relation between each of imaging systems in the imaging unit 130 in the first embodiment of the present disclosure and a subject as an imaging target of the imaging systems;

FIG. 20 is a schematic diagram showing relations between the imaging systems in the imaging unit 130 in the first embodiment of the present disclosure and subjects as imaging targets of the imaging systems;

FIG. 21 is a schematic diagram showing relations between the imaging systems in the imaging unit 130 in the first embodiment of the present disclosure and captured images generated by the imaging systems;

FIG. 22 is a schematic diagram showing a relation between each of the imaging systems in the imaging unit 130 in the first embodiment of the present disclosure and a subject as an imaging target of the imaging systems;

FIG. 23 is a schematic diagram showing relations between the imaging systems in the imaging unit 130 in the first embodiment of the present disclosure and captured images generated by the imaging systems and corrected images after correction;

FIG. 24 is a schematic diagram of a flow of combination when an image combination processing unit 224 in the first embodiment of the present disclosure generates a combined image;

FIG. 25 is a schematic diagram of a flow of combination when the image combination processing unit 224 in the first embodiment of the present disclosure generates a combined image;

FIG. 26 is a schematic diagram of a flow of combination when the image combination processing unit 224 in the first embodiment of the present disclosure generates a combined image;

FIG. 27 is a diagram of an example of a file structure of an image file to be stored in a recording medium 180 in the first embodiment of the present disclosure;

FIG. 28 is a block diagram of a functional configuration example of the information processing apparatus 100 in the first embodiment of the present disclosure;

FIG. 29 is a diagram showing a relation between a subject as an imaging target and an imaging area of imaging processing by the information processing apparatus 100 in the first embodiment of the present disclosure;

FIG. 30 is a diagram showing a relation between a panoramic image 600 generated by an image generation unit 510 in the first embodiment of the present disclosure and images displayed on a display unit 140 by a display control unit 550;

FIG. 31 is a diagram showing a relation between the panoramic image 600 generated by the image generation unit 510 in the first embodiment of the present disclosure and images displayed on the display unit 140 by the display control unit 550;

FIG. 32 is a diagram showing a relation between the panoramic image 600 generated by the image generation unit 510 in the first embodiment of the present disclosure and images displayed on the display unit 140 by the display control unit 550;

FIG. 33 is a diagram showing a relation between the panoramic image 600 generated by the image generation unit 510 in the first embodiment of the present disclosure and images displayed on the display unit 140 by the display control unit 550;

FIG. 34 is a diagram showing a relation between the panoramic image 600 generated by the image generation unit 510 in the first embodiment of the present disclosure and images displayed on the display unit 140 by the display control unit 550;

FIG. 35 is a diagram showing a relation between the panoramic image 600 generated by the image generation unit 510 in the first embodiment of the present disclosure and images as a display target and a display example of the display unit 140;

FIG. 36 is a diagram of display examples of a panoramic image displayed on the display unit 140 in the first embodiment of the present disclosure and images as the display target;

FIG. 37 is a diagram showing relations between panoramic images 650, 655, and 660 generated by the image generation unit 510 in the first embodiment of the present disclosure and middle images 651, 656, and 661;

FIG. 38 is a diagram showing relations between panoramic images 665, 670, and 675 generated by the image generation unit 510 in the first embodiment of the present disclosure and middle images 666, 671, and 676;

FIG. 39 is a diagram of display examples of the panoramic image generated by the image generation unit 510 in the first embodiment of the present disclosure and the images (middle image, left image, and right image);

FIG. 40 is a diagram of a display example in which a panoramic image generated by the image generation unit 510 in the first embodiment of the present disclosure and images (middle image, left image, and right image);

FIG. 41 is a diagram of a transition example of an area of the middle image in the panoramic image generated by the image generation unit 510 in the first embodiment of the present disclosure;

FIG. 42 is a diagram of display examples of the panoramic image generated by the image generation unit 510 in the first embodiment of the present disclosure and the images (middle image, left image, and right image);

FIG. 43 is a diagram of display examples of the panoramic image generated by the image generation unit 510 in the first embodiment of the present disclosure and the images (middle image, left image, and right image);

FIG. 44 is a diagram of display examples of the panoramic image generated by the image generation unit 510 in the first embodiment of the present disclosure and the images (middle image, left image, and right image);

FIG. 45 is a diagram showing a relation between the panoramic image 600 generated by the image generation unit 510 in the first embodiment of the present disclosure and images as the display target and a display example of the display unit 140;

FIG. 46 is a diagram of display examples when the panoramic image generated by the image generation unit 510 in the first embodiment of the present disclosure is displayed on the display unit 140;

FIG. 47 is a diagram of a modified example of the information processing apparatus 100 in the first embodiment of the present disclosure;

FIG. 48 is a diagram of the modified example of the information processing apparatus 100 in the first embodiment of the present disclosure;

FIG. 49 is a diagram of a modified example of the information processing apparatus 100 in the first embodiment of the present disclosure;

FIG. 50 is a diagram of a modified example of the information processing apparatus 100 in the first embodiment of the present disclosure;

FIG. 51 is a diagram of the modified example of the information processing apparatus 100 in the first embodiment of the present disclosure;

FIG. 52 is a diagram of a display example of an image generated by the information processing apparatus in the first embodiment of the present disclosure;

FIG. 53 is a diagram of a display example of an image generated by the information processing apparatus in the first embodiment of the present disclosure;

FIG. 54 is a diagram of a display example of images generated by the information processing apparatus in the first embodiment of the present disclosure;

FIG. 55 is a diagram of a display example of images generated by the information processing apparatus in the first embodiment of the present disclosure;

FIG. 56 is a diagram of a display example of images generated by the information processing apparatus in the first embodiment of the present disclosure;

FIG. 57 is a diagram of a display example of images generated by the information processing apparatus in the first embodiment of the present disclosure;

FIG. 58 is a flow chart showing an example of a processing procedure of display control processing by the information processing apparatus 100 in the first embodiment of the present disclosure;

FIG. 59 is a flow chart showing an example of an imaging processing procedure of a display control processing procedure by the information processing apparatus 100 in the first embodiment of the present disclosure;

FIG. 60 is a flowchart showing an example of a panoramic imaging processing procedure of the display control processing procedure by the information processing apparatus 100 in the first embodiment of the present disclosure;

FIG. 61 is a flowchart showing an example of a reproduction processing procedure of the display control processing procedure by the information processing apparatus 100 in the first embodiment of the present disclosure;

FIG. 62 is a flowchart showing an example of the processing procedure of the display control processing by the information processing apparatus 100 in the first embodiment of the present disclosure;

FIG. 63 is a flowchart showing an example of the panoramic imaging processing procedure of the display control processing procedure by the information processing apparatus 100 in the first embodiment of the present disclosure;

FIG. 64 is a flowchart showing an example of the reproduction processing procedure of the display control processing procedure by the information processing apparatus 100 in the first embodiment of the present disclosure;

FIG. 65 is a flowchart showing an example of a vertical-state panoramic reproduction processing procedure of the display control processing procedure by the information processing apparatus 100 in the first embodiment of the present disclosure;

FIG. 66 is a flowchart showing an example of a horizontal-state panoramic reproduction processing procedure of the display control processing procedure by the information processing apparatus 100 in the first embodiment of the present disclosure;

FIG. 67 is a diagram of an outer-appearance configuration example of an information processing apparatus 1000 in the second embodiment of the present disclosure;

FIG. 68 is a diagram of the outer-appearance configuration example of the information processing apparatus 1000 in the second embodiment of the present disclosure;

FIG. 69 is a diagram of an outer-appearance configuration example of an information processing apparatus 1050 in the second embodiment of the present disclosure; and

FIG. 70 is a diagram of the outer-appearance configuration example of the information processing apparatus 1050 in the second embodiment of the present disclosure.

### DETAILED DESCRIPTION OF EMBODIMENTS

Hereinafter, embodiments for carrying out the present disclosure (hereinafter, referred to as embodiments) will be described. Descriptions will be made in the following order.

1. First Embodiment (display control: example of displaying plurality of areas of panoramic image in plurality of rows in longitudinal direction of display unit)

2. Second Embodiment

### 1. First Embodiment

### Outer-Appearance Configuration Example of Information Processing Apparatus

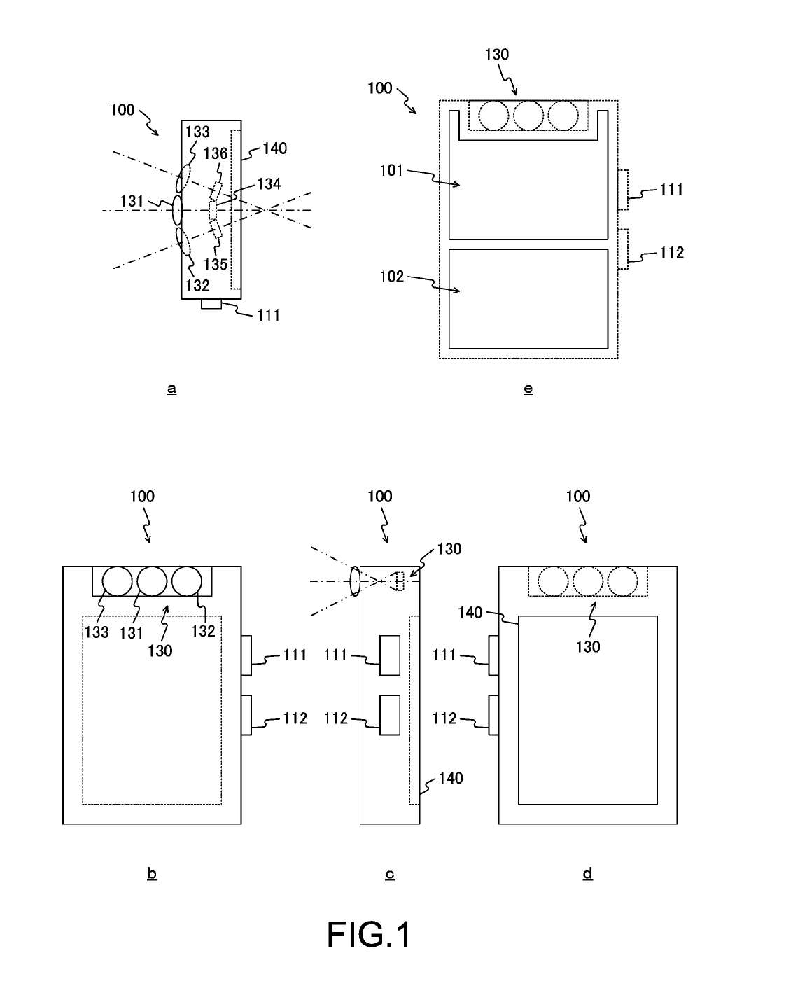

FIG. 1 is a diagram of an outer-appearance configuration example of the information processing apparatus 100 in the first embodiment of the present disclosure. Part “a” of FIG. 1 is a top view of the information processing apparatus 100, and Part “b” of FIG. 1 is a front view of the information processing apparatus 100. Further, Part “c” of FIG. 1 is a side view of the information processing apparatus 100, and Part “d” of FIG. 1 is a rear view of the information processing apparatus 100. Further, Part “e” of FIG. 1 shows an arrangement example of an electronic substrate of the information processing apparatus 100.

The information processing apparatus 100 is realized by an information processing apparatus (e.g., smart phone with multi eye camera and cell phone with multi eye camera) including a plurality of imaging units, for example. Note that, for the sake of description, the information processing apparatus 100 is simplified and shown in FIG. 1 and illustration of a power-supply switch and the like provided in an outer side surface of the information processing apparatus 100 is omitted. Further, illustration of details of a circuit and the like provided within a casing of the information processing apparatus 100 is also omitted. Note that the information processing apparatus 100 is an example of an information processing apparatus and a display apparatus described in scope of claims.

In the first embodiment of the present disclosure, a ratio of a horizontal size to a vertical size of an image is defined as an “aspect ratio” and described. Further, an image having an aspect ratio larger than the aspect ratio (16:9) of a digital Hi-vision image (high-definition television image) is defined as “panoramic image” and described.

The information processing apparatus 100 includes an electronic substrate 101, a battery storage unit 102, a changeover switch 111, a determination key 112, an imaging unit 130, and a display unit 140.

The electronic substrate 101 is an electronic substrate that mainly performs functions other than an image-capturing function. In the first embodiment of the present disclosure, a plurality of imaging systems (imaging unit 130) arranged parallel to a short side of the casing of the information processing apparatus 100 are arranged as close as possible to an outer edge of the short side of the casing. That is, the electronic substrate that performs the functions other than the image-capturing function and a image-displaying function is not provided between the plurality of imaging systems (imaging unit 130) and the outer edge of the short side of the casing. Otherwise, it is favorable that the area of the electronic substrate provided between the plurality of imaging systems (imaging unit 130) and the outer edge of the short side of the casing is set to be ½ or less of the area of the electronic substrate that is arranged in the information processing apparatus 100 and performs the functions other than the image-capturing function and the image-displaying function.

The battery storage unit 102 is an area in which a battery is stored.

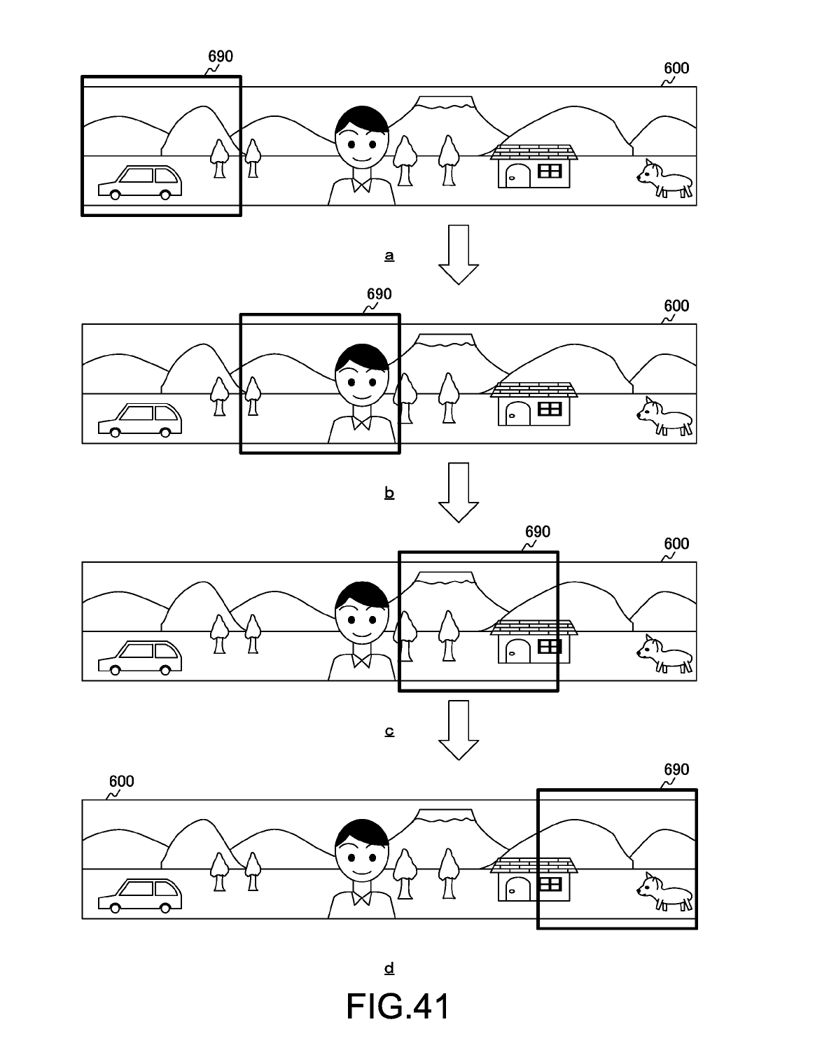

The changeover switch 111 is an operation member (so-called toggle switch) used for switching two functions. For example, the changeover switch 111 is used for switching to either one of a still-image capturing mode for recording a still image and a moving-image capturing mode for recording a moving image. Further, for example, the changeover switch 111 is used for changing a scroll method (whether or not to perform scroll shown in FIGS. 41 to 43).

The determination key 112 is an operation member that is pressed for setting various functions by a user. For example, when being pressed on the still-image capturing mode, the determination key 112 functions as a shutter button.

Note that a numeric keypad or an arrow key is appropriately displayed on the display unit 140 according to a user operation or automatically. Then, the displayed numeric keypad or the arrow key can be operated by the user.

The imaging unit 130 serves to image a subject and generate image data. Note that, in the first embodiment of the present disclosure, the generation of the image data by the imaging unit 130 includes the meaning of imaging by the imaging unit 130. Note that circles in the imaging unit 130 shown in Part “b” of FIG. 1 schematically represent lenses of the plurality of imaging systems of the imaging unit 130. That is, in the first embodiment of the present disclosure, the imaging unit 130 in which three lens groups are arranged in a specific direction is described as an example. Further, as shown in Part “a” of FIG. 1, it is assumed that an optical axis (optical axis passing through optical system 131 and enters imaging device 134) of the middle lens group (optical system 131) of the three lens groups is orthogonal (or almost orthogonal) to a display surface of the display unit 140. Further, as shown in Part “a” of FIG. 1, it is assumed that optical axes of the three lens groups (optical systems 131 to 133) cross at one point. The specific direction may be, for example, a direction orthogonal to a longitudinal direction of the display unit 140 (longitudinal direction of information processing apparatus 100). Note that portions constituting the imaging unit 130 shown in FIG. 1 are simplified and shown for the sake of description.

The display unit 140 is a display apparatus that displays various images, and configured by a touch panel, for example. For example, an image generated by an imaging operation is displayed on the display unit 140. For example, a liquid crystal display (LCD) panel or an organic electro luminescence (EL) panel may be used as the display unit 140. By the way, an aspect ratio of the display unit 140 of an information processing apparatus with a camera (e.g., smart phone with multi eye camera) or a general imaging apparatus is often 4:3 or 16:9. Therefore, in the first embodiment of the present disclosure, an example in which the aspect ratio of the display unit 140 is 4:3 is described.

As shown in Parts “b” to “d” of FIG. 1, a state in which the longitudinal direction of the information processing apparatus 100 is set to be identical to a vertical direction (direction parallel to direction of gravitational force) will be referred to as a vertical state of the information processing apparatus 100. Further, a state in which the longitudinal direction of the information processing apparatus 100 is set to be identical to a horizontal direction (direction perpendicular to direction of gravitational force) (i.e., state in which the information processing apparatus 100 in the vertical state is rotated by 90 degrees with an axis orthogonal to the display surface of the display unit 140 being an axis of rotation) will be referred to as a horizontal state of the information processing apparatus 100.

The multi-eye information processing apparatus 100 is used as described above, and hence, for example, in the case where a panoramic image being a still image is captured, images captured by the plurality of imaging systems at the same time can be coupled to form the panoramic image immediately after a shutter button is pressed. Note that a single-eye imaging apparatus capable of generating a panoramic image by an operation of rotating an imaging apparatus in the horizontal direction with an imaging position (position of photographer) being a center of rotation (so-called panning operation) exists. In the case where a panoramic image is generated by the single-eye imaging apparatus, the panning operation is necessary as described above. Therefore, the panoramic image cannot be generated immediately after the shutter button is pressed. In contrast, the information processing apparatus 100 can capture a panoramic image for a shorter time in comparison with the single-eye imaging apparatus.

[Internal Configuration Example of Information Processing Apparatus]

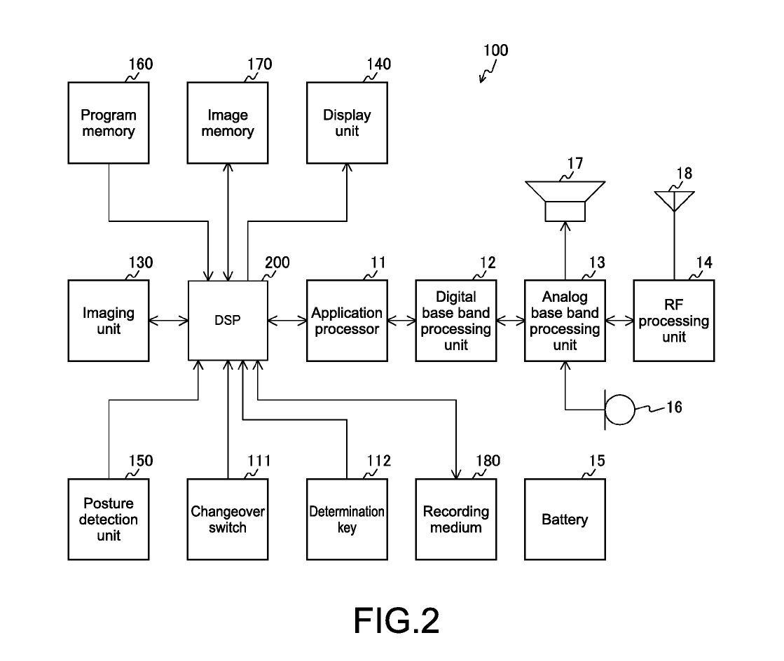

FIG. 2 is a diagram of an internal configuration example of the information processing apparatus 100 in the first embodiment of the present disclosure.

The information processing apparatus 100 includes an application processor 11, a digital base band processing unit 12, an analog base band processing unit 13, and a radio frequency (RF) processing unit 14. The information further processing apparatus 100 includes a battery 15, a microphone 16, a speaker 17, an antenna 18, a changeover switch 111, a determination key 112, the imaging unit 130, and the display unit 140. Further, the information processing apparatus 100 further includes an attitude detection unit 150, a program memory 160, an image memory 170, a recording medium 180, and a digital signal processor (DSP) 200. Note that the RF processing unit 14 includes the antenna 18 and the analog base band processing unit 13 includes the microphone 16 and the speaker 17.

The application processor 11 controls each unit of the information processing apparatus 100 based on various programs stored in a built-in memory. The application processor 11 includes, for example, a central processing unit (CPU), a read only memory (ROM), and a random access memory (RAM).

For example, in the case where a telephone reception operation is performed, radio waves received by the antenna 18 are demodulated by the digital base band processing unit 12 through the RF processing unit 14 and the analog base band processing unit 13. Then, a demodulation result of the digital base band processing unit 12 is output from the speaker 17 through the analog base band processing unit 13.

On the other hand, in the case where a telephone transmission operation is performed, sound input from the microphone 16 is modulated by the digital base band processing unit 12 through the analog base band processing unit 13. Then, demodulated audio data is transmitted from the antenna 18 through the analog base band processing unit 13 and the RF processing unit 14.

Further, when the user performs an imaging-operation starting instruction operation, the imaging operation is performed in the information processing apparatus 100. For example, when the user performs the imaging-operation starting instruction operation, the application processor 11 instructs respective units (imaging unit 130, DSP 200, and the like) involved in the imaging operation to start the imaging operation, and activates those units. Then, the activated units perform the imaging operation and a generated image is displayed on the display unit 140. When the user performs an image recording instruction operation, the generated image is recorded on the recording medium 180. Further, when the user performs an instruction operation to wirelessly transmit an image, the generated image is wirelessly transmitted. For example, generated image data is modulated by the digital base band processing unit 12 and transmitted from the antenna 18 through the analog base band processing unit 13 and the RF processing unit 14. Note that the battery 15 is a battery that supplies power to the information processing apparatus 100.

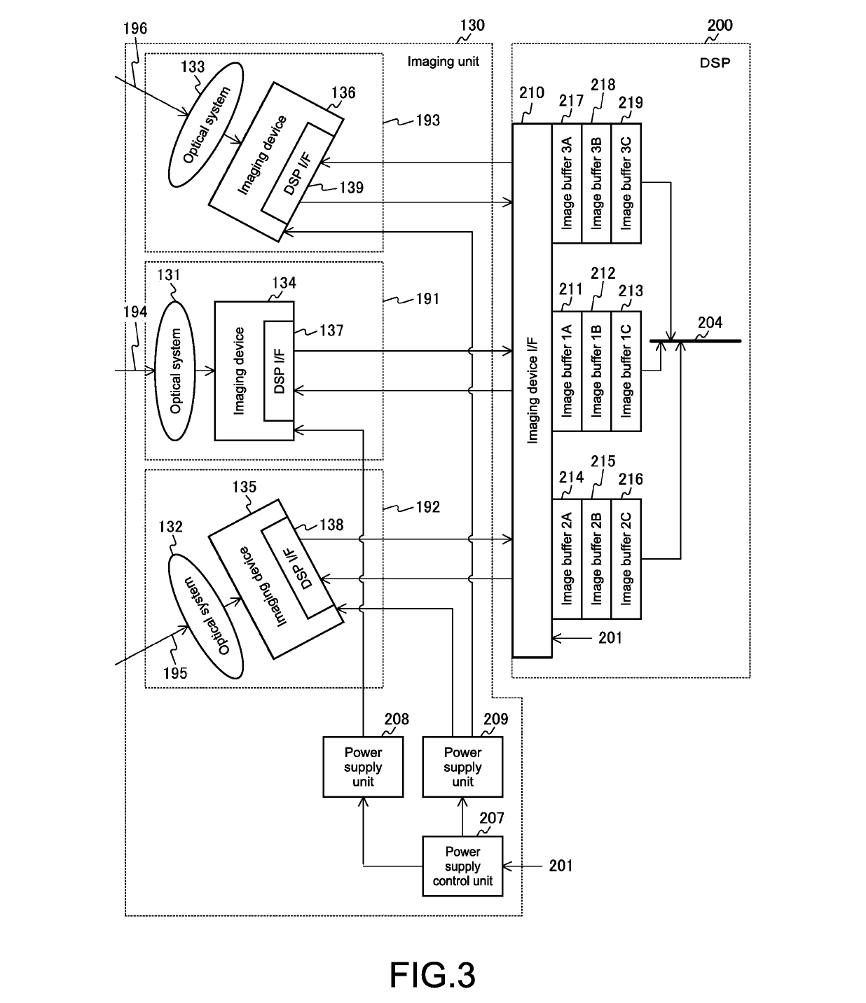

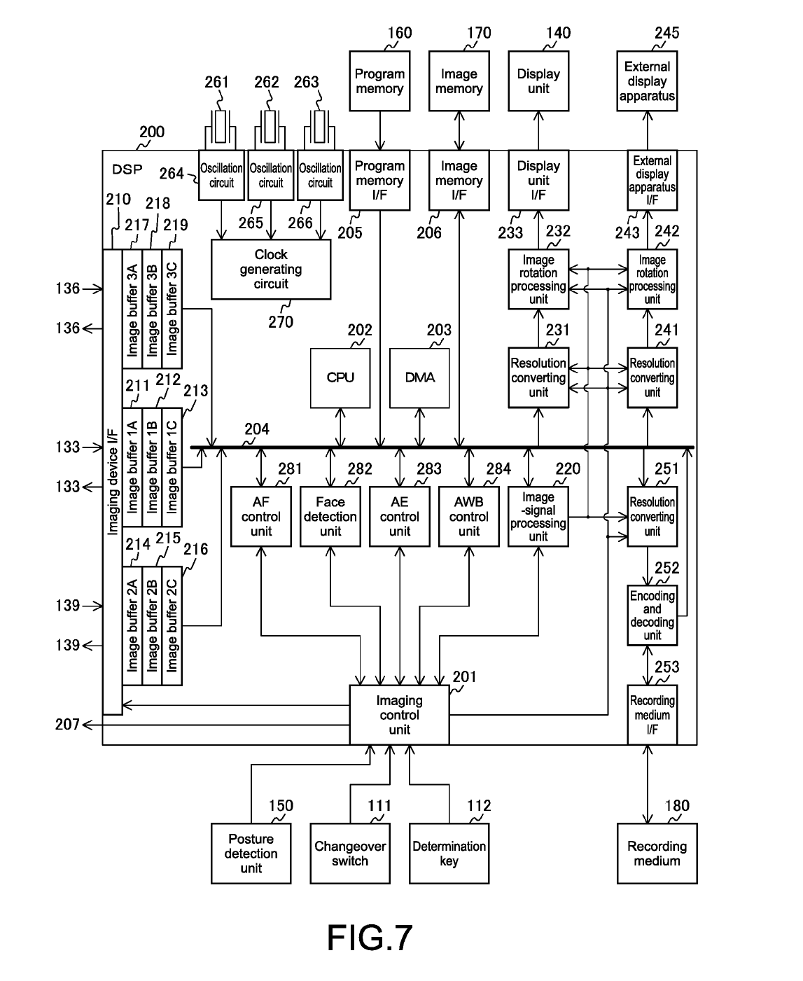

Note that the changeover switch 111, the determination key 112, the imaging unit 130, the display unit 140, the attitude detection unit 150, the program memory 160, the image memory 170, the recording medium 180, and the DSP 200 will be described in detail with reference to FIGS. 3 and 7 and the like.

[Internal Configuration Example of Imaging Unit]

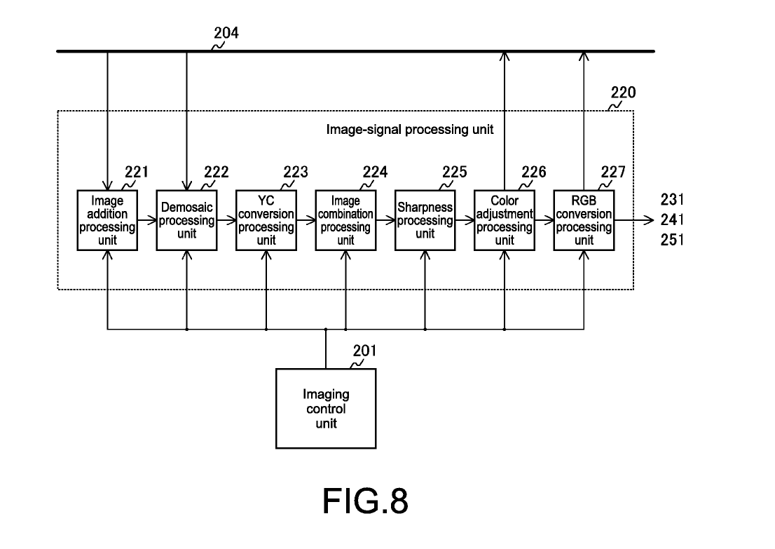

FIG. 3 is a diagram of an internal configuration example of the imaging unit 130 in the first embodiment of the present disclosure. Further, FIG. 3 shows part of the DSP 200 to be connected to the imaging unit 130. Note that an entire configuration of the DSP 200 will be described in detail with reference to FIGS. 7 and 8.

The imaging unit 130 includes three imaging systems (first imaging system 191 to third imaging system 193), a power-supply control unit 207, and power-supply units 208 and 209. Further, three imaging systems are arranged in a specific direction. That is, the first imaging system 191 is arranged in the middle while the second imaging system 192 and the third imaging system 193 are arranged on both sides of the first imaging system 191.

The first imaging system 191 includes an optical system 131, the imaging device 134, and an interface (I/F) 137 with the DSP. Further, the second imaging system 192 includes an optical system 132, an imaging device 135, and an I/F 138 with the DSP. Further, the third imaging system 193 includes an optical system 133, an imaging device 136, and an I/F 139 with the DSP. Note that the configurations of the first imaging system 191 to the third imaging system 193 are almost the same. Therefore, the configuration of the first imaging system 191 is mainly described and descriptions of the second imaging system 192 and the third imaging system 193 are omitted.

The optical system 131 is constituted of a plurality of lenses (including zoom lens and focus lens) that collect light from a subject. Further, the amount of light passing through those lenses (i.e., exposure) is adjusted by a diaphragm (not shown). Then, the collected light from the subject is input into the imaging device 134.

The imaging device 134 is an imaging device that focuses a subject image input via the optical system 131 and generates an image signal. That is, the imaging device 134 receives light from the subject input via the optical system 131 and performs photoelectric conversion, to thereby generate an analog image signal depending on the amount of light received. The analog image signal thus generated by the imaging device 134 is provided to the DSP 200 via the I/F 137 with the DSP. Note that, for example, a solid-state imaging device of a charge coupled device (CCD) type or a complementary metal oxide semiconductor (CMOS) type may be used as the imaging device.

The I/F 137 with the DSP is an interface for connecting the imaging device 134 and the DSP 200 to each other.

The power-supply control unit 207 controls, based on a power-supply controlling instruction from an imaging control unit 201 (shown in FIG. 7) of the DSP 200, the power-supply units 208 and 209. That is, when receiving the power-supply controlling instruction from the imaging control unit 201, the power-supply control unit 207 creates signals according to amplitude, rate of rise, and rate of decay of signal that are demanded by the power-supply units 208 and 209 as input specifications of control signals. Then, the power-supply control unit 207 outputs the created signals to the power-supply units 208 and 209 to control the power-supply units 208 and 209. Note that, if output signals of the imaging control unit 201 comply with the input specifications of the control signals for the power-supply units 208 and 209, the output signals of the imaging control unit 201 may be directly input into the power-supply units 208 and 209.

The power-supply unit 208 supplies power to the first imaging system 191 based on a control of the power-supply control unit 207. Further, the power-supply unit 209 supplies power to the second imaging system 192 and the third imaging system 193 based on a control of the power-supply control unit 207. Note that the power-supply units 208 and 209 are realized by, for example, a commercially available power-supply integrated circuit (IC).

Further, each of the first imaging system 191 to the third imaging system 193 is connected to the DSP 200 via a single data line and seven kinds of signal lines. A description is made with the single data line that connects the first imaging system 191 and the DSP 200 to each other being denoted by L1 and the seven kinds of signal lines being referred to as signal lines L2 to L8. Note that the data line and signal lines of the second imaging system 192 and the third imaging system 193 are almost the same as the data line and signal lines of the first imaging system 191. Therefore, the data line and signal lines of the first imaging system 191 are mainly described and descriptions of the second imaging system 192 and the third imaging system 193 are omitted.

The data line L1 is a data line for transmitting image data from the imaging device 134 to the DSP 200. This data line L1 is favorably constituted of a plurality of data lines for increasing a transmission rate of image data, for example. Further, in order to increase the transmission rate of image data and increasing a noise resistance on a transmission path, a high-speed and differential-transmission data line is favorably used as the data line L1. For example, a low voltage differential signaling (LVDS) is favorably used for the data line L1.

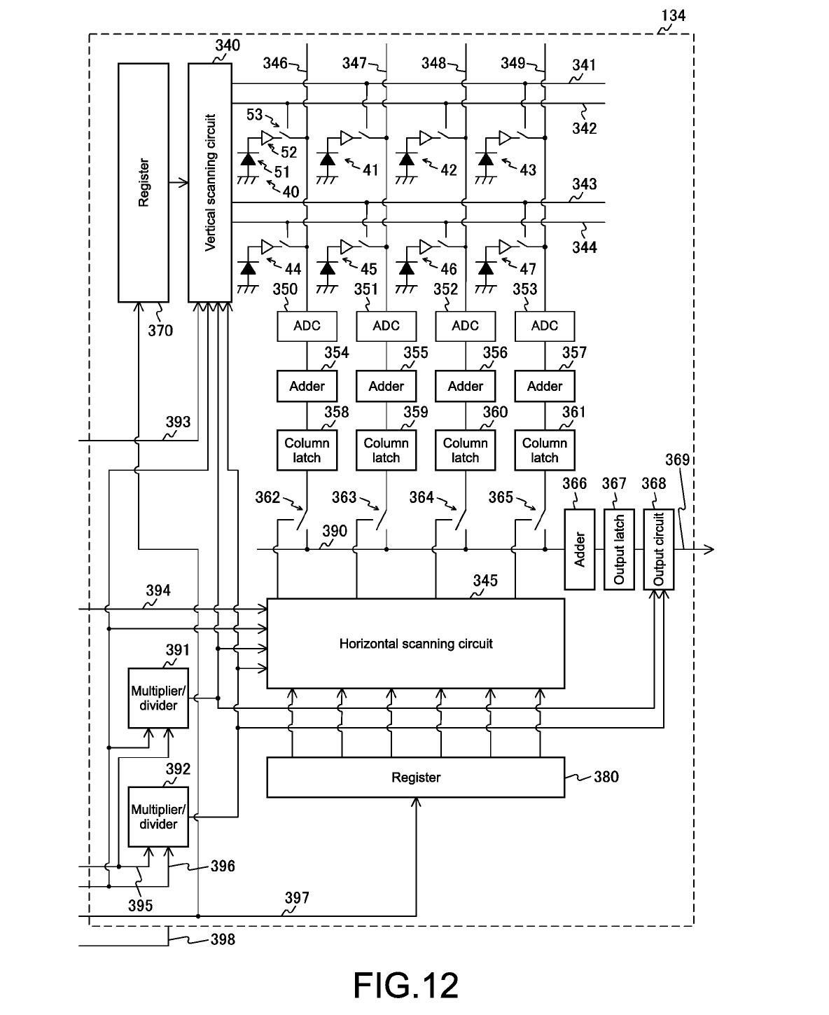

The signal line L2 is a bi-directional communication line between the imaging device 134 and the DSP 200. For example, a four-line-structure serial communication line may be used as the signal line L2. The signal line L2 is used when various setting values necessary for using the imaging device 134 are set from a side of the DSP 200, for example. As an example, setting values for thinning-out image data output from the imaging device 134 to the DSP 200 and outputting the thinned-out image data are written in registers 370 and 380 (shown in FIG. 12) from the DSP 200 via the signal line L2.

The signal line L3 is a clock signal line for supplying a clock from the DSP 200 to the imaging device 134. Using a clock supplied via the signal line L3, the imaging device 134 performs an imaging operation at one pixel per clock cycle. Alternatively, a multiplier may be installed in the imaging device 134, the clock supplied from the DSP 200 may be multiplied in the imaging device 134, and the imaging operation at one pixel per clock cycle after the multiplication may be performed.

The signal line L4 is a reset signal line for supplying a reset signal from the DSP 200 to the imaging device 134.

The signal line L5 is a signal line for controlling ON and OFF of the imaging operation of the imaging device 134 from the DSP 200. That is, the signal line L5 is a signal line for notifying the stop and start of operation from the DSP 200 to each imaging device. For example, if the execution of an imaging mode on which only one imaging device is used out of the three imaging systems is instructed by the user, power consumption can be reduced by stopping the imaging operations of the two imaging devices not used.

The signal line L6 is a vertical synchronization signal line. That is, the signal line L6 is a signal line for notifying a synchronization signal indicating imaging timing for each frame from the DSP 200 to the imaging device 134.

The signal line L7 is a horizontal synchronization signal line. That is, the signal line L7 is a signal line for notifying a synchronization signal indicating imaging timing for each line in one frame from the DSP 200 to imaging device 134.

The signal line L8 is a shutter signal line. For example, when an operation member (e.g., determination key 114) for performing captured image recording is depressed by the user in the information processing apparatus 100, a shutter signal corresponding to this depression is notified from the DSP 200 to the imaging device 134 via the signal line L8.

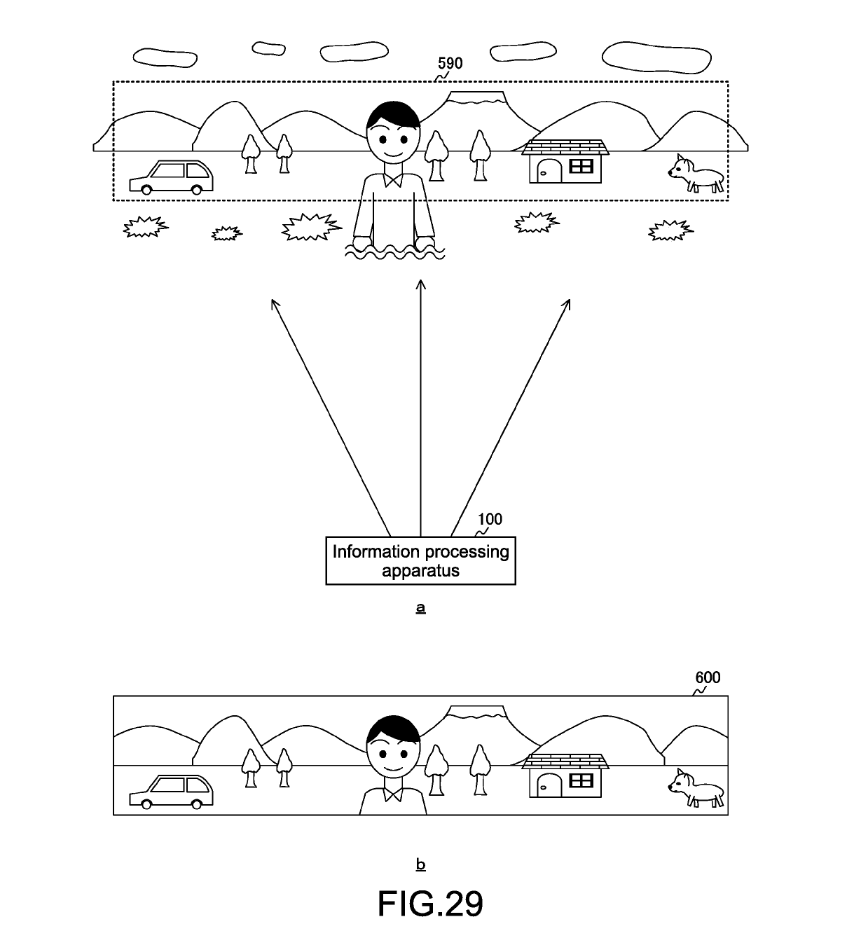

Further, it is assumed that, in the case where an imaging mode is set, either one of a single-eye imaging operation and a multi-eye imaging operation can be selected based on the user operation. If the single-eye imaging operation is selected, an imaging operation using image data generated by the first imaging system 191 is performed. On the other hand, if the multi-eye imaging operation is selected, an imaging operation using image data each generated by the first imaging system 191 to the third imaging system 193 is performed. Further, if the single-eye imaging operation is selected, a normal image is generated. If the multi-eye imaging operation is selected, a panoramic image (e.g., shown in Part “b” of FIG. 29) is generated.

[Arrangement Configuration Examples of Imaging Devices]

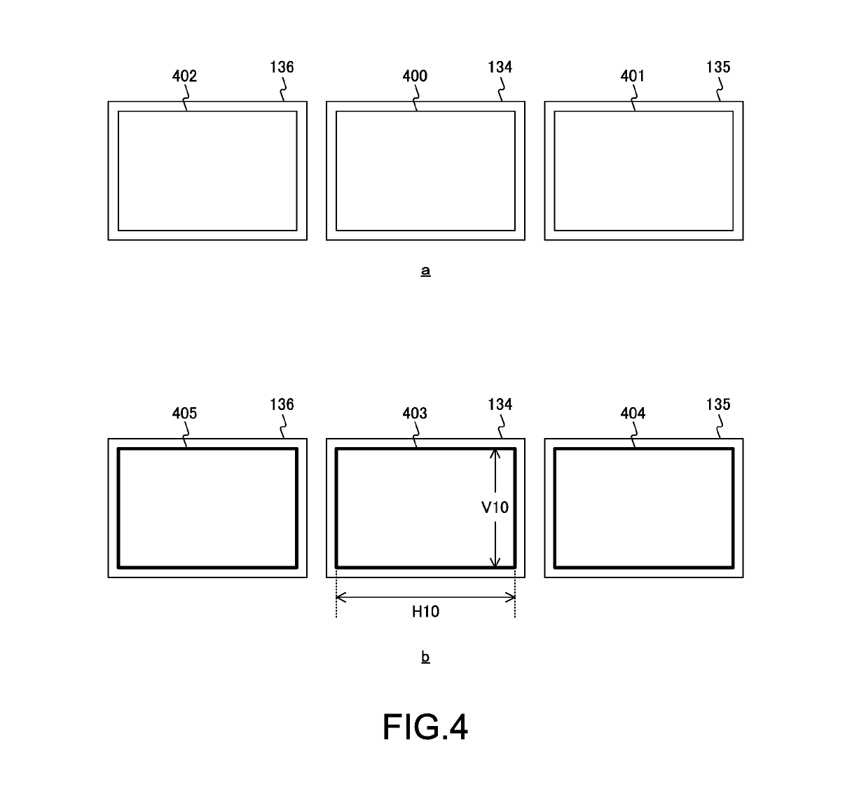

FIG. 4 is a diagram of arrangement configuration examples of the imaging devices 134 to 136 constituting the imaging unit 130 in the first embodiment of the present disclosure.

In Part “a” of FIG. 4, arrangement configurations of the imaging devices 134 to 136 are shown. In general, a shape of an area where pixels are arrayed on a light receiving surface of an imaging device is an almost rectangular shape. Therefore, in the following description, the imaging devices 134 to 136 are schematically represented by rectangles.

In Part “a” of FIG. 4, an arrangement configuration example in setting the longitudinal direction of the information processing apparatus 100 in the vertical direction is shown. Specifically, the imaging device 134 is arranged in the center and the imaging devices 135 and 136 are arranged on both sides of the imaging device 134. Further, the imaging devices 134 to 136 are arranged such that a longitudinal direction thereof almost coincides with the arraying direction. The imaging devices 134 to 136 are arranged such that center positions thereof are on the same plane. Specifically, in the arraying direction, the imaging devices 134 to 136 are arranged in horizontal direction.

In Part “a” of FIG. 4, pixel data readout possible areas 400 to 402 where pixels can be read out are schematically indicated by rectangles in the imaging devices 134 to 136. For example, a first captured image with a specific direction of a subject set in a longitudinal direction is generated by the imaging device 134. A second captured image with a specific direction thereof set in a longitudinal direction and including a subject adjacent to one side of the subject included in the first captured image is generated by the imaging device 135. A third image with a specific direction thereof set in a longitudinal direction and including a subject adjacent to the other side of the subject included in the first captured image is generated by the imaging device 136.

Note that the center imaging device of the three imaging devices constituting the imaging unit may be arranged such that the longitudinal direction of the center imaging device almost coincides with the direction orthogonal to the arraying direction (see, for example, Japanese Patent Application Laid-open No. 2011-44837.)

In Part “b” of FIG. 4, an example of a pixel data readout area in which image data is generated when the information processing apparatus 100 is in the vertical state is shown. Pixel data readout areas 403 to 405 are examples of areas from which pixels are read out when image data used for display or recording are generated in the pixel data readout possible areas 400 to 402. In Part “b” of FIG. 4, contours of the pixel data readout areas 403 to 405 are indicated by thick lines. The pixel data readout areas 403 to 405 can be set the same as, for example, the pixel data readout possible areas 400 to 402. In the pixel data readout area 403 to 405, length in the vertical direction can be denoted by V10 and length in the horizontal direction can be denoted by H10, for example.

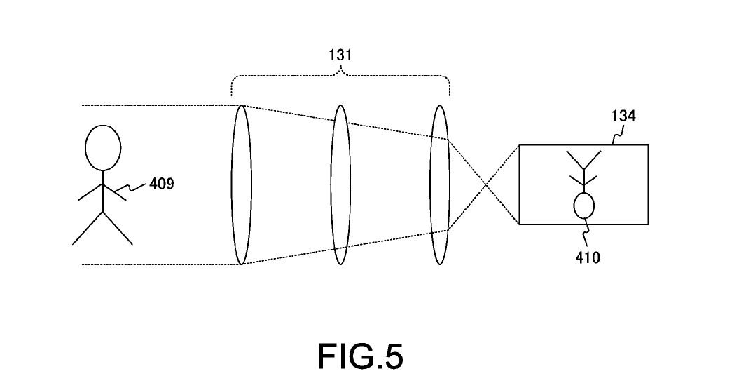

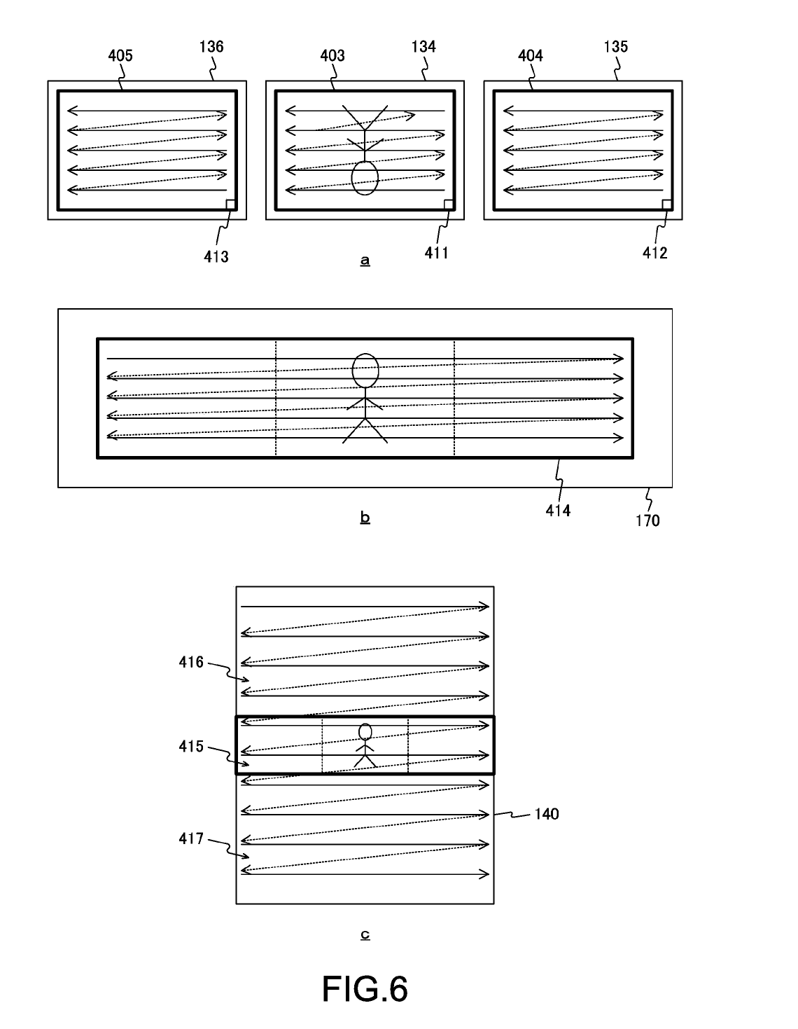

FIGS. 5 and 6 are diagrams showing a relation between images focused on the imaging devices 134 to 136 in the first embodiment of the present disclosure and a method of reading out image data. In general, an inverted image is focused on an imaging device.

FIG. 5 is a schematic diagram showing a relation among a subject 409, the optical system 131, and a captured image 410 focused on the imaging device 134 when an inverted image is generated as an image focused on an imaging device. As shown in FIG. 5, light from the subject 409 made incident via the optical system 131 is focused on the imaging device 134 and the captured image 410 is generated. In this case, an up to down direction of the subject 409 and an up to down direction of the captured image 410 are reversed.

In Part “a” of FIG. 6, readout start positions 411 to 413 and a readout direction in reading out pixel data from the imaging devices 134 to 136 are schematically shown. In this example, pixel data are read out in the pixel data readout areas 403 to 405 shown in Part “b” of FIG. 4. In the following description, a readout start position in a pixel data readout area is schematically indicated by a rectangle. For example, readout is sequentially started from the readout start positions 411 to 413 at lower right corners of the pixel data readout areas 403 to 405 and pixel data are read out in an arrow direction. For example, in the pixel data readout area 403, readout of pixel data is started from the readout start position 411 and readout of pixel data is sequentially performed while being shifted by one pixel at a time in the arrow direction. When readout of a pixel located at an end in one line in the horizontal direction (left end in the pixel data readout area 403 shown in Part “a” of FIG. 6) is performed, read out of a pixel located at the other end is performed while being shifted to an upper side by one pixel in a line as a readout object. Thereafter, readout of pixels is sequentially performed in the same manner. When readout of a pixel located at an end in a line at the upper end in the pixel data readout area 403 is performed, readout processing for the imaging device 134 is completed. Readout processing is simultaneously performed concerning the imaging devices 135 and 136.

In Part “b” of FIG. 6, a combined image 414 on the image memory 170 in which pixel data read out from the imaging devices 134 to 136 are combined is schematically shown. In this example, pixel data read out by the readout method shown in Part “a” of FIG. 6 are combined. It is assumed that an arrow direction in the combined image 414 is an arranging direction of image data on the image memory 170.

In Part “c” of FIG. 6, a display example of a combined image obtained when pixel data read out from the imaging devices 134 to 136 are displayed in the display unit 140 is shown. In this example, the combined image 414 shown in Part “b” of FIG. 6 is displayed. For example, the combined image 414 is displayed in a captured image display area 415 and a single-color image (e.g., black image or white image) is displayed in margin image display areas 416 and 417 above and below the captured image display area 415. It is assumed that an arrow direction in the display unit 140 is a scanning direction in the display unit 140.

[Configuration Example of DSP]

FIG. 7 is a block diagram of an internal configuration example of the DSP 200 in the first embodiment of the present disclosure.

The DSP 200 includes the imaging control unit 201, a CPU 202, direct memory access (DMA) controller 203, a data bus 204, a program memory I/F 205, and an image memory I/F 206. The DSP 200 further includes an image device I/F 210, image buffers 211 to 219, an image-signal processing unit 220, resolution converting units 231, 241, and 251, and image rotation processing units 232 and 242. The DSP 200 further includes a display unit I/F 233, an external display apparatus I/F 243, an encoding/decoding unit 252, a recording medium I/F 253, oscillating circuits 264 to 266, and a clock generating circuit 270. The DSP 200 further includes an auto focus (AF) control unit 281 and a face detection unit 282. The DSP 200 further includes an automatic exposure (AE) control unit 283 and an auto white balance (AWB) control unit 284. The CPU 202, the DMA controller 203, the image memory I/F 206, the image buffers 211 to 219, the image-signal processing unit 220, and the like are connected to the data bus 204. Signals from the changeover switch 111, the determination key 112, and the attitude detection unit 150 are input to the imaging control unit 201.

The attitude detection unit 150 detects a change of an attitude of the information processing apparatus 100 by detecting acceleration, motion, tilt, and the like of the information processing apparatus 100, and outputs a detection result (attitude information relating to detected attitude change) to the imaging control unit 201. For example, the attitude detection unit 150 detects, as the attitude change of the information processing apparatus 100, rotation angles about three axes (e.g., X-axis, Y-axis, and Z-axis) and outputs a detection result thereof to the imaging control unit 201. A sensor capable of detecting the rotation angles about the three axes in the information processing apparatus 100 can be used as the attitude detection unit 150. It should be noted that a sensor capable of detecting a rotation angle about at least one axis may be used. For example, a fall sensor, a gravity sensor, a gyro sensor, an acceleration sensor capable of detecting a acceleration direction, and an angular velocity sensor capable of detecting a rotational motion can be used as the attitude detection unit 150.

The imaging control unit 201 controls the units related to imaging processing. For example, the imaging control unit 201 determines, on the basis of a detection result from the attitude detection unit 150, an attitude of the information processing apparatus 100 and performs imaging control for the units on the basis of a result of the determination. The imaging control unit 201 performs imaging control for the units on the basis of input signals from the changeover switch 111 and the determination key 112.

In the first embodiment of the present disclosure, the user can set in advance an imaging mode (image size, etc.) in recording an image generated by the imaging unit 130. For example, a menu screen for setting the imaging mode is displayed on the display unit 140. The user inputs desired setting content using the determination key 114 on the menu screen. The imaging mode includes, for example, the number of imaging devices used during imaging and a vertical image size and a horizontal image size of an image during recording. For example, the imaging mode includes a vertical back porch and a vertical front porch representing an interval between a valid area of an image and a vertical synchronization signal and a horizontal back porch and a horizontal front porch representing an interval between the valid area of the image and a horizontal synchronization signal. The imaging control unit 201, the units in the DSP 200, and the imaging devices 134 to 136 include registers that store the imaging mode.

When the imaging mode is set by the user, the imaging control unit 201 notifies the units in the DSP 200 and the imaging devices 134 to 136 of the set imaging mode and causes the registers included in the units to store the imaging mode. In this way, the setting content of the imaging mode set by the user is stored in the registers included in the units. Consequently, the user can easily switch and use a plurality of photographing conditions.

The imaging control unit 201 notifies, for example, on the basis of the setting content of the imaging mode stored in the register incorporated therein, the units in the DSP 200 and the imaging devices 134 to 136 of a vertical synchronization signal, a horizontal synchronization signal, and a clock signal. The imaging control unit 201 notifies, for example, on the basis of the setting content of the imaging mode stored in the register incorporated therein, the units related to display in the DSP 200 and the display unit 140 of the vertical synchronization signal, the horizontal synchronization signal, and the clock signal. The imaging control unit 201 outputs, for example, to the power-supply control unit 207, a signal for controlling ON and OFF of a power supply.

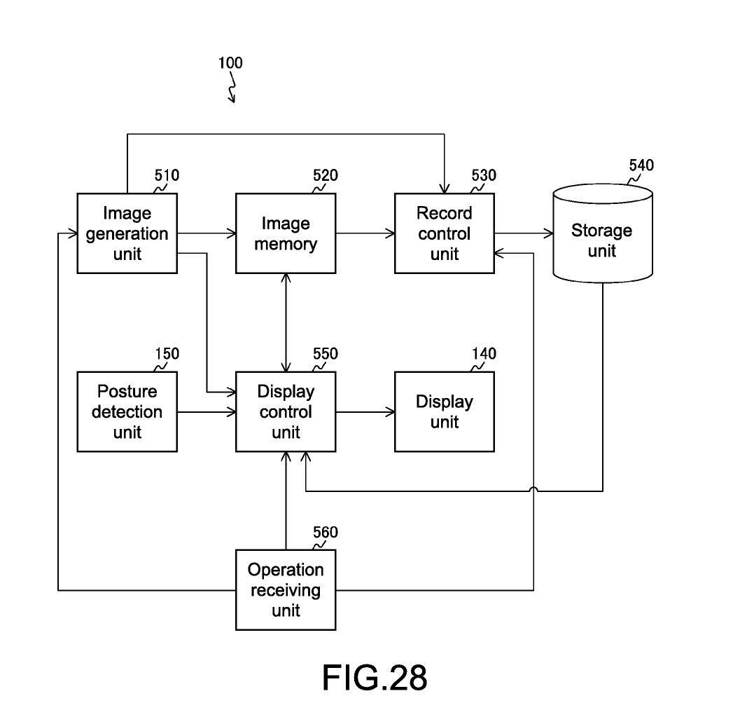

The CPU 202 controls the entire DSP 200 on the basis of various programs stored in the program memory 160. For example, the CPU 202 detects, on the basis of a detection result (attitude information) from the attitude detection unit 150, which of the horizontal state and the vertical state the information processing apparatus 100 (display unit 140) is in, and performs display control on the basis of the detected state. The control content will be described in detail with reference to FIG. 28.

The DMA controller 203 controls transfer of data among memories on the basis of the control by the CPU 202.

The program memory I/F 205 is an interface for connecting the program memory 160 and the DSP 200.

The image memory I/F 206 is an interface for connecting the image memory 170 and the DSP 200.

The imaging device I/F 210 is an interface for connecting the imaging devices 134 to 136 and the DSP 200. Specifically, image data generated by the imaging devices 134 to 136 are input to the imaging device I/F 210. For example, when the data line L1 for transmitting the image data from the imaging devices 134 to 136 is an LVDS type having micro amplitude, the image data from the imaging devices 134 to 136 is converted into GND potential or power supply potential in the DSP I/Fs 137 to 139. The image buffers 211 to 219 in three systems corresponding to the imaging devices 134 to 136 are provided at a post stage of the imaging device I/F 210.

The image buffers 211 to 219 are image buffers that store the image data output from the imaging devices 134 to 136. The stored image data are written in the image memory 170 via the data bus 204. For example, three image buffers are provided for each of the imaging devices. The image buffers are connected to the data bus 204. For example, three image buffers 211 to 213 are provided for the imaging device 134. Three image buffers 214 to 216 are provided for the imaging device 135. Three image buffers 217 to 219 are provided for the imaging device 136. In the first embodiment of the present disclosure, even while the image data are read out from the image buffers 211 to 219 in order to write the image data in the image memory 170, image data input anew from the imaging devices 134 to 136 are sequentially stored in the image buffers 211 to 219. Therefore, it is favorable to provide two or more image buffers for each of the imaging devices 134 to 136 as the image buffers 211 to 219.

It is favorable that a capacity of one of the image buffers 211 to 219 is larger than bit width of the data bus 204. For example, when the data bus 204 has 128-bit width, it is favorable that the image buffers have a capacity equal to or larger than 128 bits. It is more favorable that the capacity of one of the image buffers 211 to 219 is equal to or lager than a double of the bit width of the data bus 204. For example, when the data bus 204 has 128-bit width, it is favorable that the image buffers have a capacity equal to or larger than 256 bits.

On the other hand, the capacity of one of the image buffers 211 to 219 can be set to be equal to or smaller than an image data amount of one image generated by one imaging device. For example, it is favorable that the capacity of one of the image buffers 211 to 219 is equal to or smaller than a data amount of image data generated by pixels for one line of the imaging device 134.

In the first embodiment of the present disclosure, bit width of a data line connecting the imaging devices 134 to 136 and the DSP 200 is set to, for example, 12 bits. For example, bit width of the data bus 204 of the DSP 200 is set to 128-bit width and the capacity of one of the image buffers 211 to 219 is set to 128 bits. The image-signal processing unit 220 applies, on the basis of the control by the imaging control unit 201, various kinds of image signal processing to image data input via the image buffers 211 to 219 and the data bus 204. The internal configuration of the image-signal processing unit 220 will be described in detail with reference to FIG. 8.

The resolution converting unit 231 performs, on the basis of the control by the imaging control unit 201 or the CPU 202, resolution conversion for causing the display unit 140 to display images and outputs image data subjected to the resolution conversion to the image rotation processing unit 232.

The resolution converting unit 241 performs, on the basis of the control by the imaging control unit 201 or the CPU 202, resolution conversion for causing an external display device 245 to display images and outputs image data subjected to the resolution conversion to the image rotation processing unit 242.

The image rotation processing unit 232 applies, on the basis of the control by the imaging control unit 201 or the CPU 202, rotation processing to the image data subjected to the resolution conversion and outputs the image data subjected to the rotation processing to the display unit I/F 233.

The image rotation processing unit 242 applies, on the basis of the control by the imaging control unit 201 or the CPU 202, rotation processing to the image data subjected to the resolution conversion and outputs the image data subjected to the rotation processing to the external display device I/F 243.

The display unit I/F 233 is an interface for connecting the display unit 140 and the DSP 200.

The external display device I/F 243 is an interface for connecting the external display device 245 and the DSP 200. The external display device 245 is, for example, a television.

The resolution converting unit 251 converts, on the basis of the control by the imaging control unit 201 or the CPU 202, resolution for recording of images and outputs image data subjected to the resolution conversion to the encoding/decoding unit 252. For example, the resolution converting unit 251 performs resolution conversion processing for converting resolution to a recorded image size desired by the user and resolution conversion processing for generating a thumbnail image.

The encoding/decoding unit 252 performs, on the basis of the control by the imaging control unit 201 or the CPU 202, encoding for compressing image data output from the resolution converting unit 251, and outputs the encoded image data to the recording medium I/F 253. Further, for displaying image data recorded on the recording medium 180 on the display unit 140, the encoding/decoding unit 252 inputs and encodes the image data recorded on the recording medium 180 via the recording medium I/F 253. The encoded image data is stored in the image memory 170.

The recording medium I/F 253 is an interface for connecting the recording medium 180 and the DSP 200.

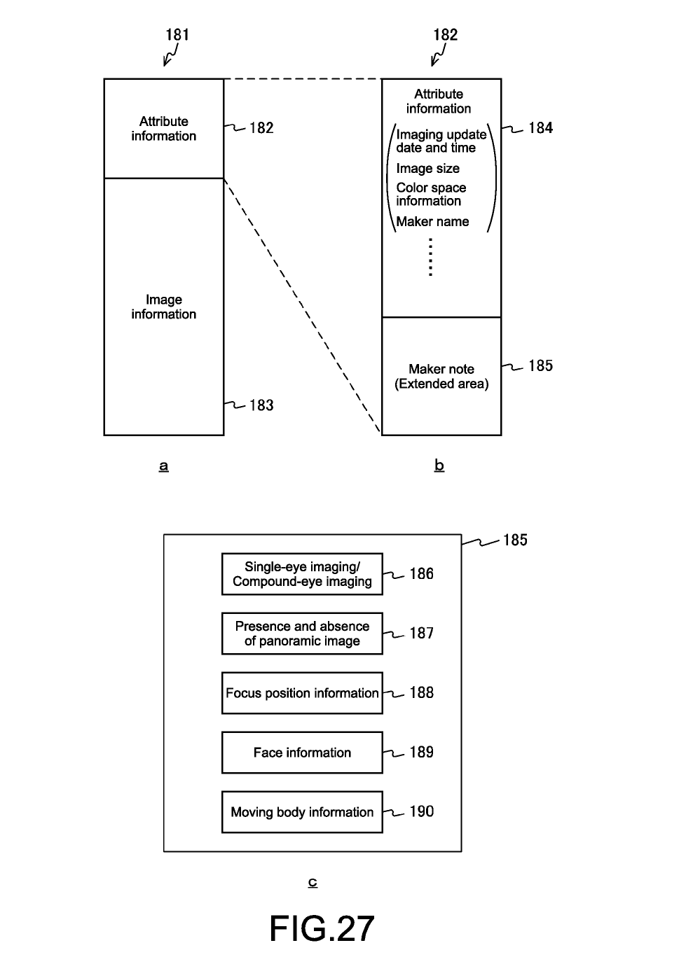

The recording medium 180 is a recording medium that records the image data supplied via the recording medium I/F 253. The recording medium 180 may be incorporated in the information processing apparatus 100 or may be detachably attached to the information processing apparatus 100. As the recording medium 180, for example, a tape (e.g., magnetic tape) or an optical disk (e.g., recordable digital versatile disc (DVD)) can be used. As the recording medium 180, for example, a magnetic disk (e.g., hard disk), a semiconductor memory (e.g., memory card), or a magneto-optical disk (e.g., MiniDisc (MD)) may be used. Note that the image data recorded on the recording medium 180 will be described in detail with reference to FIG. 27.

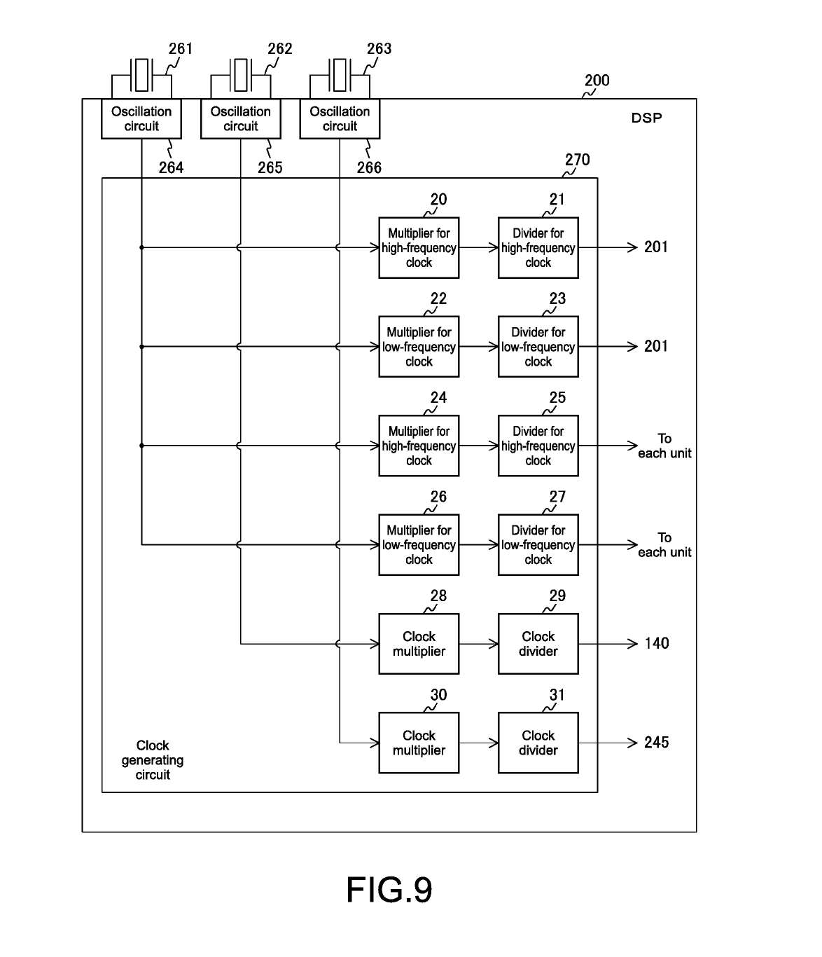

Note that the oscillating circuits 264 to 266 and the clock generating circuit 270 will be described in detail with reference to FIGS. 9 to 11.

The AF control unit 281 performs focus control on image data input via the image buffers 211 to 219 and the data bus 204 so as to be focused on the subject included in a predetermined area in that image (captured image). Note that the predetermined area can be, for example, an area in the middle of the captured image, an area specified by the user, or an area including a position of a face detected by the face detection unit 282. Further, when a plurality of predetermined areas are present, focus control is performed for each of the predetermined areas. Then, information on a position (focus position) focused in the captured image is output to the CPU 202 and the imaging control unit 201. Further, the information on the focus position is stored in the AF control unit 281.

The face detection unit 282 detects a face of a person included in an image (captured image) of the image data input via the image buffers 211 to 219 and the data bus 204, and outputs a detection result thereof to the CPU 202 and the imaging control unit 201. Alternatively, the face detection unit 282 may detect a face of a person included in an image of image data read out from the recording medium 180. Note that, as a method of detecting a face included in an image, for example, a face detection method by matching between a template in which luminescence distribution information of a face is recorded and a content image can be used (for example, see Japanese Patent Application Laid-open No. 2004-133637). A face detection method based on a skin-color part or the amount of feature of a human face included in an image can also be used. Those face detection methods make it possible to determine a position and a size of a face of a person in an image. Further, a detection result of a face is stored in the face detection unit 282. Note that the face detection unit 282 is an example of a specific-target detection unit described in scope of claims.

The AE control unit 283 is an automatic exposure control unit for automatically adjusting a shutter speed and a stop value with respect to the image data input via the image buffers 211 to 219 and the data bus 204, and outputs a detection result thereof to the CPU 202 and the imaging control unit 201.

The AWB control unit 284 performs automatic white balance adjustment and the like on the image data input via the image buffers 211 to 219 and the data bus 204, and outputs a detection result thereof to the CPU 202 and the imaging control unit 201.

[Internal Configuration Example of Image-Signal Processing Unit 220]

FIG. 8 is a block diagram of an internal configuration example of the image-signal processing unit 220 in the first embodiment of the present disclosure.

The image-signal processing unit 220 includes a pixel addition processing unit 221, a demosaic processing unit 222, a YC conversion processing unit 223, an image combination processing unit 224, a sharpness processing unit 225, a color adjustment processing unit 226, and an RGB conversion processing unit 227.

The pixel addition processing unit 221 applies pixel addition processing and pixel thinning-out processing to the image data generated by the imaging devices 134 to 136.

The demosaic processing unit 222 performs demosaic processing (interpolation processing) such that intensities of all channels for R, G, and B are set the same in pixel positions of the image data (mosaic images) generated by the imaging devices 134 to 136. The demosaic processing unit 222 supplies RGB images subjected to the demosaic processing to the YC conversion processing unit 223. Specifically, the demosaic processing unit 222 interpolates Bayer data having only pixel data for one color per one pixel and calculates three pixel data of R, G, and B for one pixel.

The YC conversion processing unit 223 applies YC matrix processing and band limitation for chroma components to the RGB images generated by the demosaic processing unit 222 to thereby generate a luminance signal (Y) and a color difference signal (Cr, Cb). The generated luminance signal (Y image) and color difference signal (C image) are supplied to the image combination processing unit 224.

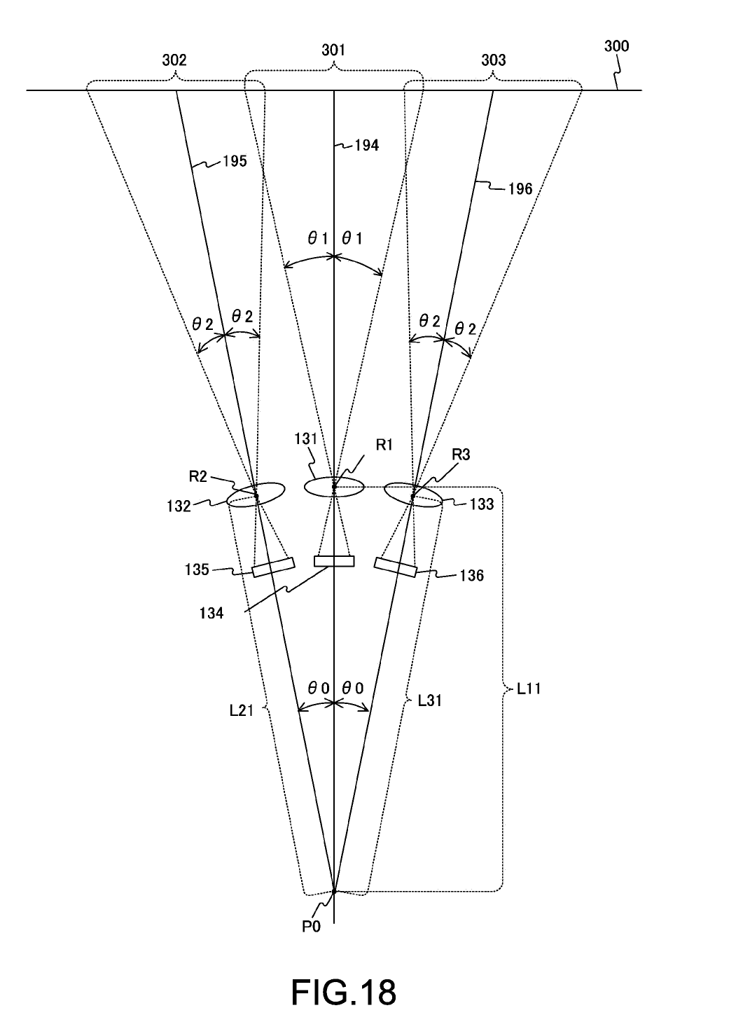

The image combination processing unit 224 applies image combination to the image data generated by the YC conversion processing unit 223 and outputs the combined image data to the sharpness processing unit 225. Note that this image combination processing will be described in detail with reference to FIGS. 18 to 26.

The sharpness processing unit 225 applies sharpness processing (processing for highlighting contour of subject) for extracting a portion with a large signal change and highlighting the portion to the image data generated by the image combination processing unit 224. The sharpness processing unit 225 supplies the image data subjected to the sharpness processing to the color adjustment processing unit 226.

The color adjustment processing unit 226 applies adjustment of a hue and chroma to the image data subjected to the sharpness processing by the sharpness processing unit 225.

The RGB conversion processing unit 227 converts the image data subjected to the adjustment of a hue and chroma by the color adjustment processing unit 226 from YCbCr data to RGB data.

A flow of image data of a signal of the image-signal processing unit 220 is described. For example, it is assumed that each of signal processing units in the image-signal processing unit 220 directly reads image data from the image memory 170 through the data bus 204 and writes the image data after signal processing into the image memory 170 through the data bus 204. This is advantageous in that the image-signal processing unit 220 can read image data in a desired position in the image data at desired timing. However, a data amount that needs to be transmitted through the data bus 204 increases, and hence it is necessary to increase an operating frequency of the data bus 204. Therefore, there is a fear that design of the data bus 204 is difficult and power consumption increases.

For example, it is assumed that each of the signal processing units in the image-signal processing unit 220 receives image data from a signal processing unit at a pre-stage not through the data bus 204 and passes the image data after the signal processing to a signal processing unit at a post-stage not through the data bus 204. In this case, the data bus 204 is not used. This is advantageous in that design of an LSI is easy and power consumption can be reduced. However, there is a fear that each of the signal processing units is not able to read image data in a desired position in the image data at desired timing.

Therefore, in the first embodiment of the present disclosure, between the demosaic processing unit 222 and the color adjustment processing unit 226 having a substantially fixed image size, in order to reduce the operating frequency of the data bus 204 and power consumption, image data is directly passed among the signal processing units. At a pre-stage of a signal processing unit that uses a large amount of image data as in resolution conversion, when image data is written in the image memory 170 and the resolution conversion is performed, desired image data is read out from the image memory 170.

[Configuration Example of Clock Generating Circuit]

FIG. 9 is a block diagram of an internal configuration example of the clock generating circuit 270 in the first embodiment of the present disclosure.

The clock generating circuit 270 includes multipliers for high-frequency clock 20 and 24, frequency dividers for high-frequency clock 21 and 25, multipliers for low-frequency clock 22 and 26, and frequency dividers for low-frequency clock 23 and 27. The clock generating circuit 270 further includes multipliers for clock 28 and 30 and frequency dividers for clock 29 and 31. The multipliers multiply a frequency of an input clock. The frequency dividers reduce a frequency of an input clock into 1/n (n is arbitrary integer). In this example, the clock generating circuit 270 generates at least six kinds of clocks according to connection destinations of the units in the DSP 200 shown in FIG. 7.

Oscillators 261 to 263 are oscillation sources for generating clock signals supplied into the DSP 200. For example, quartz oscillators are used.

The oscillating circuits 264 to 266 generate clock signals supplied into the DSP 200 and output the generated clock signals to the clock generating circuit 270.

Two kinds of the six kinds of clocks generated by the clock generating circuit 270 are clocks supplied to the imaging devices 134 to 136. One kind of the clocks supplied to the imaging devices 134 to 136 is a clock having a relatively large frequency for generating an image having a relatively large number of pixels. A clock output from the oscillating circuit 264 is input to the multiplier for high-frequency clock 20 and multiplied and the multiplied clock is input to the frequency divider for high-frequency clock 21 and divided. In this way, the clock having the relatively large frequency is generated. The other one kind is a clock having a relatively small frequency for generating an image having a relatively small number of pixels. A clock output from the oscillating circuit 264 is input to the multiplier for low-frequency clock 22 and multiplied and the multiplied clock is input to the frequency divider for low-frequency clock 23 and divided. In this way, the clock having the relatively small frequency is generated. The clocks divided by the frequency divider for high-frequency clock 21 and the frequency divider for low-frequency clock 23 are output as clocks generated in the clock generating circuit 270 and supplied to the imaging devices 134 to 136 through the inside of the DSP 200. The clocks supplied to the imaging devices 134 and 136 are not limited to the two kinds described in this example. It is favorable that a larger number of kinds of clocks are generated and used according to the size of an image generated by imaging operation.

The other two kinds among the six kinds of clocks generated by the clock generating circuit 270 are clocks used in the inside of the DSP 200. One kind of the clocks used in the inside of the DSP 200 is a clock having a relatively large frequency for generating an image having a relatively large number of pixels. A clock output from the oscillating circuit 264 is input to the multiplier for high-frequency clock 24 and multiplied and the multiplied clock is input to the frequency divider for high-frequency clock 25 and divided. In this way, the clock having the relatively large frequency is generated. The other one kind is a clock having a relatively small frequency for generating an image having a relatively small number of pixels. A clock output from the oscillating circuit 264 is input to the multiplier for low-frequency clock 26 and multiplied and the multiplied clock is input to the frequency divider for low-frequency clock 27 and divided. In this way, the clock having the relatively small frequency is generated. The clocks divided by the frequency divider for high-frequency clock 25 and the frequency divider for low-frequency clock 27 are output as clocks generated in the clock generating circuit 270 and supplied to the inside of the DSP 200. The clocks used in the inside of the DSP 200 are not limited to the two kinds described in this example. It is favorable that a larger number of kinds of clocks are generated and used according to the size of an image generated by an imaging operation.

The remaining two kinds among the six kinds of clocks generated by the clock generating circuit 270 are a pixel clock for displaying an image in the display unit 140 and a pixel clock for displaying an image in a display device (e.g., external display device 245) on the outside of the information processing apparatus 100. A clock output from the oscillating circuit 265 is input to the multiplier for clock 28 and multiplied and the multiplied clock is input to the frequency divider for clock 29 and divided. In this way, the pixel clock for displaying an image in the display unit 140 is generated. A clock output from the oscillating circuit 266 is multiplied by the multiplier for clock 30 and multiplied and the multiplied clock is input to the frequency divider for clock 31 and divided. In this way, the pixel clock for displaying an image in the display device on the outside of the information processing apparatus 100 is generated. The clock divided by the frequency divider for clock 29 is output as a clock generated in the clock generating circuit 270 and supplied to the display unit 140 through the inside of the DSP 200. The clock divided by the frequency divider for clock 31 is output as a clock generated in the clock generating circuit 270 and supplied to the display device on the outside of the information processing apparatus 100 through the inside of the DSP 200. The clocks for image display are not limited to the two kinds described in this example. It is favorable that a larger number of kinds of clocks are generated and used according to specifications of a display device connected to the information processing apparatus 100.

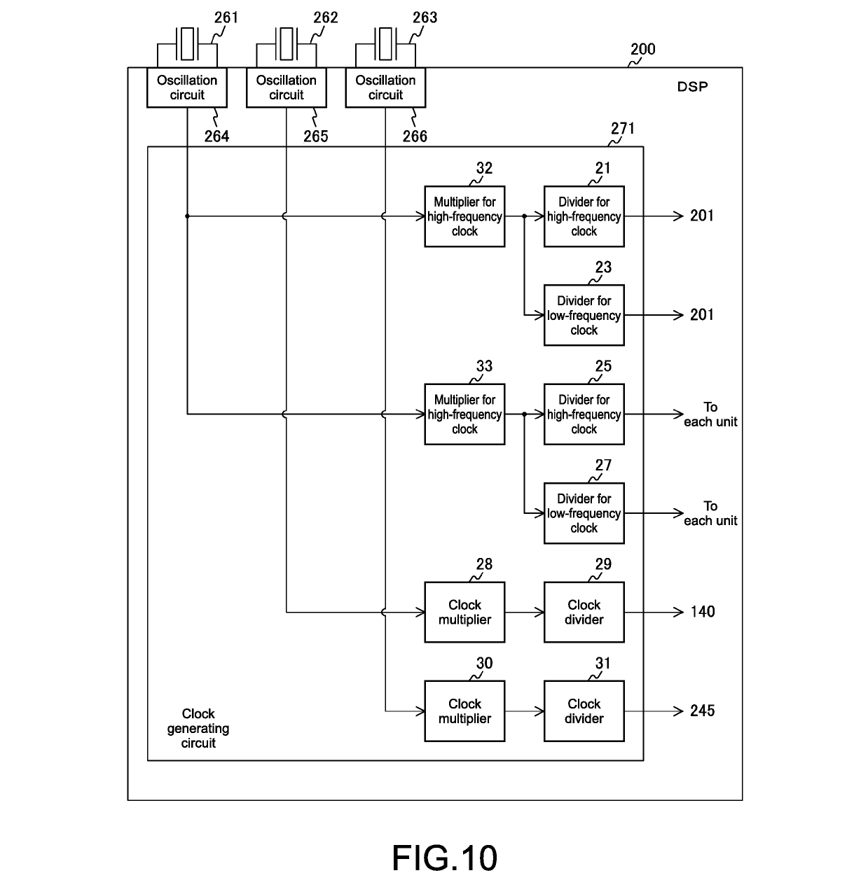

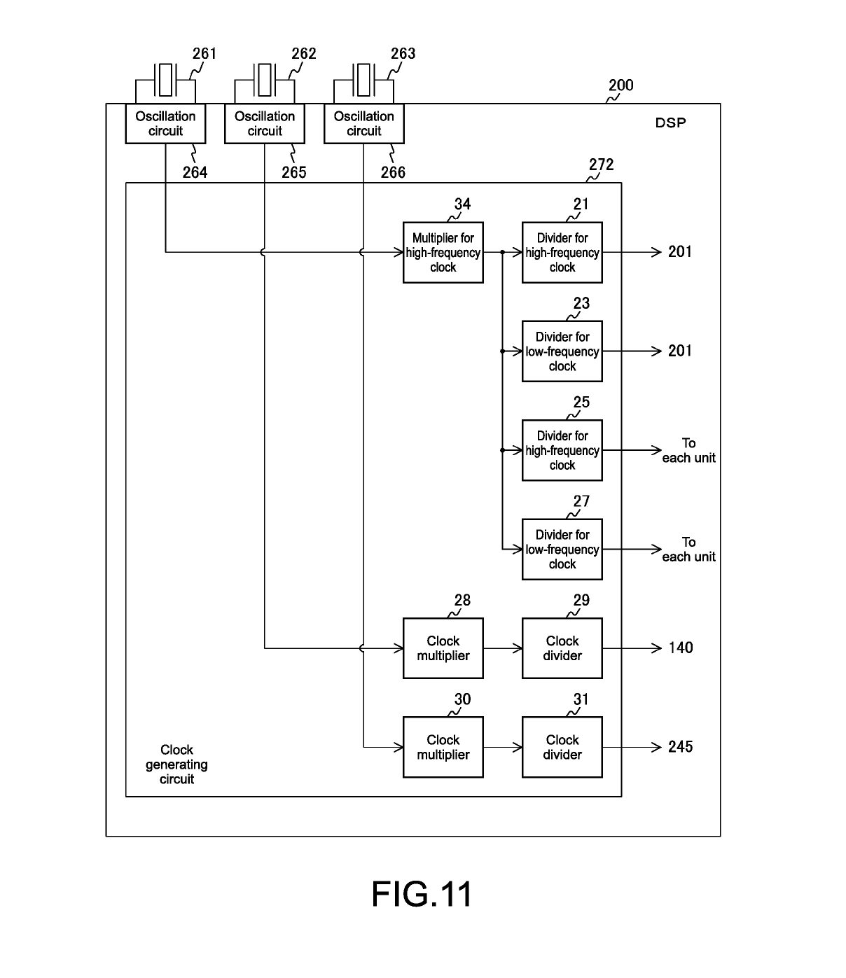

FIGS. 10 and 11 are block diagrams each showing a modified example of the clock generating circuit 270 in the first embodiment of the present disclosure.

In the example shown in FIG. 10, two kinds of clocks supplied to the imaging devices 134 to 136 share one multiplier (multiplier for clock 32) and two kinds of clocks supplied to the inside of the DSP 200 share one multiplier (multiplier for clock 33).

In the example shown in FIG. 11, a plurality of kinds of clocks supplied to the imaging devices 134 to 136 and a plurality of kinds of clocks supplied to the inside of the DSP 200 share one multiplier (multiplier for clock 34).

[Configuration Example of Imaging Device and Pixel Readout Example]

FIG. 12 is a diagram of an internal configuration example of an imaging device in the first embodiment of the present disclosure. The internal configurations of the imaging devices 134 to 136 are almost the same. Therefore, in FIG. 12, only the imaging device 134 is shown and illustration and description of the other imaging devices are omitted. In FIG. 12, a CMOS imaging device is exemplified as the imaging device 134.

The imaging device 134 includes pixels 40 to 47, a vertical scanning circuit 340, and a horizontal scanning circuit 345. The imaging device 134 includes ADCs (analog/digital (A/D) converters) 350 to 353, adders 354 to 357 and 366, and column latches 358 to 361. Further, the imaging device 134 includes switches 362 to 365, an output latch 367, an output circuit 368, registers 370 and 380, and multipliers/dividers 391 and 392. Note that, in general, an array of imaging devices in a longitudinal direction will be referred to as column and an array of imaging devices in a lateral direction will be referred to as row. Therefore, in the following description, the names “column” and “row” are used as appropriate. In this example, in the imaging device 134, a part of pixels (pixels 40 to 47) and units related to the pixels are representatively described. Illustration and description of other components are omitted.

In the imaging device 134, vertical control lines 341 to 344 are wired in a row direction and every other pixels present on the same line are connected to the same vertical control line. Data readout lines 346 to 349 are wired in a column direction and pixels present on the same line share one readout line.

The vertical scanning circuit 340 turns on and off switches between the pixels 40 to 47 and the data readout lines 346 to 349 through the vertical control lines 341 to 344 wired in the row direction. Specifically, in the pixels in the row direction, every other pixels among the pixels present on the same line in the row direction are turned on and off in common. Image data of the pixels 40 to 47 are output to the data readout lines 346 to 349 through switches between the pixels and the data readout lines corresponding to the pixels.

The horizontal scanning circuit 345 turns on and off the switches 362 to 365 between the column latches 358 to 361 and an output data line 369. It is possible to readout signals of all the pixels in a time division manner while sequentially selecting the pixels according to selection of ON and OFF of the switches by the vertical scanning circuit 340 and ON and OFF of the switches 362 to 365 by the horizontal scanning circuit 345. The output data line 369 is output data line for outputting output results of the columns from the imaging devices 134.

In the imaging device 134, the pixels 40 to 47 are arranged in a two-dimensional square lattice shape. The configurations of the pixels 40 to 47 are the same, and hence the pixel 40 is described as an example. The pixel 40 includes a photodiode 51 as a light receiving unit, an amplifier 52, and a switch 53. The photodiode 51 converts light irradiated on the pixel into charges corresponding to an amount of the light. The amplifier 52 is an amplifier that amplifies a signal of the charges converted by the photodiode 51. The switch 53 is a switch that controls charge transfer of the pixel 40 according to ON and OFF of a vertical control line 342.

The columns include the ADCs 350 to 353, the adders 354 to 357, and the column latches 358 to 361. The ADC 350, the adder 354, and the column latch 358 connected to the data readout line 346 are described below as examples.

The ADC 350 is an AD converter that converts image data from the pixels as analog values into digital data (digital values).

The adder 354 adds, every time image data is converted into digital data by the ADC 350, the new digital data after the conversion to digital data stored in the column latch 358.

The column latch 358 is a column latch that sequentially stores the digital data converted by the ADC 350. The column latch is a name indicating a data storing circuit that stores digital data after AD conversion. As the data storing circuit, besides a latch including a linear circuit, circuits that can store digital data such as a flip-flop including a synchronization circuit can be used.

For example, image data output from the pixel 40 is output to an output data line 390 through the switch 362 connected to the data readout line 346 after passing through the ADC 350, the adder 354, and the column latch 358. in the first embodiment of the present disclosure, like the data readout lines of the columns, the output data line 390 includes the adder 366 and the output latch 367 and performs addition and storage of image data. Image data stored in the output latch 367 is output to the output data line 369 through the output circuit 368. Note that image data from the output data line 369 is output to the above-mentioned data line L1.

The multipliers/dividers 391 and 392 perform, on the basis of the control from the DSP 200, multiplication of a frequency of an input clock and dividing of the frequency of the input clock. The multipliers/dividers 391 and 392 supply a generated clock to the vertical scanning circuit 340, the horizontal scanning circuit 345, and the output circuit 368.

The signal line 393 is a vertical synchronization signal line for supplying a vertical synchronization signal from the DSP 200. The signal line 394 is a horizontal synchronization signal line for supplying a horizontal synchronization signal from the DSP 200.

The signal line 395 is a clock signal line for supplying a clock signal from the DSP 200. The signal line 396 is a signal line for controlling ON and OFF of an imaging operation from the DSP 200 and a signal line for controlling pixel thinning-out. The signal line 397 is a bi-directional communication line between the imaging device 134 and the DSP 200. The signal line 398 is a power supply line.

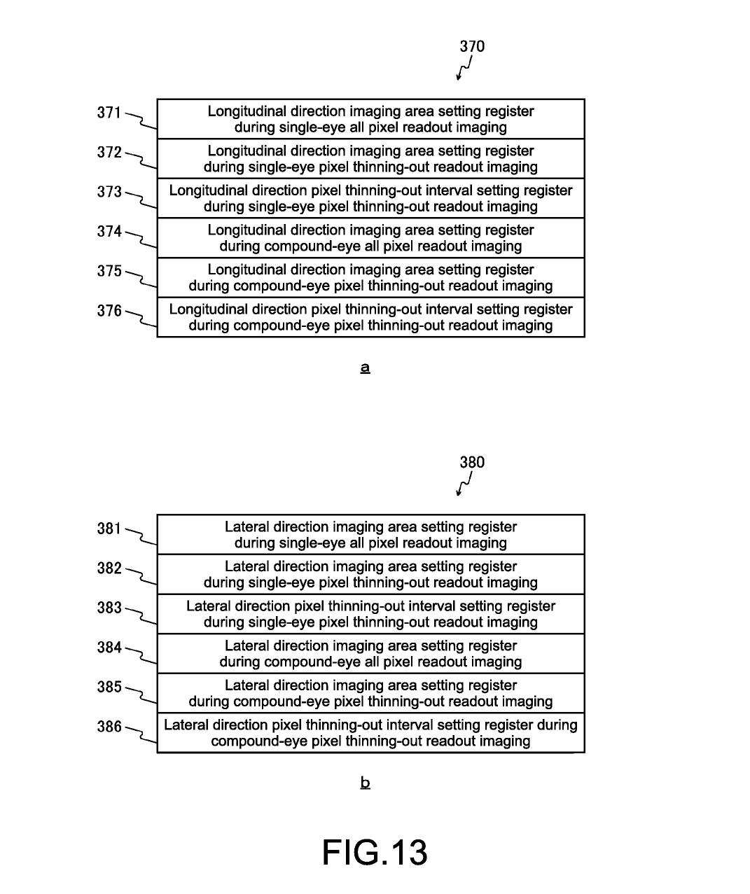

Note that the registers 370 and 380 are registers in which setting values concerning an imaging operation are stored. An example of stored contents is shown in FIG. 13.

FIG. 13 is a schematic diagram of stored contents of the registers 370 and 380 of the imaging device 134 in the first embodiment of the present disclosure.

In the registers 370 and 380, setting values concerning an imaging operation are stored. The setting values are supplied to the vertical scanning circuit 340 and the horizontal scanning circuit 345. Note that the setting values may be changeable by user operation.

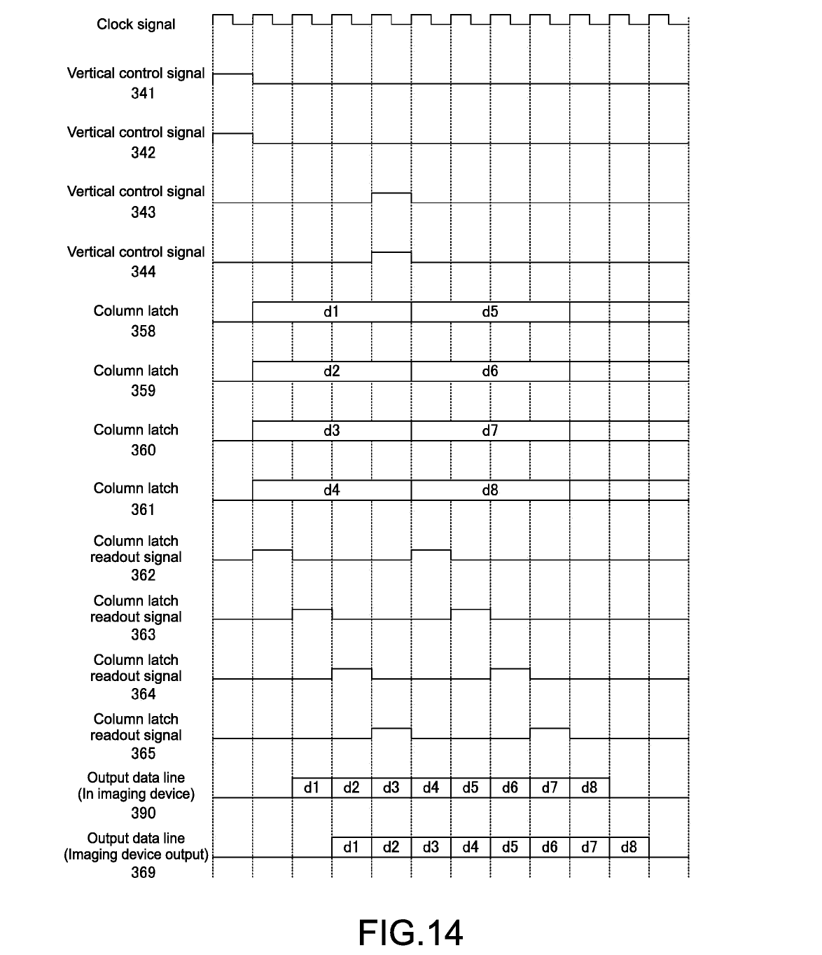

FIGS. 14 to 16 are schematic timing charts of states of control signals to the pixels in the imaging device 134 in the first embodiment of the present disclosure and data output from the pixels.

The abscissa shown in FIGS. 14 to 16 is a time axis. The vertical control lines 341 to 344 and the column latches 358 to 361 shown in FIGS. 14 to 16 are denoted by reference numerals same as those shown in FIG. 12 corresponding thereto. Column latch readout signals shown in FIGS. 14 to 16 are denoted by reference numerals same as those of the switches 362 to 365 shown in FIG. 12 corresponding thereto.

In the example shown in FIG. 14, an imaging operation in reading out all the pixels in the imaging device 134 is described.

Image data of all the imaging devices 134 connected to certain rows (e.g., lines of pixels 40 to 43) are output to the data readout lines 346 to 349 of the columns by using the vertical control lines 341 to 344. Subsequently, the pixel data output to the data readout lines 346 to 349 are AD-converted by the ADCs 350 to 353 of the columns. Subsequently, outputs of the ADCs 350 to 353 are stored in the column latches 348 to 361 of the columns. For example, pixel data d1 to d4 are stored in the column latches 358 to 361 shown in FIG. 14. Subsequently, the horizontal scanning circuit 345 turns on, in order column by column, the readout switches 362 to 365 from the column latches 358 to 361 to the output data line 390. This makes it possible to read out pixel data in one line in order. For example, after the pixel data d1 is output to the output data line 390 shown in FIG. 14, the pixel data d2 and d3 are sequentially output.

Thereafter, similarly, every time readout of one line in the horizontal direction is completed, the vertical scanning circuit 340 turns on the readout switches from the pixels to the vertical signal lines in order row by row. Consequently, pixel data in the rows are input to the ADCs 350 to 353. After the input pixel data are AD-converted by the ADCs 350 to 353, the pixel data are stored in the column latches 358 to 361 of the columns. For example, pixel data d5 to d8 are stored in the column latches 358 to 361 shown in FIG. 14. Subsequently, the horizontal scanning circuit 345 turns on the readout switches 362 to 365 from the column latches 358 to 361 to the output data line 390 in order column by column and reads out the pixel data in one line in order. For example, the pixel data d5 to d8 are sequentially output to the output data line 390 shown in FIG. 14.

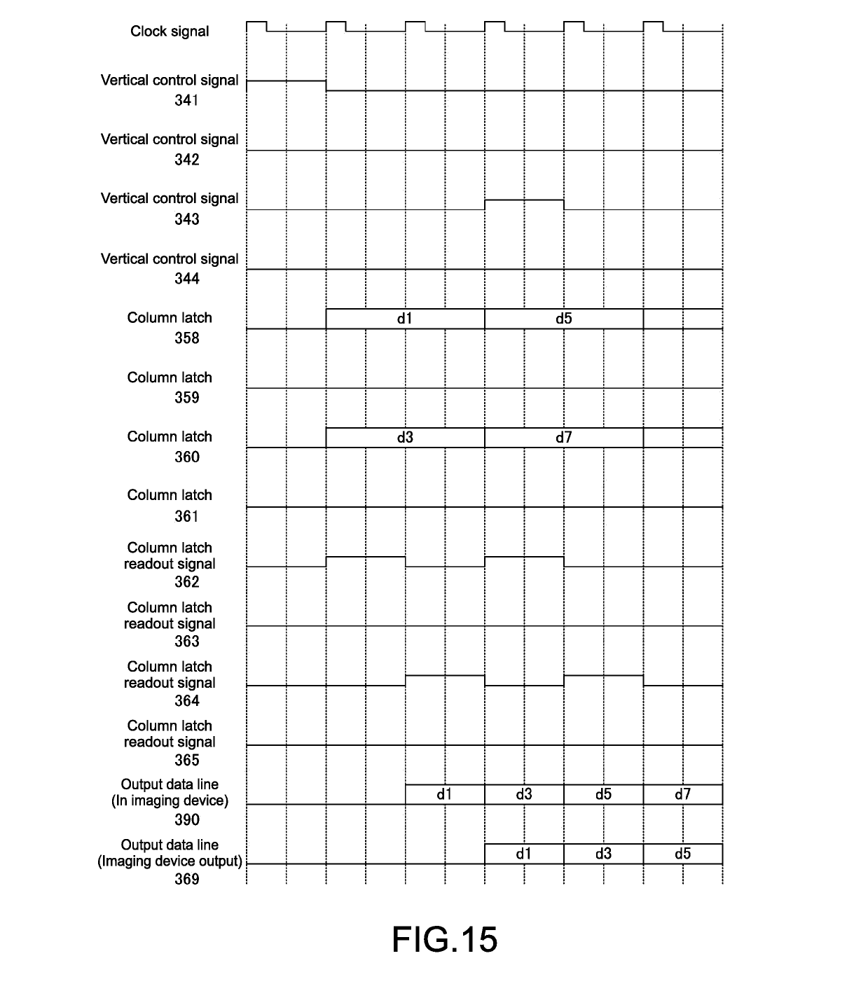

In the example shown in FIG. 15, an imaging operation in reading out the pixels in the imaging device 134 by horizontally thinning out the pixels is described as an example of pixel thinning-out readout.

The vertical scanning circuit 340 turns on the readout switches from the pixels to the vertical signal lines 346 to 349 only in a desired column. Consequently, only pixel data in a specific row is input to the ADCs 350 to 353 and AD-converted by the ADCs 350 to 353. Outputs of the ADCs 350 to 353 are stored in the column latches 358 to 361 in the columns. For example, the readout switches connected to the vertical control lines 342 and 344 are turned on. In this way, the pixel data d1 and d3 are stored in the column latches 358 and 360 shown in FIG. 15. After this readout for one row is completed, for example, the readout switches connected to the vertical control lines 342 and 344 are turned on. In this way, pixel data d5 and d7 are stored in the column latches 358 and 360 shown in FIG. 15.

The horizontal scanning circuit 345 turns on the readout switches from the column latches 358 to 361 to the output data line 390 only in a desired column. This makes it possible to read out only specific pixel data in one line in order.

For example, in the horizontal direction, when one piece of pixel data is read out from N pieces of pixel data, 1/N thinning-out readout is performed in the horizontal direction. For example, when one piece of pixel data of two pieces of pixel data is read out, ½ thinning-out readout is performed in the horizontal direction. When one piece of pixel data among four pieces of pixel data is read out, ¼ thinning-out readout is performed in the horizontal direction.

Simultaneously with a thinning-out operation in the horizontal direction (i.e., row direction), a thinning-out operation in the vertical direction (i.e., column direction) can also be performed. For example, when pixel data in one line among M lines is read out in the vertical direction, 1/M thinning-out readout is performed in the vertical direction. For example, when pixel data in one row of two rows is read out, ½ thinning-out readout is performed in the vertical direction. When pixel data in one row among four rows is read out, ¼ thinning-out readout is performed in the vertical direction.

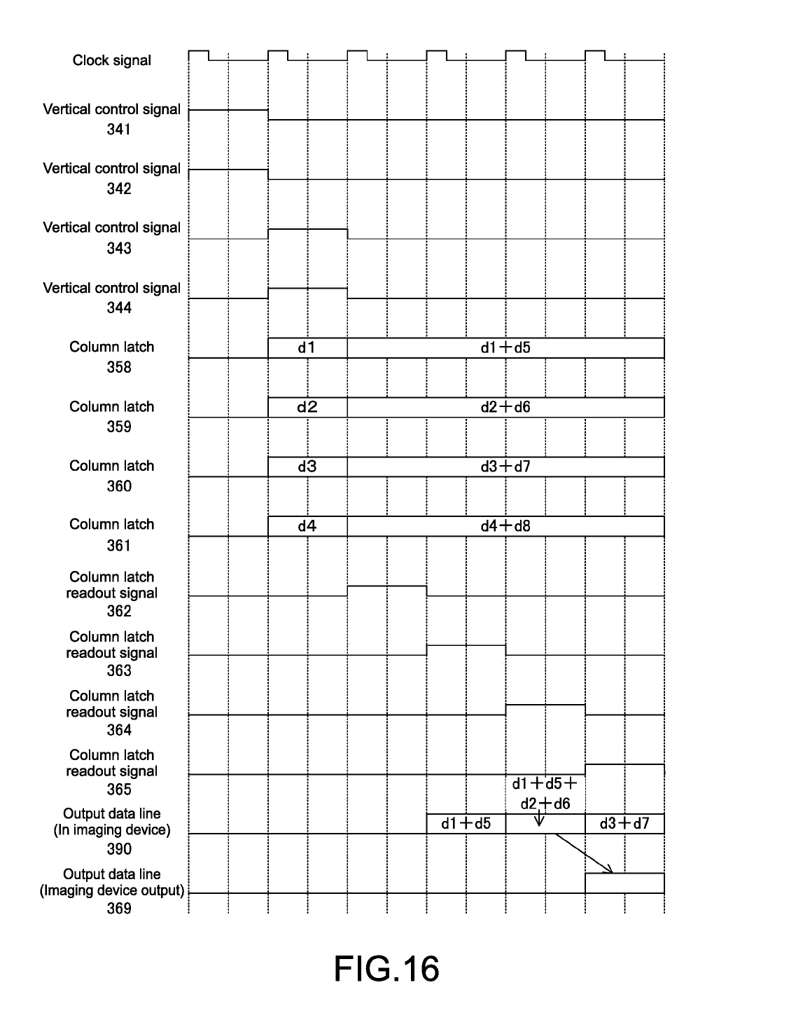

In the example shown in FIG. 16, an imaging operation in performing pixel addition readout of the pixels in the imaging device 134 is described. In this example, an imaging operation in the case of ½ pixel addition readout in the horizontal direction and ½ pixel addition readout in the vertical direction is described as pixel addition readout.

As in the case of all pixel readout, data of all the imaging devices 134 connected to a certain row are output to the data readout lines included in the columns by using a vertical control line, AD-converted, and stored in the column latches. Unlike the case of the all pixel readout, data of all the imaging devices 134 connected to another row are output to the data readout lines included in the columns by using another vertical control line and AD-converted. The data are added to the data stored in the column latches by using an adder. Values of pixel data are added up by this method by a desired number of lines in the vertical direction. The data after the addition are stored in the column latches. For example, pixel data d1+d5, d2+d6, d3+d7, and d4+d8 are stored in the column latches 358 to 361. After adding up N pieces of pixel data in the vertical direction, an addition result is output as one piece of pixel data. In this way, 1/N pixel addition readout in the vertical direction is performed.

Subsequently, the horizontal scanning circuit 345 sequentially turns on, in order column by column, the readout switches from the column latches to the output data line 390. In this case, data read out from the column latches to the output data line 390 are added up by the adder 366 of the output data line 390 and stored in the output latch 367. Addition processing is repeated by a desired number of columns in the horizontal direction and data after the addition is output to the imaging device 134. For example, data d1+d5+d2+d6 obtained by adding up the pixel data d1+d5 and the pixel data d2+d6 is output to the imaging device 134 via the output data line 369. The pixel data in M rows are added up in the horizontal direction. In this way, 1/M pixel addition readout is performed in the horizontal direction. The processing described above enables addition processing in the horizontal direction (row direction) and addition processing in the vertical direction (column direction).

When the thinning-out readout shown in FIG. 15 and the pixel addition readout shown in FIG. 16 are performed, it is favorable to cause the imaging devices to operate according to a plurality of kinds of thinning-out ratios and pixel addition ratios. In view of this, a scanning circuit that causes the imaging devices to operate according to a plurality of kinds of thinning-out ratios and pixel addition ratios is described below.

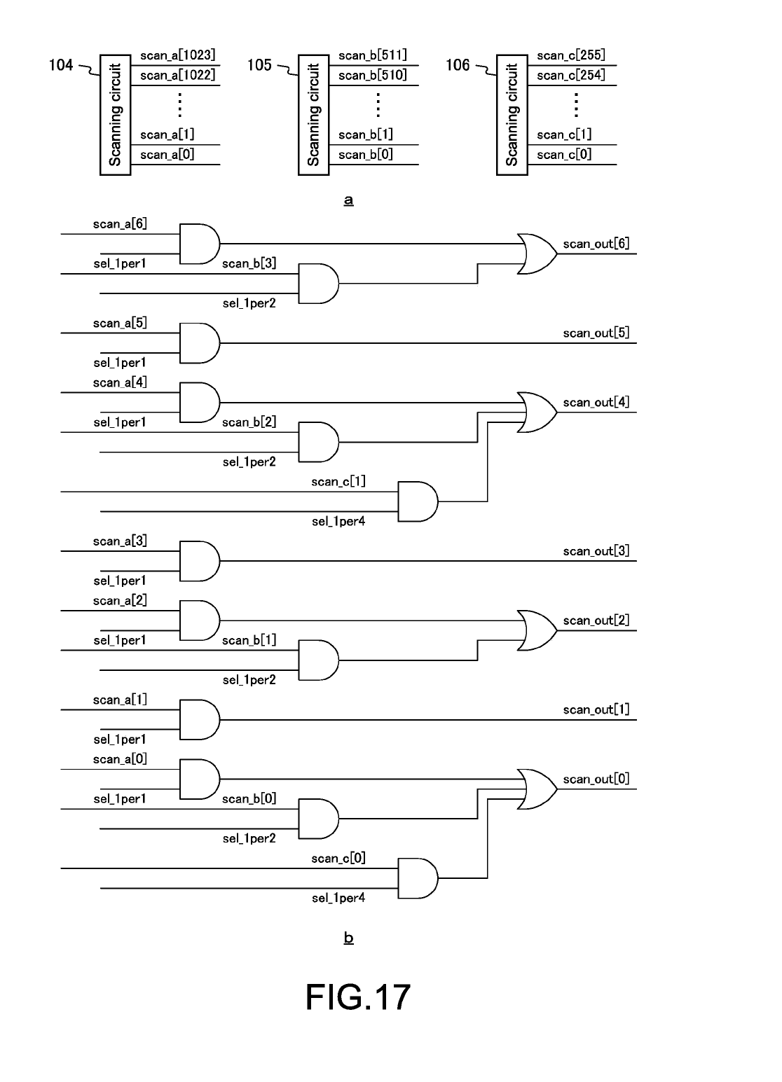

FIG. 17 is a schematic diagram of an example of a scanning circuit for performing thinning-out of the imaging device 134 in the first embodiment of the present disclosure. In Part “a” of FIG. 17, three kinds of scanning circuits 104 to 106 are shown. In Part “b” of FIG. 17, a configuration example of a 1/N thinning-out scanning circuit is shown. In the examples shown in FIG. 17, the number of lateral direction pixels of an imaging device is 1024 with respect to scanning circuits of the imaging device corresponding to three kinds of pixel thinning-out ratios for all pixel readout, ½ thinning-out readout, and ¼ thinning-out readout.

As shown in Part “a” of FIG. 17, the scanning circuit 104 is a 1024-to-1 scanning circuit including 1024 output signal lines (scan_a[n(0≦n≦1023: n is an integer)]). The scanning circuit 104 changes the signal lines to an enable state one by one and then changes the signal lines to a disable state. The scanning circuit 105 is a 512-to-1 scanning circuit including 512 output signal lines (scan_b[n(0≦n≦511: n is an integer)]). The scanning circuit 105 changes the signal lines to the enable state one by one and then changes the signal lines to the disable state. The scanning circuit 106 is a 256-to-1 scanning circuit including 256 output signal lines (scan_c[n(0≦n≦255: n is an integer)]). The scanning circuit 106 changes the signal lines to the enable state one by one and then changes the signal lines to the disable state.

As shown in Part “b” of FIG. 17, the output signal lines of the scanning circuit 105, the output signal lines of the scanning circuit 106, and control lines indicating which of the three kinds of pixel thinning-out ratios is selected are connected to signal lines having numbers of multiples of 4 among the 1024 output signal lines of the scanning circuit 104. The three kinds of control lines are control lines corresponding to all pixel readout (sel_{—}1per1), ½ thinning-out readout (sel_{—}1per2), and ¼ thinning-out readout (sel_{—}1per4).

The output signal lines of the scanning circuit 105 and control lines indicating which of the two kinds of pixel thinning-out ratios is selected are connected to signal lines having numbers of multiples of 2 rather than the multiples of 4 among the 1024 output signal lines of the scanning circuit 104. The two kinds of control lines are control lines corresponding to the all pixel readout and the ½ thinning-out readout.

A control line indicating whether the all pixel readout is selected is connected to the signal lines other than the signal lines described above among the 1024 output signal lines of the scanning circuit 104.

According to outputs (scan_out[n(0≦n≦1023: n is an integer) from the scanning circuits shown in Part “b” of FIG. 17, in the imaging device 134, it is possible to perform thinning-out processing of each of the all pixel readout, the ½ thinning-out readout, and the ¼ thinning-out readout.

[Arrangement Configuration Example of Imaging Systems]

FIG. 18 is a diagram showing a relation between the imaging unit 130 and a subject in the first embodiment of the present disclosure. Note that, in FIG. 18, only the optical systems 131 to 133 and the imaging devices 134 to 136 in the first to third imaging systems 191 to 193 in the imaging unit 130 shown in FIG. 3 are shown and the other components are omitted. In FIG. 18, a subject as an imaging target is represented as a subject surface 300. The information processing apparatus 100 is arranged such that an optical axis 194 of the first imaging system 191 is orthogonal to the subject surface 300. Further, the optical axis 194 of the first imaging system 191 is orthogonal (almost orthogonal) to the display surface of the display unit 140. It is assumed that three optical axes 194 to 196 cross at an intersection P0.

In the imaging unit 130, an angle formed by the optical axis 194 of the first imaging system 191 and the optical axis 195 of the second imaging system 192 is represented as θ0. Similarly, an angle formed by the optical axis 194 of the first imaging system 191 and the optical axis 196 of the third imaging system 193 is represented as θ0. Note that the third imaging system 193 is arranged in a position line-symmetrical to the second imaging system 192 across the optical axis 194 of the first imaging system 191.

In the first imaging system 191, an angle formed by a line on the outermost side of an incident light path of light made incident on the imaging device 134 and the optical axis 194 is represented as θ1. In the second imaging system 192, an angle formed by a line on the outermost side of an incident light path of light made incident on the imaging device 135 and the optical axis 195 is represented as θ2. Similarly, in the third imaging system 193, an angle formed by a line on the outermost side of an incident light path of light made incident on the imaging device 136 and the optical axis 196 is represented as θ2. For example, as shown in FIG. 18, the width in the horizontal direction of a light receiving surface in the imaging device 134 is equal (or almost equal) to the width in the horizontal direction of light receiving surfaces in the imaging devices 135 and 136. Therefore, an angle of view 2×θ1 of light made incident on the imaging device 134 is equal (or almost equal) to an angle of view 2×θ2 of light made incident on the imaging devices 135 and 136.

An imaging area 301 on the subject surface 300 is specified by the angle of view 2×θ1 of the light made incident on the imaging device 134. Similarly, an imaging area 302 on the subject surface 300 is specified by the angle of view 2×θ2 of the light made incident on the imaging device 135 and an imaging area 303 on the subject surface 300 is specified by the angle of view 2×θ2 made incident on the imaging device 136. in the first embodiment of the present disclosure, images generated by the imaging devices 134 to 136 are combined to generate a panorama image. Therefore, the angles formed by the optical axes are set such that the imaging area 301 on the subject surface 300 and the imaging area 302 on the subject surface 300 partially overlap. Specifically, the angle θ0 formed by the optical axis 194 of the first imaging system 191 and the optical axis 195 of the second imaging system 192 and the angle θ0 formed by the optical axis 194 of the first imaging system 191 and the optical axis 196 of the third imaging system 193 are set such that the imaging areas 301 and 302 partially overlap. Note that the optical axes 194 to 196 are included in the same plane. The first to third imaging systems 191 to 193 are arranged such that the optical axes 194 to 196 cross at one point (intersection P0).

A lens center of the first imaging system 191 is represented as R1, a lens center of the second imaging system 192 is represented as R2, and a lens center of the third imaging system 193 is represented as R3. A distance between the lens center R1 and the intersection P0 is represented as L11, a distance between the lens center R2 and the intersection P0 is represented as L21, and a distance between the lens center R3 and the intersection P0 is represented as L31. In this case, it is favorable that the first to third imaging systems 191 to 193 are arranged such that the distances L11, L21, and L31 are equal.

[Correction Example of Trapezoidal Distortion]

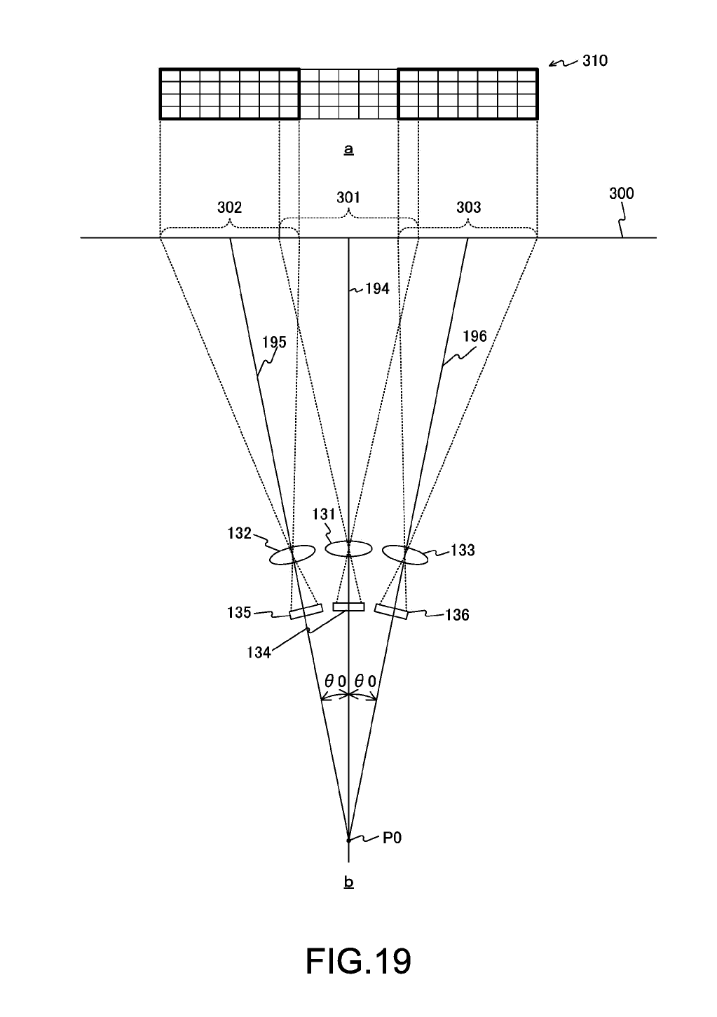

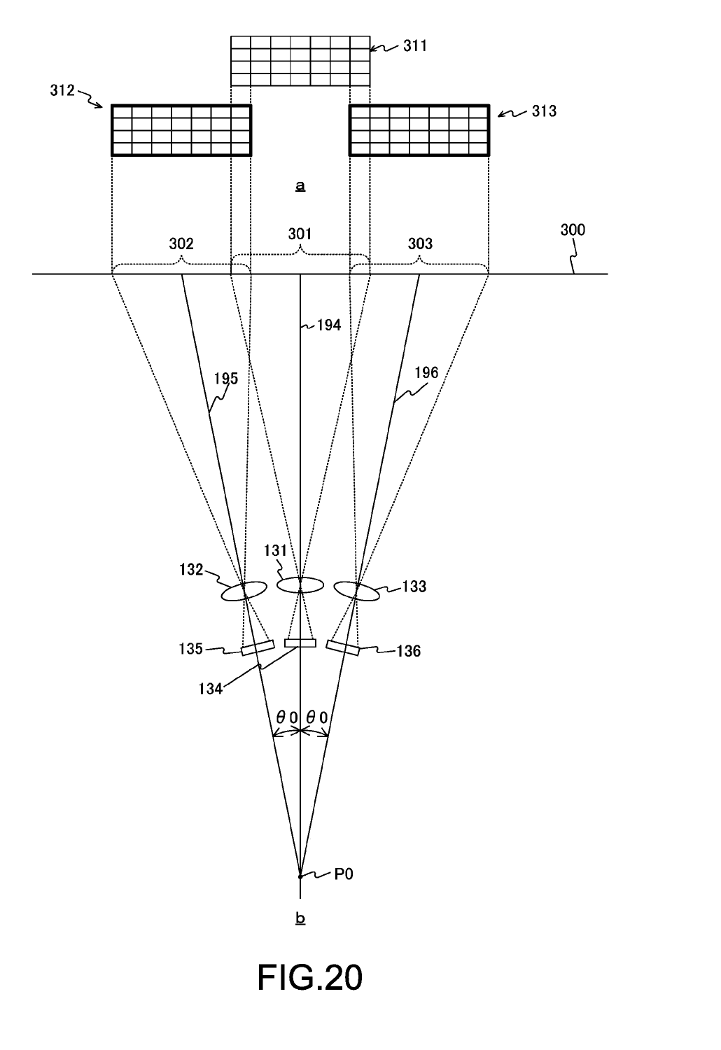

FIGS. 19 and 20 are schematic diagrams showing a relation between the imaging systems in the imaging unit 130 and a subject as an imaging target of the imaging systems in the first embodiment of the present disclosure.

In Part “a” of FIG. 19, a subject 310 as an imaging target of the imaging unit 130 is schematically shown. The subject 310 is a subject corresponding to the subject surface 300 shown in FIG. 18. A range corresponding to the subject 310 is indicated by a rectangle. The inside of the rectangle is schematically shown in a lattice shape.

In Part “a” of FIG. 20, subjects 311 to 313 as imaging targets by the imaging unit 130 are schematically shown. The subject 311 is a subject corresponding to the first imaging system 191 in the subject 310 shown in Part “a” of FIG. 19. Similarly, the subject 312 is a subject corresponding to the second imaging system 192 in the subject 310. The subject 313 is a subject corresponding to the third imaging system 193 in the subject 310. Both ends in the horizontal direction of the subject 311 among the subjects 311 to 313 and one ends in the horizontal direction of the subjects 312 and 313 overlap.

In Parts “b” of FIGS. 19 and 20, the imaging systems in the imaging unit 130 are shown. Note that examples shown in Parts “b” of FIGS. 19 and 20 are the same as the example shown in FIG. 18 except that reference symbols and the like are omitted.

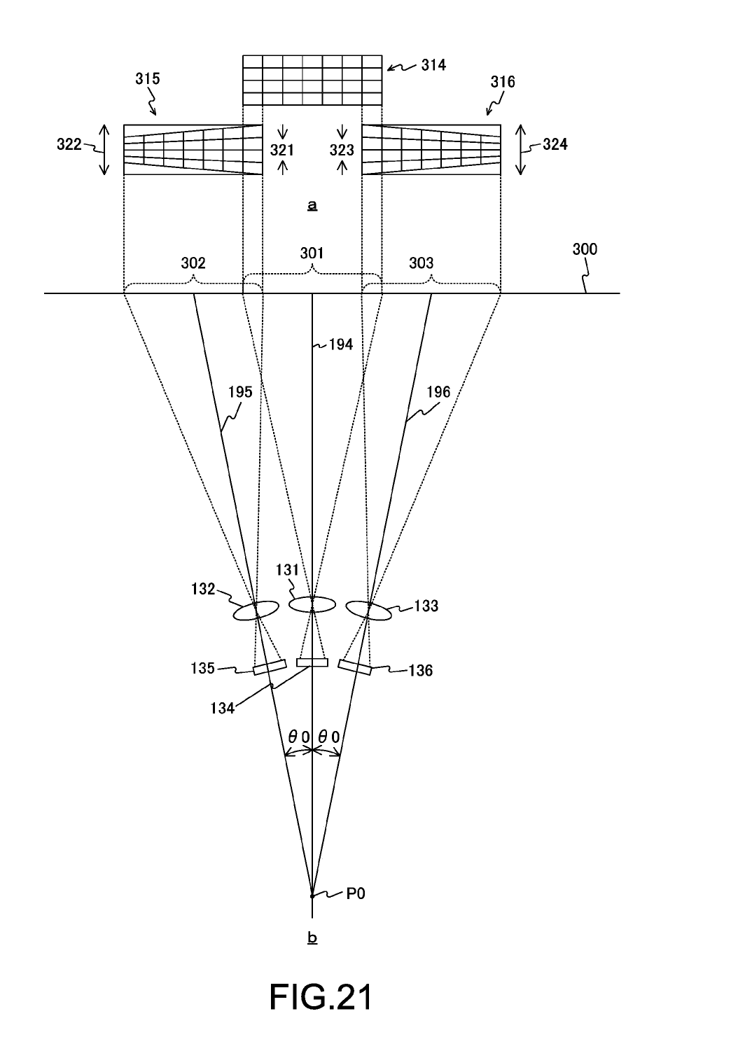

FIG. 21 is a schematic diagram showing relations between the imaging systems in the imaging unit 130 in the first embodiment of the present disclosure and captured images generated by the imaging systems. In Part “a” of FIG. 21, captured images 314 to 316 generated by the imaging unit 130 are schematically shown. The captured images 314 to 316 are captured images corresponding to the subjects 311 to 313 shown in Part “a” in FIG. 20. Rectangles of a lattice shape shown in the subjects 311 to 313 are schematically shown.

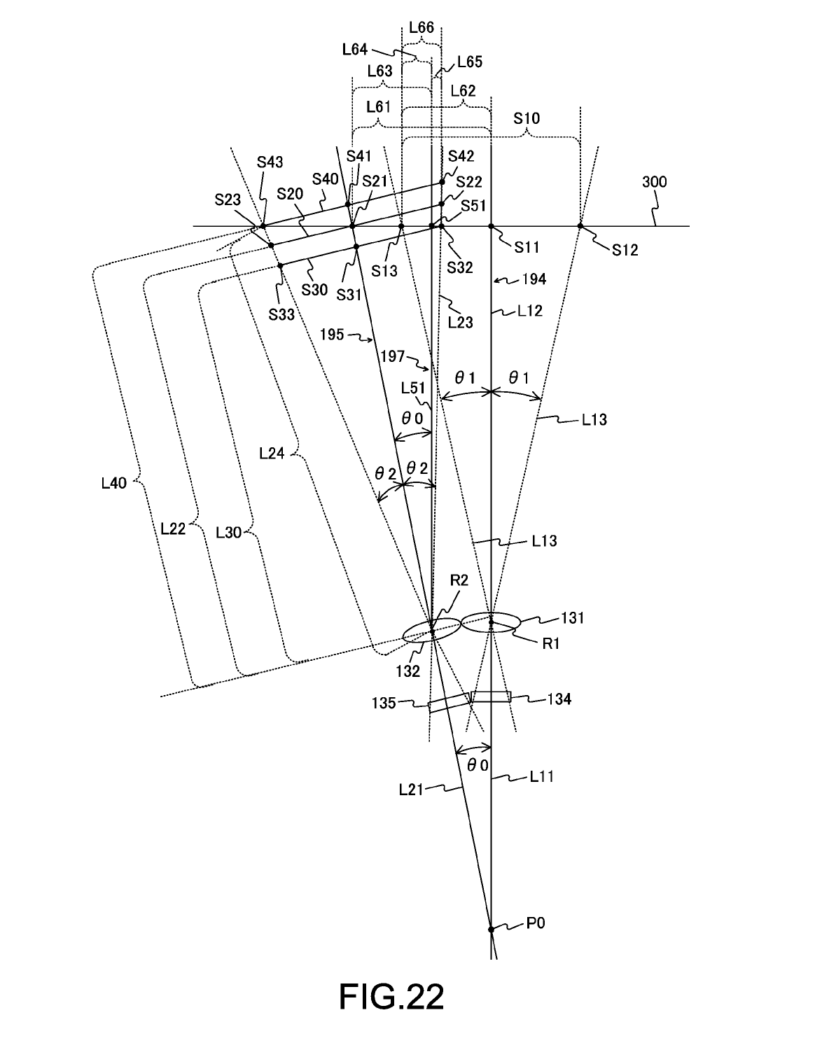

As shown in Part “a” of FIG. 21, the optical axes 195 and 196 of the second and third imaging systems 192 and 193 are not orthogonal to the subject surface 300. Therefore, a trapezoidal distortion occurs in the captured images 315 and 316. The trapezoidal distortion will be described in detail with reference to FIG. 22.

FIG. 22 is a schematic diagram showing a relation between each of the imaging systems in the imaging unit 130 in the first embodiment of the present disclosure and a subject as an imaging target of the imaging systems. Note that, in FIG. 22, for the sake of description, components related to the third imaging system 193 are omitted and only the first and second imaging systems 191 and 192 are shown. The example shown in FIG. 22 is almost the same as the example shown in FIG. 18 except that the components related to the third imaging system 193 are omitted. The intersection P0, the angles θ0, θ1, and θ2, the lens centers R1 and R2, and the distance L11 are the same as those in the example shown in FIG. 18 and, therefore, are denoted by the same reference symbols.

In FIG. 22, an intersection of the optical axis 194 of the first imaging system 191 and the subject surface 300 is represented as S11. An intersection of a right visible outline of an angle of view of the first imaging system 191 and the subject surface 300 is represented as S12. An intersection of a left visible outline of the angle of view of the first imaging system 191 and the subject surface 300 is represented as S13.

A planar subject area that is a plane including the intersection S11 and orthogonal to the optical axis 194 and is made incident on the first imaging system 191 is represented as a subject surface S10.

An intersection of the optical axis 195 of the second imaging system 192 and the subject surface 300 is represented as S21. An intersection of a right visible outline of an angle of view of the second imaging system 192 and the subject surface 300 is represented as S32. An intersection of a left visible outline of the angle of view of the second imaging system 192 and the subject surface 300 is represented as S43.

A planar subject area that is a plane including the intersection S21 and orthogonal to the optical axis 195 and is made incident on the second imaging system 192 is represented as subject surface S20.

A planar subject area that is a plane including the intersection S32 and orthogonal to the optical axis 195 and is made incident on the second imaging system 192 is represented as a subject surface S30.

A planar subject area that is a plane including the intersection S43 and orthogonal to the optical axis 195 and is made incident on the second imaging system 192 is represented as a subject surface S40.

An intersection of the subject surface S30 and the optical axis 195 is represented as S31. An intersection of the subject surface S40 and the optical axis 195 is represented as S41.

An intersection of the right visible outline of the angle of view of the second imaging system 192 and the subject surface S20 is represented as S22. An intersection of the right visible outline of the angle of view of the second imaging system 192 and the subject surface S40 is represented as S42.

An intersection of the left visible outline of the angle of view of the second imaging system 192 and the subject surface S20 is represented as S23. An intersection of the right visible outline of the angle of view of the second imaging system 192 and the subject surface S30 is represented as S33.

An intersection of a segment 197 passing through the lens center R2 of the second imaging system 192 and perpendicular to the subject surface 300 and the subject surface 300 is represented as S51.

For example, when the subject surface S40 including the point S43 at the left end of the angle of view and the subject surface S30 including the point S32 at the right end of the angle of view are compared, the subject surface S40 is present in a position farther from the lens center R2 than the subject surface S30. Therefore, when the subject surface S40 is imaged, an imaged area is wider than an area imaged when the subject surface S30 is imaged. For example, it is assumed that segments having the same length are arranged as subjects on the subject surface S40 and the subject surface S30. In this case, when a captured image generated for the subject surface S30 and a captured image generated for the subject surface S40 are compared, the segment included in the captured image generated for the subject surface S40 is shorter.

Therefore, for example, when the subject 312 shown in Part “a” in FIG. 20 is imaged by the second imaging system 192, as in the captured image 315 shown in Part “a” of FIG. 21, an area corresponding to the subject 312 is formed in a trapezoidal shape. Specifically, in the example shown in Part “a” of FIG. 21, in the captured image 315, the left side is shorter than the right side in the rectangle corresponding to the subject 312.

Similarly, when the subject 313 shown in Part “a” in FIG. 20 is imaged by the third imaging system 193, as in the captured image 316 shown in Part “a” of FIG. 21, an area corresponding to the subject 313 is formed in a trapezoidal shape. In this way, a trapezoidal distortion occurs in the captured images generated by the three-eye imaging unit. A trapezoidal distortion correcting method for correcting a trapezoidal distortion of a captured image is described below.

A distance between the intersection S11 and the lens center R1 is represented as L12. A distance between the intersection S13 and the lens center R1 and a distance between the intersection S12 and the lens center R1 is represented as L13.

A distance between the intersection S21 and the lens center R2 is represented as L22. A distance between the intersection S31 and the lens center R2 is represented as L30. A distance between the intersection S41 and the lens center R2 is represented as L40.

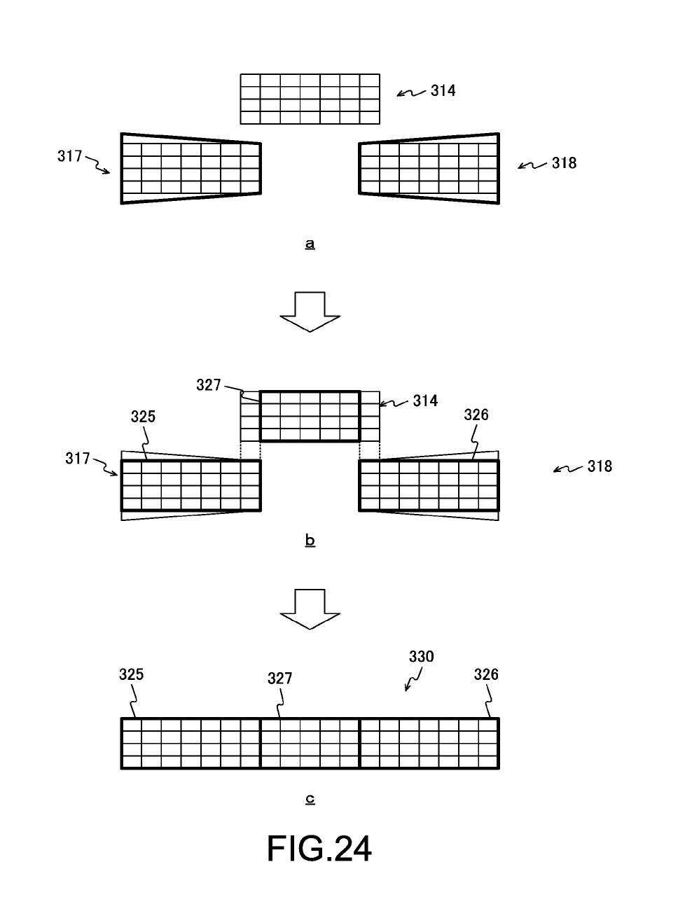

A distance between the intersection S32 and the lens center R2 is represented as L23. A distance between the intersection S43 and the lens center R2 is represented as L24. A distance between the intersection S51 and the lens center R2 is represented as L51. Note that distances L61 to L66 will be described with reference to FIG. 24.

The following formula holds according to the formula of the trigonometric function.

L21+L22=L11+L22=(L11+L12)/cos θ0

The following Formula 1 is obtained according to this formula.

L22={(L11+L12)/cos θ0}−L11 Formula 1

where L11=L21

Concerning the distance L51, the following Formula 2 is obtained according to the formula of the trigonometric function and Formula 1.

$$\begin{matrix}L 51 = L 22 \times cos θ0 \\ = [ \{ ( L 11 + L 12 ) / cos θ0 \} - L 11 ] ] \times cos θ0\end{matrix} \qquad Formula 2$$

Concerning the distance L23, the following Formula 3 is obtained according to the formula of trigonometric function and Formula 2.

$$\begin{matrix}L 23 = L 51 / cos ( θ2 - θ0 ) \\ = ( L 22 \times cos θ0 ) / cos ( θ2 - θ0 )\end{matrix} \qquad Formula 3$$

Concerning the distance L30, the following Formula 4 is obtained according to the formula of trigonometric function and Formula 3.

$$\begin{matrix}L 30 = L 23 \times cos θ2 \\ = \{ ( L 22 \times cos θ0 ) / cos ( θ2 - θ0 ) \} \times cos θ2 \\ = ( [ ( \{ ( L 11 + L 12 ) / cos θ0 \} - L 1 \; 1 ) \times cos θ 0 ] / \\ cos ( θ2 - θ0 ) ) ) \times cos θ2\end{matrix} \qquad Formula 4$$

When the distances L11 and L12 in the optical axis 194 of the first imaging system 191 are determined, the distance L30 can be calculated by using Formula 4. By calculating the distance L30 in this way, it is possible to calculate a value XR (=L12/L30) of a ratio of the distance L30 to the distance L12. Note that XR is smaller than 1.

Concerning the distance L24, the following Formula 5 is obtained according to the formula of the trigonometric function and Formula 2.

$$\begin{matrix}L 24 = L 51 / cos ( θ2 + θ0 ) \\ = ( L 22 \times cos θ0 ) / cos ( θ2 + θ0 )\end{matrix} \qquad Formula 5$$

Concerning the distance L40, the following Formula 6 is obtained according to the formula of trigonometric function, Formula 1, and Formula 5.

$$\begin{matrix}L 40 = L 24 \times cos θ2 \\ = \{ ( L 22 \times cos θ0 ) / cos ( θ2 + θ0 ) \} \times cos θ2 \\ = [ [ \{ ( L 11 + L 12 ) / cos θ0 - L 1 \; 1 \} \times cos θ 0 ] / \\ cos ( θ2 + θ0 ) ] \times cos θ2\end{matrix} \qquad Formula 6$$

When the distances L11 and L12 in the optical axis 194 of the first imaging system 191 is determined, the distance L40 can be calculated by using Formula 6. By calculating the distance L40 in this way, a value XL (=L12/L40) of a ratio of the distance L40 to the distance L12 can be calculated. Note that XL is larger than 1.

Next, a correcting method for correcting a trapezoidal distortion will be described by using the values XR and XL of the ratios.

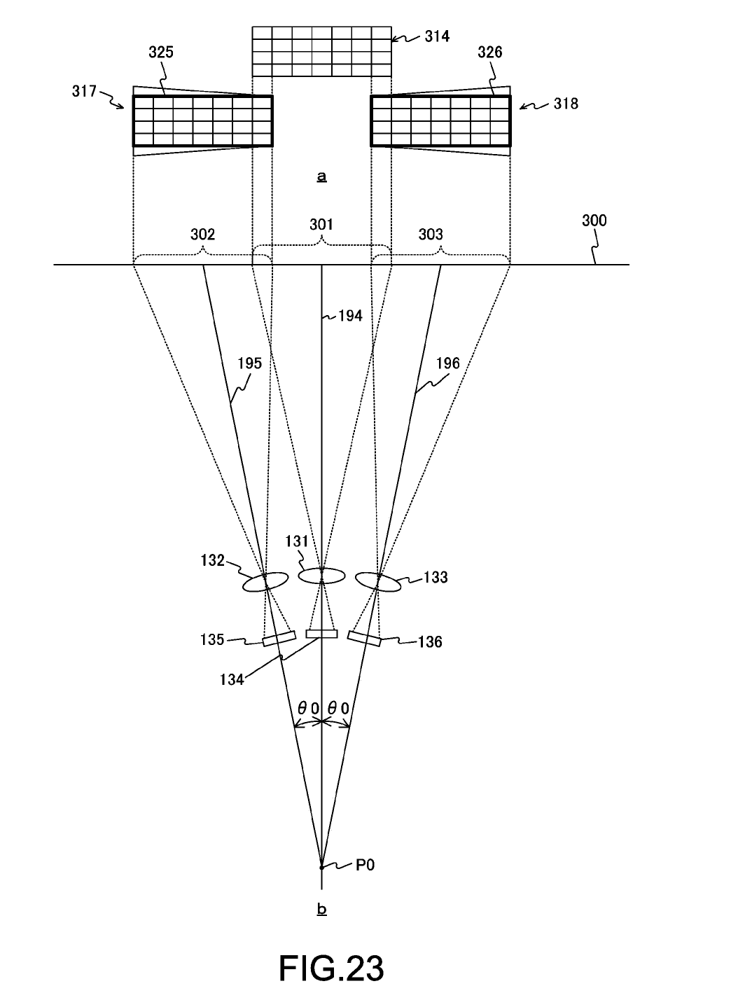

Concerning the captured image 315 shown in Part “a” of FIG. 21, coordinates are converted such that the length of the right side is multiplied by XR and the length of the left side is multiplied by XL. Specifically, the right side in the captured image 315 is reduced in an arrow 321 direction such that the length of the right side is multiplied by XR. The left side in the captured image 315 is expanded in an arrow 322 direction such that the length of the left side is multiplied by XL. A corrected image 317 corrected in this way is shown in “a” of FIG. 23.

FIG. 23 is a schematic diagram showing relations between the imaging systems in the imaging unit 130 in the first embodiment of the present disclosure and captured images generated by the imaging systems and corrected images after correction. In “a” of FIG. 23, the captured image 314 generated by the imaging unit 130 and corrected images 317 and 318 obtained by correcting the captured images 315 and 316 shown in Part “a” of FIG. 21 are schematically shown. Note that the example shown in “b” of FIG. 23 is the same as the example shown in FIG. 18 except that reference symbols and the like are omitted.

As described above, concerning the captured image 315 shown in Part “a” of FIG. 21, coordinates are converted such that the length of the right side is multiplied by XR and the length of the left side is multiplied by XL. In this way, the corrected image 317 shown in “a” of FIG. 23 is generated. The corrected image 317 generated in this way is an image, an external shape of which is a trapezoid. Therefore, it is possible to acquire, by cutting out the center in the corrected image 317 in a rectangular shape, an image 325 (indicated by thick line) with a trapezoidal distortion corrected.

Similarly, concerning the captured image 316 shown in Part “a” of FIG. 21, coordinates are converted such that the length of the left side is multiplied by XR and the length of the right side is multiplied by XL. In this way, the corrected image 318 shown in “a” of FIG. 23 is generated. It is possible to acquire, by cutting out the center in the corrected image 318 in a rectangular shape, an image 326 (indicated by thick line) with a trapezoidal distortion corrected. Note that trapezoidal distortion correction processing for a captured image is performed by the image combination processing unit 224.

When such trapezoidal distortion correction is performed, for example, coordinates of pixels in a captured image distorted in a trapezoidal shape are measured and the values XR and XL of the ratios are calculated in advance. It is possible to perform, using the values XR and XL of the ratios calculated in advance, the trapezoidal distortion correction processing in a software manner with an arithmetic apparatus such as a CPU incorporated in the information processing apparatus 100.

Note that the example of the correcting method for correcting a trapezoidal distortion of a captured image caused by a three-eye imaging operation is described above. However, correction may be performed by other trapezoidal distortion correcting methods (see, for example, Japanese Patent Application Laid-open No. HEI 08-307770).

[Combination Example of Captured Images]

FIG. 24 is a schematic diagram of a flow of combination when the image combination processing unit 224 in the first embodiment of the present disclosure generates a combined image. In this example, three captured images generated by three imaging systems are combined on the basis of an angle (convergence angle) formed by optical axes of the three imaging systems. Specifically, in an overlapping portion of two captured images generated by two imaging systems, one of the captured images is removed on the basis of the convergence angle and, after the removal, the two captured images are combined.

In Part “a” of FIG. 24, the captured image 314 and corrected images 317 and 318 generated by the first to third imaging systems 191 to 193 in the imaging unit 130 are shown. Note the captured image 314 and the corrected images 317 and 318 are the same as those shown in Part “a” of FIG. 23. As shown in Part “a” of FIG. 24, the captured image 314 and the corrected images 317 and 318 with trapezoidal distortions corrected by the trapezoidal distortion correction processing are acquired.

As described above, the same subject is included in the area at the right end of the corrected image 317 and the area at the left end of the captured image 314. The same subject is included in the area at the left end of the corrected image 318 and the area at the right end of the captured image 314. A method of calculating the areas including the same subjects is described below.

In FIG. 22, a distance between the intersection S11 and the intersection S21 is represented as L61. A distance between the intersection S11 and the intersection S13 is represented as L62. A distance between the intersection S51 and the intersection S21 is represented as L63. A distance between the intersection S13 and the intersection S51 is represented as L64. A distance between the intersection S32 and the intersection S51 is represented as L65. A distance between the intersection S32 and the intersection S13 is represented as L66. Note that the distance L66 is a distance for specifying areas including the same subject in a captured image generated by the first imaging system 191 and a captured image generated by the second imaging system 192. The areas are common areas of an area at the left end of the captured image generated by a first imaging system 191 and an area at the right end of the captured image generated by the second imaging system 192.

The following Formulas 7 and 8 hold according to the formula of the trigonometric function.

L61=(L11+L12)×tan θ0 Formula 7

L62=L12×tan θ1 Formula 8

The following Formula 9 is obtained according to the formula trigonometric function and Formula 2.

$$\begin{matrix}L 63 = L 51 \times tan θ0 \\ = [ \{ ( L 11 + L 12 ) / cos θ0 \} - L 11 ] \times cos θ0 \times tan θ0\end{matrix} \qquad Formula 9$$

The following Formula 10 is obtained by using Formulas 7 and 8.

$$\begin{matrix}L 64 = L 62 + L 63 - L 61 \\ = ( L 12 \times tan θ1 ) + ( \begin{matrix}[ \{ ( L 11 + L 12 ) / cos θ0 \} - L 1 \; 1 ] \times \\ cos θ0 \times tan θ0\end{matrix} ) - \\ \{ ( L 11 + L 12 ) \times tan θ0 )\end{matrix} \qquad Formula 10$$

The following Formula 11 is obtained according to the formula of the trigonometric function and Formula 2.

$$\begin{matrix}L 65 = L 51 \times tan ( θ2 - θ0 ) \\ = [ \{ ( L 11 + L 12 ) / cos θ0 \} - L 11 ] \times cos θ0 \times tan ( 2 θ - θ0 )\end{matrix} \qquad Formula 11$$

The following Formula 12 is obtained by using Formulas 10 and 11 obtained above.

$$\begin{matrix}L 66 = L 65 + L 64 \\ = \{ \begin{matrix}[ \{ ( L 11 + L 12 ) / cos θ0 \} - L 11 ] \times \\ cos θ0 \times tan ( θ2 - θ0 )\end{matrix} \} + \\ ( L 12 \times tan θ1 ) + ( [ \{ ( L 1 \; 1 + L 12 ) / cos θ \} - L 11 ] \times \\ cos θ0 \times tan θ0 ) - [ \{ ( L 11 + L 12 ) \times tan θ0 \} ]\end{matrix} \qquad Formula 12$$

When the distances L11 and L12 in the optical axis 194 of the first imaging system 191 are determined, the distance L66 can be calculated by using Formula 12. Distances can be calculated in the same manner concerning common areas of an area at the right end of the captured image generated by the first imaging system 191 and an area at the left end of the captured image generated by the third imaging system 193.

In Part “b” of FIG. 24, areas as combination targets in the captured image 314 and the corrected images 317 and 318 are shown. For example, concerning the captured image 314 generated by the first imaging system 191, areas equivalent to the distance L66 calculated by using Formula 12 are deleted. Similarly, concerning the captured image 314, the common area calculated concerning the right end of the captured image 314 is deleted. In Part “b” of FIG. 24, an external shape of an image 327 after the common areas at both the ends is indicated by a thick line.

In Part “c” of FIG. 24, a panorama image 330 generated by using the captured image 314 and the corrected images 317 and 318 is shown. After the images at both the ends are deleted in the captured image 314 as shown in Part “b” of FIG. 24, a panorama image is generated by using the image 327 after the deletion and the corrected images 317 and 318. For example, the corrected image 317 is coupled to the left end of the image 327 and the corrected image 318 is coupled to the right end of the image 327 to generate the panorama image 330.

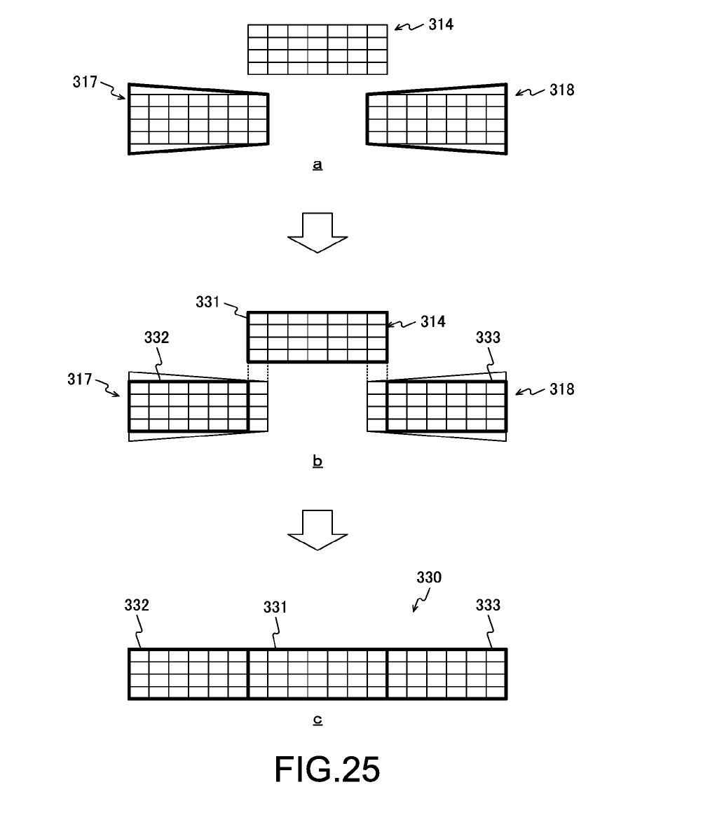

FIG. 25 is a schematic diagram of a flow of combination when the image combination processing unit 224 in the first embodiment of the present disclosure generates a combined image. The example shown in FIG. 25 is a modification of FIG. 24. An image including areas deleted in image combination is different. Specifically, as shown in Part “b” of FIG. 25, concerning the corrected image 317 corresponding to the captured image generated by the second imaging system 192, an area (area at right end) equivalent to the distance L66 calculated by using Formula 12 is deleted. Similarly, concerning the corrected image 318, a common area calculated concerning the left end is deleted. In Part “b” of FIG. 25, external shapes of images 332 and 333 after the common areas are deleted are indicated by thick lines.

In Part “c” of FIG. 25, the panorama image 330 generated by using images 331 to 333 is shown. As shown in Part “b” of FIG. 25, for example, the image 332 is coupled to the left end of the image 331 and the image 333 is coupled to the right end of the image 331 to generate the panorama image 330.

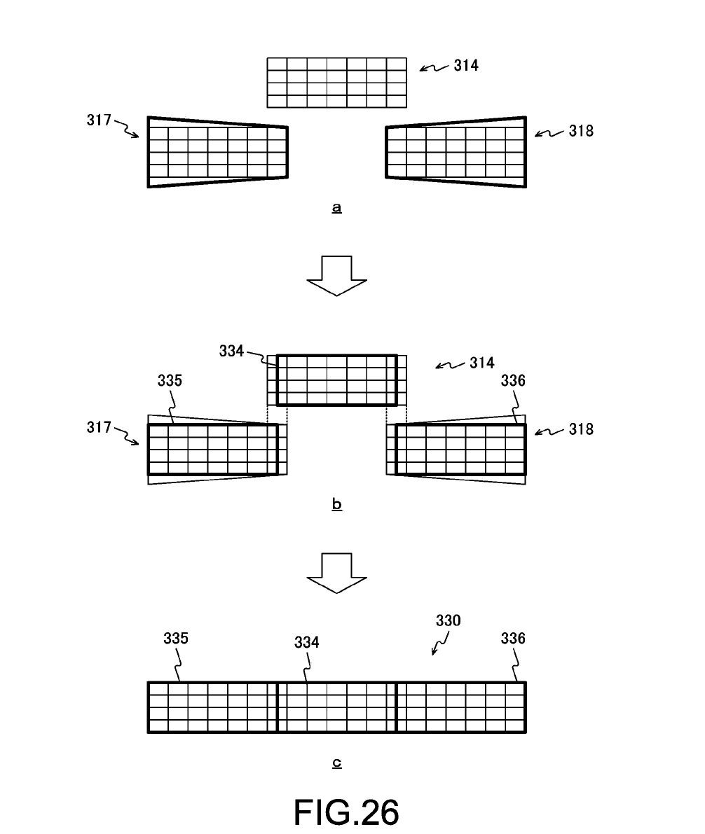

FIG. 26 is a schematic diagram of a flow of combination when the image combination processing unit 224 in the first embodiment of the present disclosure generates a combined image. The example shown in FIG. 26 is a modification of FIG. 24. An image including areas to be deleted in image combination is different. Specifically, as shown in Part “b” of FIG. 26, concerning the captured image 314 generated by the first imaging system 191, areas equivalent to a half of the distance L66 calculated by using Formula 12 are deleted. Concerning the corrected image 317 corresponding to the captured image generated by the second imaging system 192, an area (area at right end) equivalent to a half of the distance L66 calculated by using Formula 12 is deleted.

Similarly, concerning the captured image 314, a half of the common area calculated concerning the right end of the captured image 314 is deleted. An area (area at left end) equivalent to the half of the common area is deleted concerning the corrected image 318 corresponding to the captured image generated by the third imaging system 193. In Part “b” of FIG. 26, external shapes of the images 334 to 336 after the common areas are deleted are indicated by thick lines.

In Part “c” of FIG. 26, the panorama image 330 generated by using the images 334 to 336 is shown. As shown in Part “b” of FIG. 26, for example, the image 335 is coupled to the left end of the image 334 and the image 336 is coupled to the right end of the image 334 to generate the panorama image 330. It is possible to appropriately combine images by deleting parts of images in this way.

Note that these kinds of image combination processing are performed by the image combination processing unit 224. In the example shown in FIG. 8, in the image-signal processing unit 220, the image combination processing unit 224 is arranged at a post-stage of the YC conversion processing unit 223 and at a pre-stage of the sharpness processing unit 225. However, the image combination processing may be performed at other stages of the image-signal processing unit 220. For example, the trapezoidal distortion correction processing and the image combination processing may be performed at a pre-stage of the demosaic processing unit 222. For example, the trapezoidal distortion correction processing and the image combination processing may be performed at a post-stage of the demosaic processing unit 222 and at a pre-stage of the YC conversion processing unit 223. Further, for example, the trapezoidal distortion correction processing and the image combination processing may be performed at a post-stage of the color adjustment processing unit 226.

When such image combination processing is performed, for example, concerning images after trapezoidal distortion correction, overlapping areas of the images are measured in advance. It is possible to perform, using measured values, deletion processing for the overlapping areas of the images in a software manner with an arithmetic apparatus such as a CPU incorporated in the information processing apparatus 100.

In this example, the three captured images are combined on the basis of a convergence angle. However, for example, the image combination processing may be performed by using other image combining methods. For example, it is possible to use an image combining method for, concerning an overlapping portion of two images generated by two imaging systems, matching patterns of the two images and combining the two images by the pattern matching. It is also possible to use an image combining method for calculating a change in a density level in two images generated by two imaging systems, calculating an overlapping portion on the basis of the change in the density level, and combining the two images.

[Configuration Example of Image File]

Next, image data (image file) recorded on the recording medium 180 by still image recording processing in the information processing apparatus 100 will be described in detail with reference to the drawings.

FIG. 27 is a diagram of an example of a file structure of an image file to be stored in the recording medium 180 in the first embodiment of the present disclosure. In the example shown in FIG. 27, a file structure of a still image file to be recorded by a design rule for camera file system (DCF) standard is schematically shown.

The DCF is a file system standard for realizing mutual use of images between apparatuses such as a digital still camera and a printer via the recording medium. In the DCF, how to name a file and a configuration of a folder in the case of recording on the recording medium with an exchangeable image file format (Exif) as a base are defined. The Exif is a standard for adding image data and camera information in an image file and defines a format (file format) for recording an image file. In Part “a” of FIG. 27, a configuration example of an image file 181 is shown. In Part “b” of FIG. 27, a configuration example of accompanying information 182 is shown. In Part “c” of FIG. 27, a configuration example of a maker note 185 is shown.

The image file 181 is a still image file to be recorded by a DCF standard. As shown in Part “a” of FIG. 27, the image file 181 includes the accompanying information 182 and image information 183. The image information 183 is, for example, image data obtained by the resolution converting unit 251 resolution-converting the image data generated by the imaging unit 130 and subjected to various types of image signal processing by the image-signal processing unit 220 and by the encoding/decoding unit 252 compressing the resolution-converted image data. The image data is compressed by a joint photographic experts group (JPEG) format, for example.

As shown in Part “b” of FIG. 27, the accompanying information 182 includes attribute information 184 and a maker note 185. The attribute information 184 is attribute information or the like relating to the image file 181, and includes, for example, GPS information, azimuth information, property information (e.g., device property) of an imaging unit, imaging update date and time, an image size, a color space information, and a maker name.

The maker note 185 is generally an area in which data unique to the user is recorded, and an extended area (TAGID=37500, MakerNote) in which each maker can freely record information. As shown in Part “c” of FIG. 27, for example, single-eye imaging/multi-eye imaging 186, presence and absence of panoramic image 187, focus position information 188, face information 189, and moving body information 190 are recorded in the maker note 185 as information relating to a captured image.

The single-eye imaging/multi-eye imaging 186 is information indicating which of image data generated using only the imaging device 134 (single-eye imaging) and image data of pieces of image data generated using the imaging devices 134 to 136 (multi-eye imaging) it is. For example, “0” is stored in the case of the image data generated by single-eye imaging or “1” is stored in the case of the image data generated by multi-eye imaging.

The presence and absence of a panoramic image 187 is information indicating which of an image (panoramic image) having an aspect ratio beyond a certain value and an image (normal image) other than such an image it is. For example, “0” is stored in the case of the normal image or “1” is stored in the case of the panoramic image.

The focus position information 188 is information on a focus position in a captured image. For example, information on a focus position detected by the AF control unit 281 is stored.

The face information 189 is information including a position and a size of a face included in an image generated by the imaging unit 130. For example, a position (coordinates) at an upper left corner in a rectangular area including a face in a captured image is stored as the position of a face, and a length (longitudinal width and lateral width) in the vertical direction and the horizontal direction of the rectangular area of the captured image is stored as the size of a face. The face information is detected by the face detection unit 282.

The moving body information 190 is information including a position and a size of a moving body (moving object (e.g., running car)) included in an image generated by the imaging unit 130. For example, a position at an upper left corner of the rectangular area including the moving body in the captured image is stored as the position of the moving body, and length (longitudinal width and lateral width) in the vertical direction and the horizontal direction of the rectangular area of the captured image is stored as the size of the moving body. The moving body information is detected by the CPU 202.

Further, using the accompanying information 182 (attribute information 184 and maker note 185) recorded in the image file 181, it is possible to display various images during reproduction.

[Display Timing Example of Still Image]

Now, a timing when an image display is necessary in the information processing apparatus that handles a still image is described. The timing when an image display is necessary in the information processing apparatus that handles a still image mainly includes four timings of a live view display, a postview display, a reproduction display, and a list display (so-called thumbnail display) of recorded images. Those image displays are described.

Note that, as mentioned above, a single-eye imaging apparatus capable of generating a panoramic image by an operation of rotating an imaging apparatus in the horizontal direction with an imaging position (position of photographer) being a center of rotation (so-called panning operation) exists. When the panoramic image is generated by this single-eye imaging apparatus, an image displayed on the display unit at an imaging start of a panoramic image forms one end of the panoramic image and an image displayed on the display unit at an imaging end of the panoramic image forms other end of the panoramic image. Therefore, the user can relatively easily know where imaging of the panoramic image starts and where the imaging of the panoramic image ends.

Further, when the panoramic image is generated by the single-eye imaging apparatus, a range of the panoramic image as an imaging target can be changed during imaging. For example, an image corresponding to a position at which imaging of the panoramic image is started forms one end of the panoramic image and an image corresponding to a position at which the imaging of the panoramic image is stopped forms other end of the panoramic image.

In contrast, the information processing apparatus 100 is capable of capturing a panoramic image instantly when a shutter button (e.g., determination key 112) is depressed. That is, a panoramic image can be instantly captured at a timing desired by the user. In the information processing apparatus 100, capturing of the panoramic image is instantly completed in this manner, it is necessary to determine an angle of view (e.g., range in horizontal direction desired by user) before capturing. For example, during a live view display before capturing the panoramic image, a check in the display unit 140 is necessary. For example, it is necessary to check whether a main subject is included in an angle of view and whether the subject is in a good state (whether person doesn't close eyes or whether it is moment when butterfly sits on flower). Further, it is necessary to check an imaging area from a right end to a left end of an image (whether desired subject is included).

(1) Live View Display

The live view display is an operation of displaying a captured image generated by the imaging unit 130 on the display unit 140 before a still-image recording instruction operation is performed in a state in which a still image recording mode is set. That is, the live view display is a moving-image display in which an image currently input into the imaging unit is continuously displayed in order for the user to check the subject before the imaging operation (i.e., depression of shutter button). Further, an image (captured image) to be displayed in the live view display will be referred to as a live view image.

Aims of the live view display in the information processing apparatus are mainly the following (a) to (c).

(a) To check, by the user of the information processing apparatus 100, whether a main subject is included in an angle of view (in other words, area recoded as image) while viewing the live view image.

(b) To adjust and determine, while checking an area to be recoded from the left to the right as an angle of view (in other words, area to be recorded as image, particularly, area to be recorded from left to right in case of panoramic image), that area.

(c) To determine an imaging timing by checking the state of a main subject (e.g., whether person doesn't close eyes or whether it is moment when butterfly sits on flower).

Further, each area can be adjusted by sequentially feeding back and displaying adjustment results in the live view display.

(2) Postview Display

The postview display is an operation of automatically displaying, when a still-image recording instruction operation is performed in a state in which a still image recording mode is set and then recording processing based on the recording instruction operation is completed, the recorded captured image for a predetermined period. That is, the postview display is a display for the user to check a recorded image after an imaging operation (i.e., after recording processing of panoramic image by depression of shutter button is completed). An image (captured image) displayed in the postview display will be referred to as a postview image.

It is also assumed that, for example, in order to reduce power consumption of the information processing apparatus 100, a clock frequency is intentionally decreased based on an instruction by the user or information on a remaining battery amount. In this case, there is a possibility that the image signal processing and the image recording processing of a still image are not completed within a predetermined period of time. In such a case, after the user performs a still-image recording instruction operation, a monitoring image is not displayed on the display unit 140 for a predetermined period. Specifically, from a point of time when the recording instruction operation is performed to a point of time when recording processing of the captured image is completed in the information processing apparatus 100, a message that capturing of new captured image cannot be performed because the image signal processing and the image recording processing are performed is displayed on the display unit 140. For example, a solid color image (e.g., black or dark blue) is displayed on the display unit 140 and, on this solid color image, characters of “Under processing” or “Wait for a while” or a mark indicating that processing is being executed within the apparatus (e.g., hourglass) is displayed. In this manner, an image indicating that capturing of a new captured image cannot be performed will be referred to as “black image” and this display operation will be referred to as a “black image display operation.” That is, when the user performs a still-image recording instruction operation, a black image is displayed on the display unit 140 by the black image display operation, and, after a predetermined period, the postview image is displayed on the display unit 140 by a postview operation.

Aims of the postview display in the information processing apparatus are mainly the following (d) and (e).

(d) To check an image recorded by imaging and determine, based on this, whether or not re-capturing of the image is necessary.

For example, whether or not an angle of view (i.e., area of image recorded by imaging) is satisfactory or whether or not the state of the subject is satisfactory (e.g., whether it is moment when butterfly sits on flower) is checked. Whether or not re-capturing of the image is necessary is also determined with the check.

For checking the angle of view, it is important to check the right end and the left end of the image in order to know which area is imaged and recorded as the panoramic image. Further, for checking the state of the subject, it is important to check how a main subject is imaged and recorded in detail.

(e) To view image recorded by imaging.

Viewing an image has the same aim as that of the reproduction display of an image shown in the following. Further, the check of the captured image and the determination to re-capture the image are only for the postview display, and re-capturing can no longer be performed in many cases if an occasion is missed. Therefore, the main aim of the postview display is (d) to check the image and determine whether or not to re-capture the image rather than (e) to view the image. Note that the postview display is aimed to check an image recorded by still-image recording processing, and hence a real-time moving-image display as in the live view is not performed and a display of a recorded still image is performed.

(3) Reproduction Display

The reproduction display is an operation of reproducing content (e.g., panoramic image) stored in the recording medium 180 by the user operation at an arbitrary point of time.

Further, a main aim of the reproduction display of the image in the information processing apparatus is to view an image recorded by imaging. In viewing the panoramic image, it is favorable that both of viewing a whole of an image and viewing the details of the main subject in detail is possible.

Note that the reproduction display shown here is aimed to view an image recorded by the still-image recording processing, and hence the real-time moving-image display as in the live view is not performed and a display of a recorded still image is performed.

(4) List Display (So-Called Thumbnail Display) of Recorded Images

When a plurality of images are captured and recorded, it is convenient that a plurality of images can be viewed in one glance in order to know which images are recorded. It should be noted that a plurality of recorded images are displayed on the display unit 140, and hence the size of a single image inevitably becomes small.

It is favorable that, in this state, in each image (in particular, panoramic image), the user can view what is included in the image.

Note that the thumbnail display is aimed to display recorded images in a list, and hence only a still-image display is performed.

[Display Timing example of Moving Image]

Next, a timing at which an image display is necessary in the information processing apparatus that handles a moving image will be described. Timing at which an image display is necessary in the information processing apparatus that handles a moving image mainly includes three timings of a real-time display, a reproduction display, a list display (so-called thumbnail display) of recorded images. Those image displays are described.

(1) Real-Time Display

A main aim of the real-time display in the information processing apparatus is to check an angle of view of an image as a recording target and check a state of a subject before and during imaging in a state in which a moving-image recording mode is set.

Note that the real-time display is aimed to check a moving image in real-time before and during recording, and hence only the moving-image display is performed.

(2) Reproduction Display

A main aim of the reproduction display of an image in the information processing apparatus is to view an image recorded by imaging. In viewing the panoramic image, it is favorable that two things: viewing a whole of an image and viewing the details of the main subject in detail are possible.

Note that the reproduction display shown here is aimed to view a moving image recorded, and hence only the moving-image display is performed.

(3) List Display (So-Called Thumbnail Display) of Recorded Image

When recording is performed by capturing a plurality of images, it is convenient that a representative image (e.g., image at start of capturing moving image) can be viewed in one glance as a still image in order to know which images are recorded. It should be noted that a plurality of recorded images are displayed on the display unit 140, and hence the size of a single image inevitably becomes small. It is favorable that, in this state, in each image (in particular, panoramic image), the user can view what is included in the image.

Note that the thumbnail display is aimed to display a head image of the recorded moving image in a list and only a still-image display is performed.

Note that, in the first embodiment of the present disclosure, the “image” described herein has the meaning of an image itself and also has the meaning of image data for displaying the image.

[Functional Configuration Example of Information Processing Apparatus]

FIG. 28 is a block diagram of a functional configuration example of the information processing apparatus 100 in the first embodiment of the present disclosure.

The information processing apparatus 100 includes the display unit 140, the attitude detection unit 150, an image generation unit 510, an image memory 520, a record control unit 530, a storage unit 540, a display control unit 550, and an operation receiving unit 560.

The image generation unit 510 generates a captured image by imaging a subject, and stores the generated captured image in the image memory 520. This captured image is, for example, a captured image generated using one imaging device 134 or a captured image (e.g., panoramic image) by combining three captured images generated using three imaging devices 134 to 136. Those captured images are generated depending on a user operation received by the operation receiving unit 560. Further, the image generation unit 510 outputs pieces of information during generation of the captured image to the display control unit 550 and the record control unit 530. The pieces of information during generation of the captured image are, for example, information (face information) relating to a face included in the captured image and information (focus position information) relating to a focus position (e.g., pieces of information of Part “c” of FIG. 27). That is, the image generation unit 510 functions as a detection unit that detects a specific target in a panoramic image. Note that the image generation unit 510 corresponds, for example, to the imaging unit 130 and the DSP 200 shown in FIG. 2 (image-signal processing unit 220, AF control unit 281, face detection unit 282, and the like shown in FIG. 7). Further, the image generation unit 510 is an example of a target detection unit described in scope of claims.

The image memory 520 stores the captured images generated by the image generation unit 510 or captured images (image files) acquired from the storage unit 540 by the display control unit 550. The image memory 520 supplies the stored captured images to the recording control unit 530 or the display control unit 550. Note that, for example, the image memory 520 corresponds to the image memory 170 shown in FIG. 2.

The recording control unit 530 records the captured image generated by the image generation unit 510 and stored in the image memory 520 in the storage unit 540 as an image file in accordance with the user operation received by the operation receiving unit 560. Moreover, the recording control unit 530 records information (respective kinds of information produced when captured image is generated), which is output from the image generation unit 510, in the image file when recording the captured image. For example, when the panoramic image (horizontally long image) is recorded, the record control unit 530 records specific-target information (e.g., face information 189 shown in Part “c” of FIG. 27) relating to an area in which the specific target (e.g., face of person) is present in the storage unit 540 in association with the panoramic image. Note that, for example, the recording control unit 530 corresponds to the DSP 200 (imaging control unit 201, resolution converting unit 251, encoding/decoding unit 252, and the like shown in FIG. 7) shown in FIG. 2.

The storage unit 540 stores the captured image generated by the image generation unit 510 as an image file, and provides a stored image file to the display control unit 550. Note that the storage unit 540 corresponds to, for example, the recording medium 180 shown in FIG. 2.

According to the user operation received by the operation receiving unit 560, the display control unit 550 causes the display unit 140 to display the captured image generated by the image generation unit 510 and stored in the image memory 520. Further, according to the user operation received by the operation receiving unit 560, the display control unit 550 acquires an image file stored in the storage unit 540, stored in the image memory 520, and displays a captured image of the image file on the display unit 140. For example, the display control unit 550 is capable of displaying, on the basis of information recorded in an acquired image file (pieces of information during generation of captured image), images of the plurality of areas in the captured image stored in the image memory 520. For example, when displaying the panoramic image stored in the storage unit 540, the display control unit 550 is capable of displaying an image relating to an area in which the specific target is present, using the specific-target information recorded in association with the panoramic image. For example, it is possible to display an image of an area in which a face of a person is present using face information (face information 189 shown in Part “c” of FIG. 27).

The display control unit 550 displays an image on the display unit 140, for example, during the live view display, during the postview display, and during the reproduction display. In this case, for example, the display control unit 550 performs control to display the plurality of areas in the panoramic image generated by the image generation unit 510 in a plurality of rows in the longitudinal direction of the display unit 140.

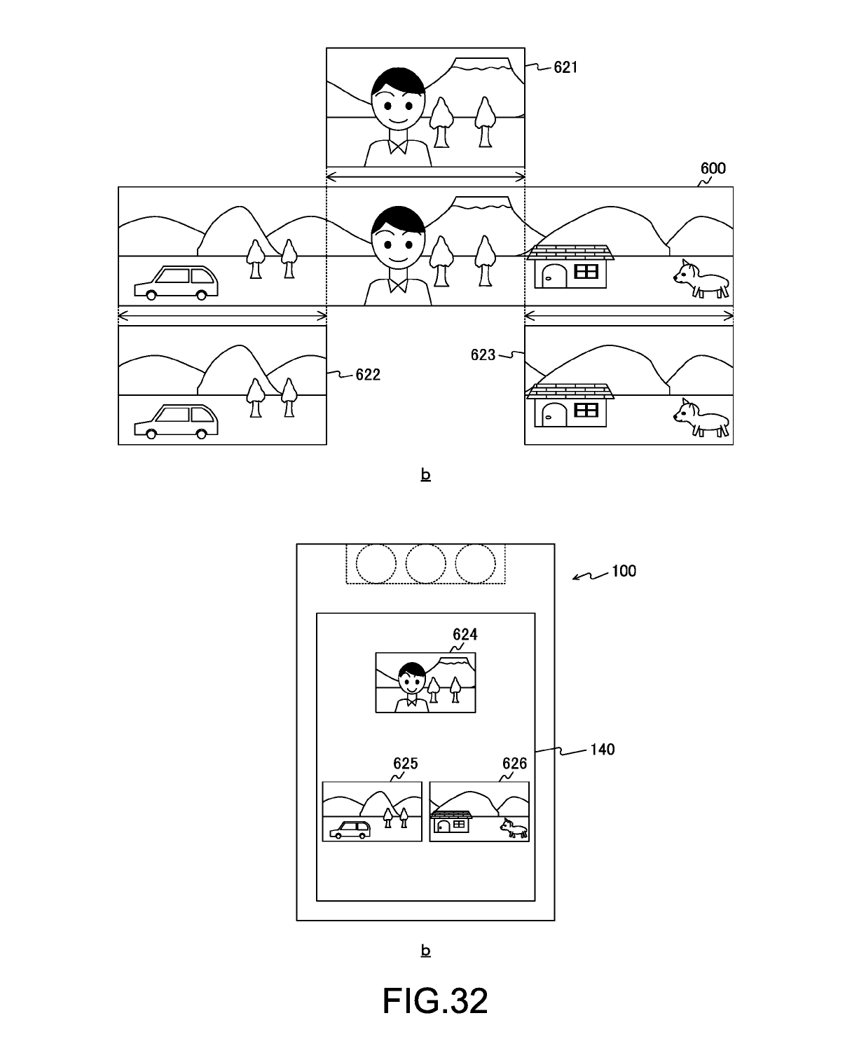

For example, as shown in FIG. 32 and the like, the display control unit 550 divides the panoramic image with an orthogonal direction orthogonal to the longitudinal direction of the panoramic image and displays the divided images in a plurality of rows in the longitudinal direction of the display unit 140. In this case, the display control unit 550 displays, for example, two images (left image and right image) including areas at the both end portions in the longitudinal direction of the panoramic image and an image (middle image) including an area present between the both end portions in two rows in the longitudinal direction of the display unit 140. Further, the display control unit 550 displays, for example, the left image and the right image in the same line and displays the middle image in another line. Further, the display control unit 550 displays the left image, the right image, and the middle image, for example, such that the left image, the right image, and the middle image have the same vertical size. The display control unit 550 displays the left image, the right image, and the middle image, for example, such that the middle image has a horizontal size larger than a horizontal size of each of the left image and the right image.

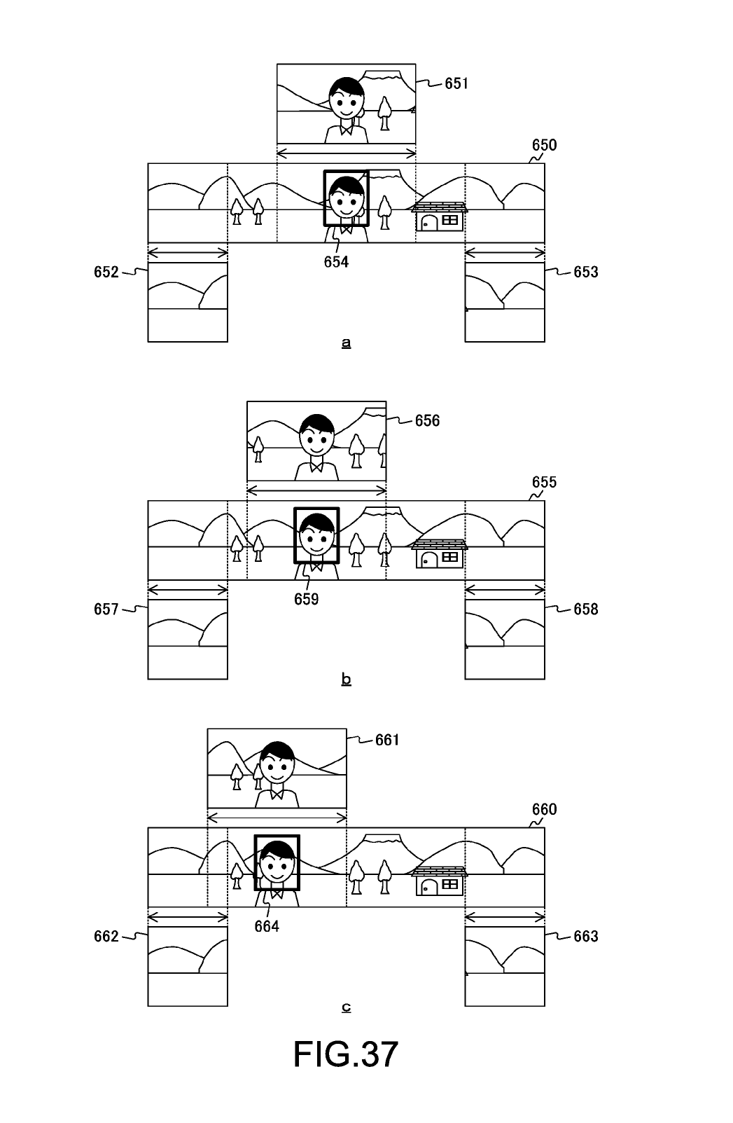

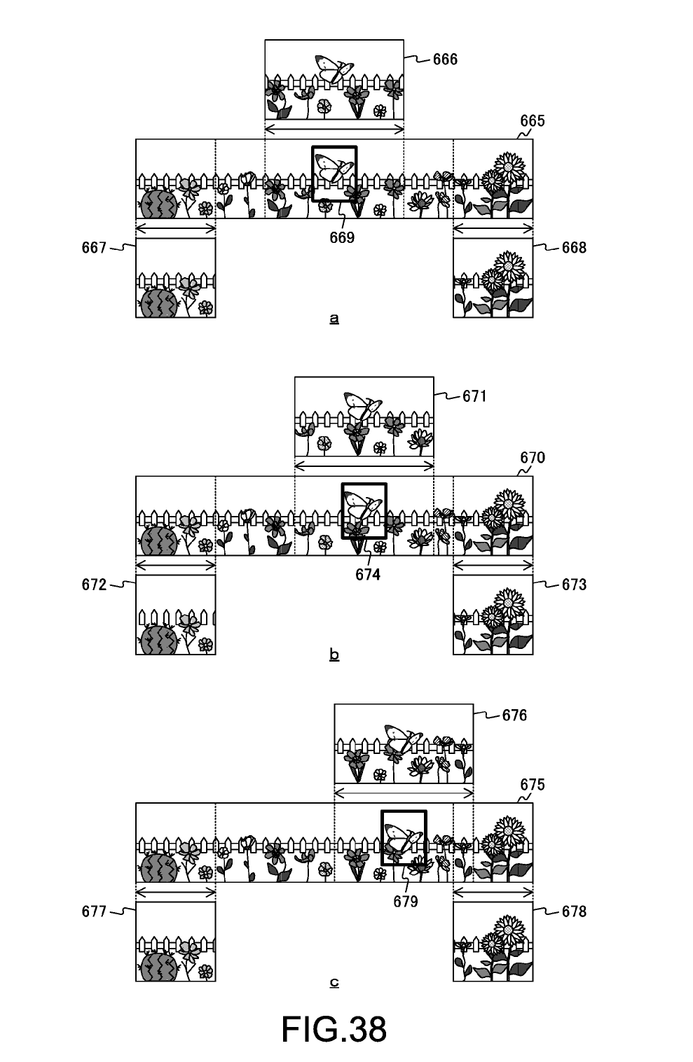

Alternatively, for example, as shown in FIGS. 37 and 38, the display control unit 550 may display an image including an area in which the specific target (e.g., person and butterfly) detected from the panoramic image is present, as the middle image.

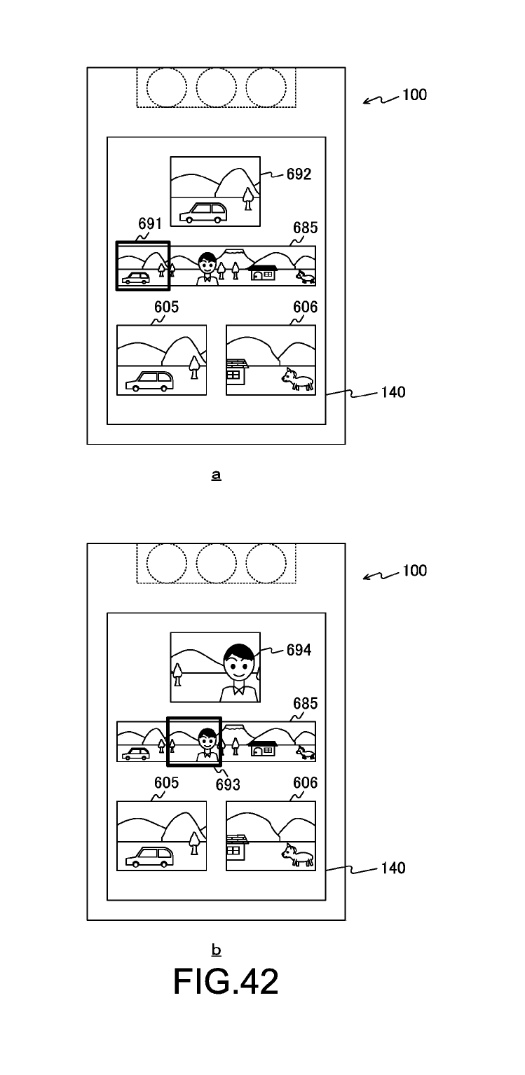

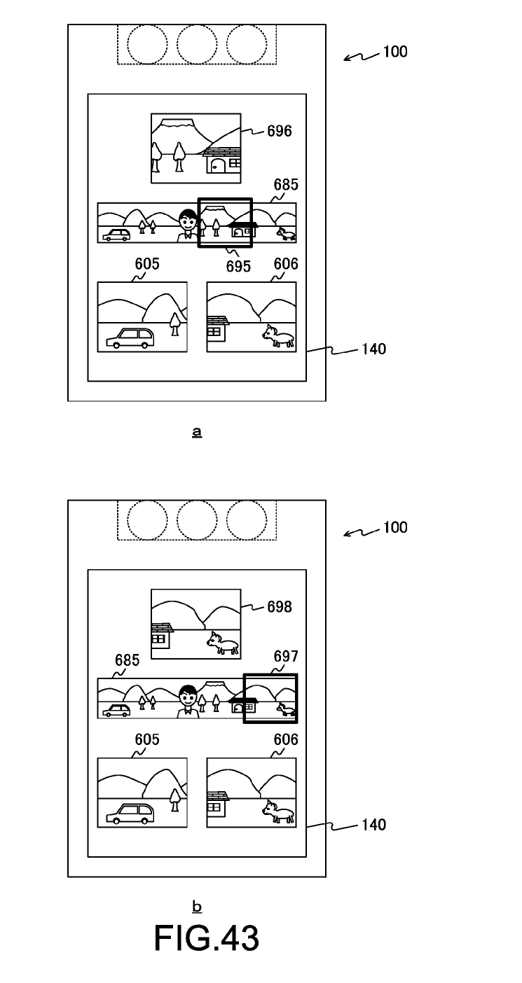

Alternatively, for example, as shown in FIGS. 42 and 43, the display control unit 550 may display the middle image while moving an area displayed as the middle image from one end to other end of the both end portions in the panoramic image.

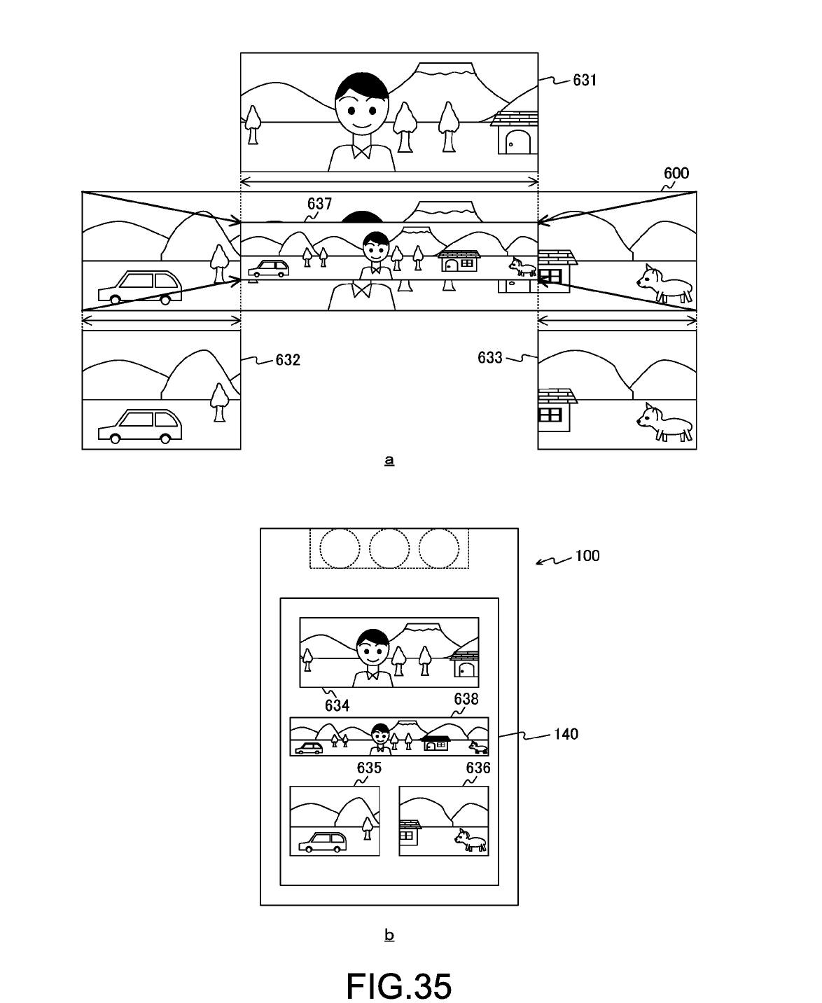

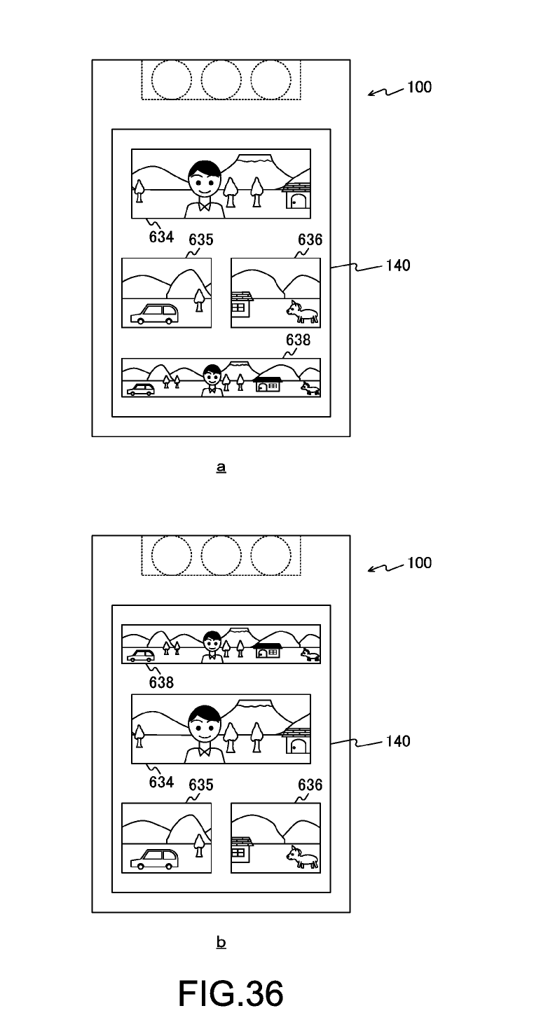

Alternatively, for example, as shown in FIGS. 35 and 36 and the like, the display control unit 550 may display a reduced image of the panoramic image in an area other than the display area of the plurality of areas in the panoramic image.

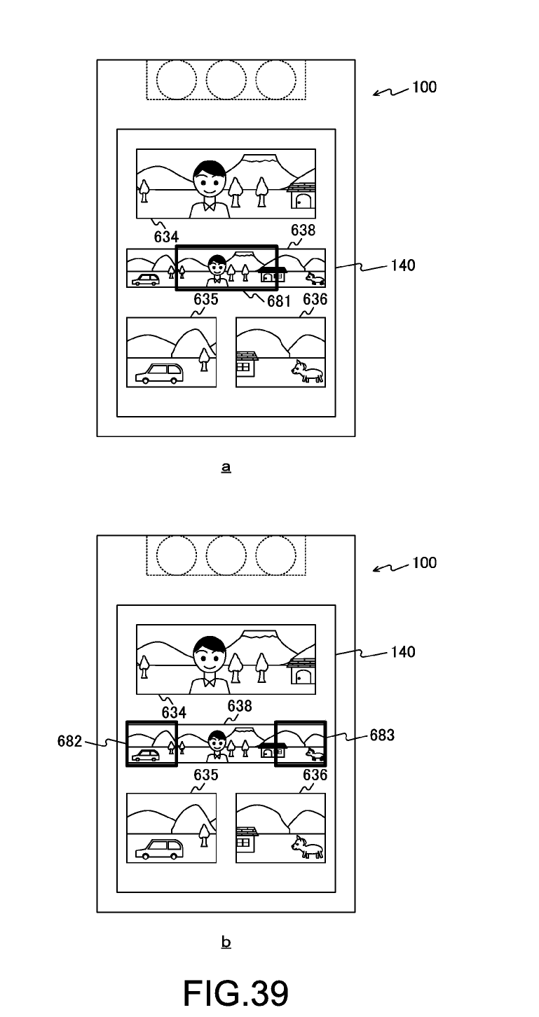

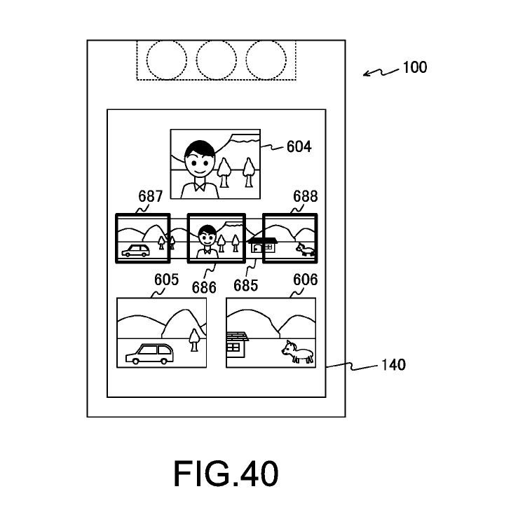

Alternatively, for example, as shown in FIGS. 39 and 40 and the like, the display control unit 550 may display display information (e.g., frames) indicating positions of the plurality of areas in the panoramic image in association with a reduced image of the panoramic image.

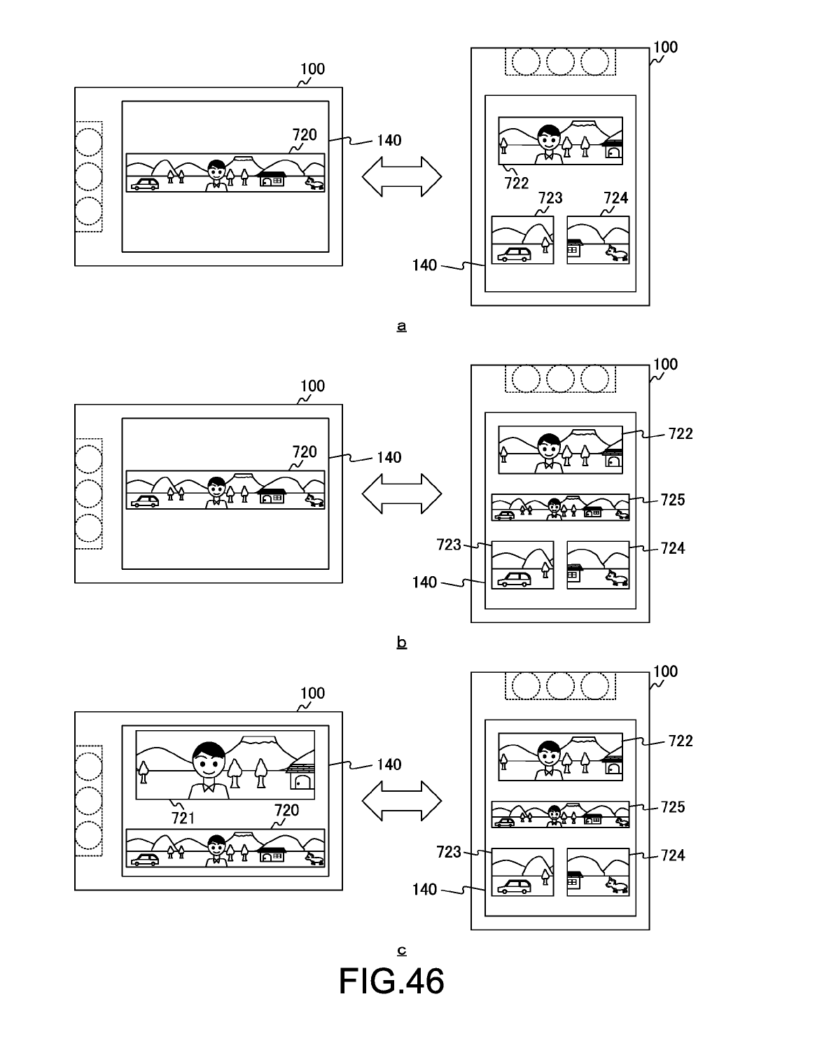

Note that, for example, as shown in FIG. 46, the display control unit 550 may determine whether or not the longitudinal direction of the panoramic image and the longitudinal direction of the display unit 140 may coincide with each other, and display the panoramic image on the display unit 140 without performing the above-mentioned controls if the longitudinal direction of the panoramic image and the longitudinal direction of the display unit 140 coincide with each other. On the other hand, when the longitudinal direction of the panoramic image and the longitudinal direction of the display unit 140 do not coincide with each other, the above-mentioned controls may be performed and the plurality of areas in the panoramic image may be displayed in a plurality of rows in the longitudinal direction of the display unit 140.

Furthermore, the display control unit 550 displays various setting screens on the display unit 140 in accordance with the user operation received by the operation receiving unit 560. Note that, for example, the display control unit 550 corresponds to the DSP 200 (imaging control unit 201, CPU 202, encoding/decoding unit 252, resolution conversion unit 231, image rotation processing unit 232, and the like shown in FIG. 7) shown in FIG. 2.

The display unit 140 displays various images based on the control of the display control unit 550. Note that, for example, the display unit 140 corresponds to the display unit 140 shown in FIG. 2.

The operation receiving unit 560 is an operation receiving unit that receives operation inputs from the user, and outputs the content of the received operation inputs to the respective units. For example, when a still-image recording instruction operation is performed by the user, the operation receiving unit 560 outputs the content of the instruction to the image generation unit 510, the recording control unit 530, and the display control unit 550. Moreover, when a display instruction operation to display the image files stored in the storage unit 540 is performed by the user, the operation receiving unit 560 outputs the content of the instruction to the display control unit 550. Moreover, when the image files stored in the storage unit 540 are displayed, and an instruction operation to change the displayed state is performed, the operation receiving unit 560 outputs the content of the instruction to the display control unit 550. Note that, for example, the operation receiving unit 560 corresponds to the respective operation members (changeover switch 111, determination key 112, and the like) shown in FIGS. 1 and 2.

The attitude detection unit 150 detects the attitude of the information processing apparatus 100 (display unit 140), and outputs a detection result thereof to the display control unit 550. For example, the attitude detection unit 150 detects whether the attitude of the information processing apparatus 100 is in the horizontal state or in the vertical state. Note that the attitude detection unit 150 corresponds to the attitude detection unit 150 shown in FIG. 2.

[Display Example of Panoramic Image]

Next, an example in which image data is read out from the imaging devices 134 to 136 and an image thereof is displayed on the display unit 140 will be described.

FIG. 29 is a diagram showing a relation between a subject as an imaging target and an imaging area of imaging processing by the information processing apparatus 100 in the first embodiment of the present disclosure.

In Part “a” of FIG. 29, a relation between the subject and the information processing apparatus 100 during the imaging operation is schematically shown. In Part “b” of FIG. 29, a panoramic image 600 corresponding to an imaging area (indicated by dotted rectangle 590) including the subject shown in Part “a” of FIG. 29 is shown.

Now, a traditional information processing apparatus is described. For example, in a multi-eye imaging apparatus (e.g., multi-eye digital still camera) constituted of a single casing, in general, the display apparatus is arranged in the casing such that the longitudinal direction of the rectangular casing corresponds to the longitudinal direction of the rectangular display apparatus. A single image as a recording target or a display target is a rectangle having an aspect ratio of 4:3 or 16:9, and hence it is important to allow the user to easily view those images as much as possible. In view of this, in order to display a whole of an image to be as large as possible in the rectangular display apparatus, the plurality of imaging systems including an optical system (lens and the like) and an imaging device are arranged within the casing such that an optical center arrangement line (line linking optical centers of plurality of imaging systems) and the longitudinal direction of the casing coincide with each other.

Note that, as in the single-eye imaging apparatus included in a single imaging system including a single optical system and a single imaging device that have the same optical center, the display apparatus is arranged in the casing such that the longitudinal direction of a rectangular casing and the longitudinal direction of a rectangular display apparatus coincide with each other. Further, such an arrangement is necessary also in an apparatus that handles a panoramic image having a large aspect ratio of an image.

In this manner, when imaging of a panoramic image (panoramic image extending in horizontal direction) is performed using the information processing apparatus in which the plurality of imaging systems are arranged in a direction parallel to the longitudinal direction of the information processing apparatus, it is assumed that the information processing apparatus is often used in the horizontal state. However, in the case of an information processing apparatus such as a smart phone and a cell phone, a rectangular casing and a rectangular display apparatus are often used in the vertical state. Concerning those information processing apparatuses, when the imaging system is arranged such that the long side of the display apparatus and the optical center arrangement line are in parallel, it is necessary to put an information processing apparatus into the horizontal state every time imaging of the panoramic image is performed, which may make it difficult for the user unfamiliar with capturing the panoramic image to use the apparatus.

In this manner, for example, when functions of the information processing apparatus other than an image-capturing function are used, the user often uses the information processing apparatus in the vertical state. On the other hand, concerning imaging the panoramic image and displaying the panoramic image, it is assumed that the information processing apparatus is used in the horizontal state. In this manner, it is cumbersome for the user to change the orientation of the casing depending on a function to be used.

In such an information processing apparatus, it is assumed that the optical center arrangement line (line linking optical centers of plurality of imaging systems) is parallel to the longitudinal direction of the casing and the optical center arrangement line is arranged near a center of a short side of the casing (end side of casing in longitudinal direction). However, when the imaging systems (optical systems) are arranged in this manner, there is a fear that design of the electronic substrate that serves functions other the image-capturing function becomes difficult. That is, many imaging system components including a lens and an imaging device have a large height among components of the information processing apparatus. Therefore, when the imaging system components are arranged near the center of the short side of the casing (end side of casing in longitudinal direction) such that the optical center arrangement line is parallel to the longitudinal direction of the casing, there is a fear that arrangement of the electronic substrate is interfered. For example, a concave portion on an upper side of the electronic substrate 101 shown in Part “e” of FIG. 1 becomes deeper.

In view of this, in the first embodiment of the present disclosure, an example in which the plurality of imaging units are arranged in the orthogonal direction orthogonal to the longitudinal direction of the display unit is shown. Further, an example in which the plurality of areas in the panoramic image including the plurality of images generated by the plurality of imaging units are displayed in a plurality of rows in the longitudinal direction of the display unit is shown.

Further, in the first embodiment of the present disclosure, an example in which the panoramic image is divided and displayed when the panoramic image generated by using the plurality of imaging systems is displayed in a state in which the longitudinal direction in the display unit 140 of the information processing apparatus 100 and the vertical direction almost coincide with each other is shown. Note that, in the example shown below, the longitudinal direction in the display unit 140 will be sometimes referred to as a Y-coordinate direction.

[Display Example of Panoramic Image]

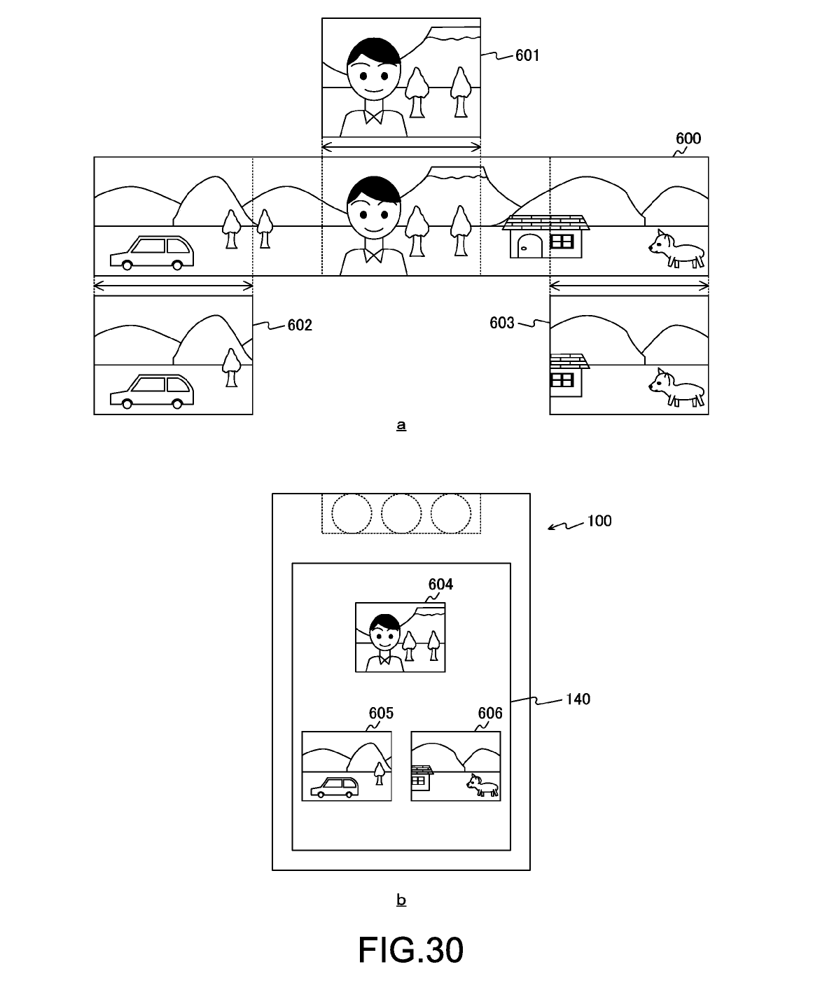

FIGS. 30 to 32 are diagrams showing a relation between the panoramic image 600 generated by the image generation unit 510 in the first embodiment of the present disclosure and images displayed on the display unit 140 by the display control unit 550. Note that, as a timing at which the panoramic image is displayed on the display unit 140, as described above, the live view display, the postview display, the reproduction display, and the like are assumed.

In Part “a” of FIG. 30, the panoramic image 600 generated by the image generation unit 510 and images 601 to 603 as the display target is shown. Note that the panoramic image 600 is the same as the panoramic image 600 shown in Part “b” of FIG. 29.

In Part “b” of FIG. 30, images 604 to 606 displayed on the display unit 140 by the display control unit 550 are shown. The image 604 corresponds to the image 601 shown in Part “a” of FIG. 30, the image 605 corresponds to the image 602 shown in Part “a” of FIG. 30, and the image 606 corresponds to the image 603 shown in Part “a” of FIG. 30.

In this manner, the image (middle image) 604 arranged in an upper row in the longitudinal direction of the display unit 140 is set to be an image near the center of the panoramic image. Further, the image (left image) 605 arranged on a lower left-hand side in the longitudinal direction of the display unit 140 is set to be an image at a left end in the panoramic image 600 and an image (right image) 606 arranged on a lower right-hand side is set to be an image at a right end in the panoramic image 600.

In this manner, at least three images are displayed at at least two positions in the longitudinal direction of the display unit 140. Note that, in the first embodiment of the present disclosure, as described above, an image arranged in an upper row in the longitudinal direction of the display unit 140 will be referred to as the middle image. Further, an image arranged on a lower left-hand side in the longitudinal direction of the display unit 140 will be referred to as the left image and an image arranged on a lower right-hand side will be referred to as the right image.

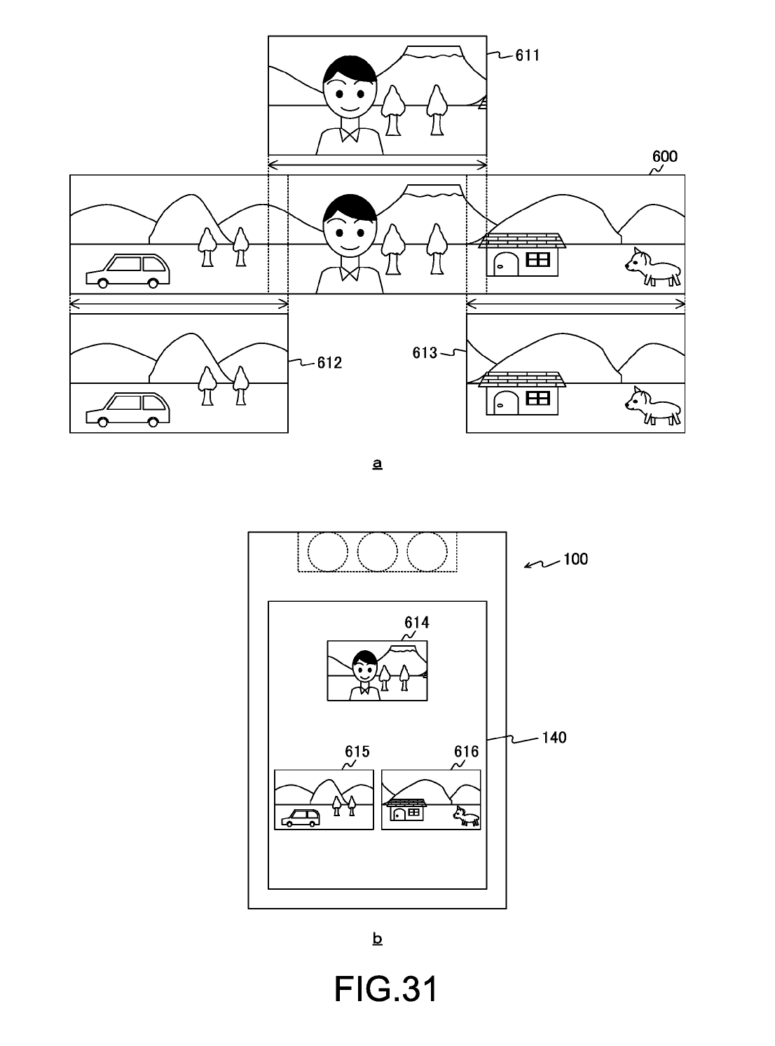

Note that, although a display example when the middle image and the left image and the middle image and the right image are separated from each other in the horizontal direction, respectively, is shown in FIG. 30, the middle image and the left image and the middle image and the right image partially overlap with each other, respectively. This display example is shown in FIG. 31. Further, boundaries in the horizontal direction between the middle image and the left image and between the middle image and the right image may connect to each other. This display example is shown in FIG. 32.

In Part “a” of FIG. 31, a relation between the panoramic image 600 and images 611 to 613 as the display target is shown. In Part “b” of FIG. 31, images 614 to 616 displayed on the display unit 140 by the display control unit 550 is shown.

In Part “a” of FIG. 32, a relation between the panoramic image 600 and images 621 to 623 as the display target is shown. In Part “b” of FIG. 32, images 624 to 626 displayed on the display unit 140 by the display control unit 550 is shown.

In this manner, in the first embodiment of the present disclosure, a left area with respect to the middle image, which is not displayed in the middle image, is displayed as a whole or part of the left image. Further, a right area with respect to the middle image, which is not displayed in the middle image, is displayed as a whole or part of the right image. Further, part of a right area with respect to the left image and part of the right area with respect to the left image are displayed as a whole or part of the middle image.

Note that, when the left image, the middle image, and the right image are displayed, it is favorable that those images (left image, middle image, and right image) are displayed at almost the same display magnification. Further, it is favorable that those images are displayed with almost the same vertical width (vertical size).

In this manner, by displaying three images in two rows in the longitudinal direction in the display unit 140, it is possible to display the images with a horizontal width (horizontal size) smaller than in the case of displaying the whole of the panoramic image on the display unit 140. That is, in the display unit 140 with a certain width, it is possible to display an enlarged image in comparison with the case of displaying the whole of the panoramic image. With this, for example, a car (present at left end) and a dog (present at right end) included in the panoramic image 600 are displayed as images having a relatively large size, and hence the user can easily check them.

The main aims in the case of the live view display are the above-mentioned aims (a) to (c). For example, the aims are (a) to check whether or not a main subject is included within an angle of view, (b) to adjust and determine, while checking an area to be recorded from the left to the right as an angle of view, the area, and (c) to determine an imaging timing by checking the state of a main subject.

In this manner, for achieving the aims (a) to (c), it is not necessarily necessary to display the whole of the panoramic image on the display unit 140 and it is important to display the main subject and the left and right ends of an angle of view in an enlarged state. Therefore, as shown in FIG. 30, the middle image and the left image and the middle image and the right image do not respectively overlap with each other, and, instead of this, it is favorable to display the middle image, the left image, and the right image as large as possible within a range displayable on the display unit 140.

If the middle image showing the main subject and the left and right images respectively showing the left and right ends of the angle of view are at different display magnifications (magnification ratios) when the middle image, the left image, and the right image are displayed, there is a fear that the user is confused when the user checks those images.

Further, if the middle image showing the main subject and the left and right images respectively showing the left and right ends of the angle of view have different vertical widths (vertical sizes), there is a fear that the user thinks those images as having different magnification ratios for a moment. Therefore, it is favorable that the display magnification (magnification ratio) of the middle image and the left and right images are the same. Further, it is favorable that the vertical width (vertical size) of the middle image and the left and right images are the same.

For example, in the case of various information processing apparatuses (e.g., cell phone and smart phone), display content in the display unit is often displayed such that the user can read the display content from the top to the bottom. Therefore, the user is often used to view the display unit from the top to the bottom.

Further, for example, when the live view display is performed, in many cases, the user first checks whether the main subject is appropriately included within an angle of view. Therefore, it is assumed that the user first views the middle image rather than the left image and the right image. In view of this, when the middle image, the left image, and the right image are arranged at different Y-coordinate positions in the display unit 140, it is favorable to arrange the middle image above the left image and the right image. Further, it is favorable to arrange the left image and the right image at the same Y-coordinate position.

FIGS. 30 to 32 show examples in which the middle image is displayed above the left image and the right image in the longitudinal direction in the display unit 140.

[Example in which Images are Displayed Such that Middle Image has Horizontal Width (Horizontal Size) Larger than that of Other Images]

In the examples shown in FIGS. 30 to 32, the middle image, the left image, and the right image are displayed while the middle image is arranged on an upper side in the longitudinal direction in the display unit 140 and the left image and the right image are arranged on a lower side thereof. Further, the middle image, the left image, and the right image are displayed with the same size. When the images are displayed in this manner, only one middle image is arranged on the upper side in the longitudinal direction in the display unit 140. Therefore, there is an empty area on the upper side in the longitudinal direction in the display unit 140. In view of this, an example in which the empty area on the upper side in the longitudinal direction in the display unit 140 is efficiently used is shown below.

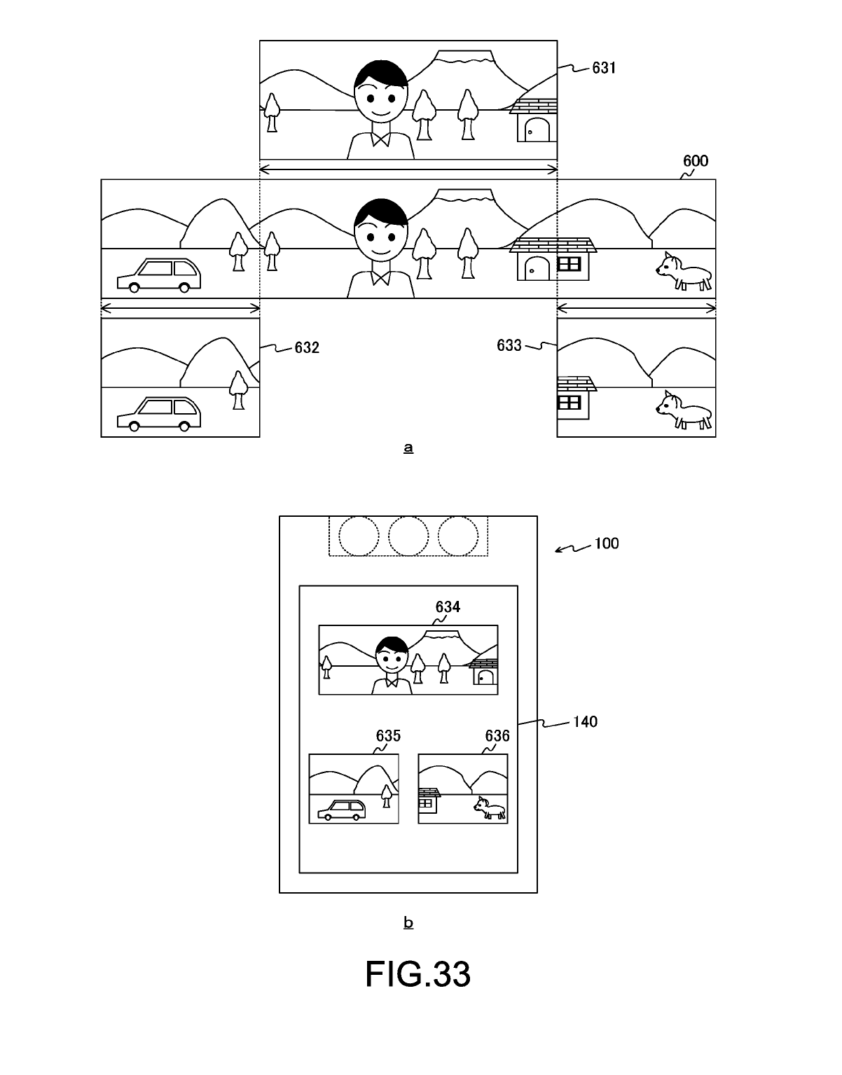

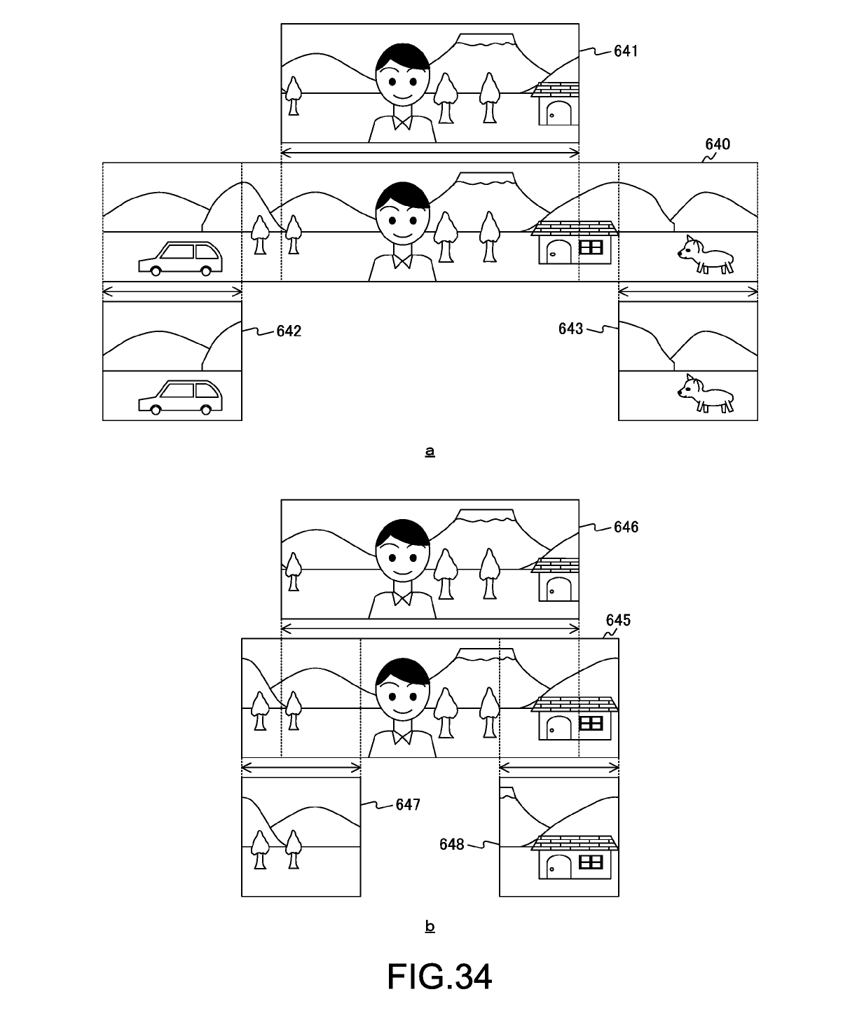

FIGS. 33 and 34 are diagrams showing a relation between the panoramic image 600 generated by the image generation unit 510 in the first embodiment of the present disclosure and images displayed on the display unit 140 by the display control unit 550.

In the example shown in FIG. 33, the middle image, the left image, and the right image are displayed such that the aspect ratio and the horizontal width (horizontal size) of the middle image are larger than those of the left image and the right image. Note that the relation between Parts “a” and “b” of FIG. 33 is the same as the relation between Parts “a” and “b” of FIG. 30 except for a point that the aspect ratio and the horizontal width (horizontal size) of the middle image are larger than those of other images (left image and right image). For example, other points in FIG. 33 (display magnifications of images are almost the same and vertical width (vertical size) of images are almost the same) are the same as those of FIG. 30.

With this, for example, in the case of the live view display, the user can check not only the state of the main subject but also the state of surroundings thereof in the middle image, and hence the user can easily check the vicinity of the center of the panoramic image. Therefore, the user also can easily check the background and the like around the person. In this manner, convenience for the user is improved.

Alternatively, regarding a relation between the middle image and each of the left image and the right image, a size other than the size shown in FIG. 33 may be adopted. This display example is shown in FIG. 34.

In Part “a” of FIG. 34, a relation between a panoramic image 640 having a horizontal size larger than a horizontal size of the panoramic image 600 and images 641 to 643 displayed on the display unit 140 by the display control unit 550 is shown.

In Part “b” of FIG. 34, a relation between a panoramic image 645 having a horizontal size smaller than a horizontal size of the panoramic image 600 and images 646 to 648 displayed on the display unit 140 by the display control unit 550 is shown. Note that the horizontal size can be appropriately changed by the user operation.

[Example in which Whole of Panoramic Image is Displayed]

In the above-mentioned example, the panoramic image is divided and displayed. Although the details of the panoramic image can be checked using the images (middle image, left image, and right image), it is assumed that some users desire to check also a whole of the panoramic image. In view of this, an example in which the whole of the panoramic image or an image similar to this image (e.g., partial panoramic image) are also displayed together with the images (middle image, left image, and right image) is shown below.

FIG. 35 is a diagram showing a relation between the panoramic image 600 generated by the image generation unit 510 in the first embodiment of the present disclosure and images as the display target and a display example of the display unit 140.

In Part “a” of FIG. 35, the panoramic image 600 generated by the image generation unit 510 is shown. In the example of FIG. 35, a reduced image of the whole of the panoramic image (or image similar to this image) is displayed together with the images (middle image, left image, and right image). Specifically, in Part “a” of FIG. 35, a relation between the panoramic image 600 and a reduced image 637 obtained by reducing the panoramic image 600 is schematically indicated by the four arrows. In Part “b” of FIG. 35, a display example of a reduced image 638 (corresponding to reduced image 637 shown in Part “a” of FIG. 35) displayed on the display unit 140 is shown. Note that the relation between Parts “a” and “b” of FIG. 35 is the same as the relation between Parts “a” and “b” of FIG. 33 except for a point that the entire image of the panoramic image 600 is displayed.

In particular, when an image is displayed in a state in which the longitudinal direction in the display unit 140 of the information processing apparatus 100 and the vertical direction almost coincide with each other, it is favorable to display the image as shown in Part “b” of FIG. 35. For example, it is favorable that the entire image (or similar image) 638 of the panoramic image is displayed at a display magnification smaller than that of a middle image 634, a left image 635, and a right image 636. That is, it is favorable that the entire image (or similar image) 638 of the panoramic image is displayed with a vertical width (vertical size) smaller than that of the middle image 634, the left image 635, and the right image 636.

In this manner, in the example shown in FIG. 35, the entire image of the panoramic image is displayed between the row of the middle image and the row of the left image and the right image. Note that, in each of the display examples shown in FIGS. 30 to 34, the entire image of the panoramic image may be displayed.

The entire image of the panoramic image (or image similar to this image) is displayed together with the middle image, the left image, and the right image in this manner, and hence the entire content of the panoramic image can be easily checked. That is, the display of the middle image, the left image, and the right image enables, for example, a check of the state of the main subject necessary during the live view display and a check of an angle of view from the left to the right to be performed. In addition, the display of the entire image of the panoramic image (or image similar to this image) enables the entire content of the panoramic image to be easily checked.

FIG. 36 is a diagram of display examples of the panoramic image displayed on the display unit 140 in the first embodiment of the present disclosure and images as the display target. In the example shown in FIG. 36, the entire image of the panoramic image (or image similar to this image) is displayed outside the display areas of the middle image, the left image, and the right image.

In the example shown in Part “a” of FIG. 36, the entire image (or similar image) 638 of the panoramic image is displayed on a lower side of the display areas of the left image 635 and the right image 636.

In the example shown in Part “b” of FIG. 36, the entire image (or similar image) 638 of the panoramic image is displayed on the upper side of the display area of the middle image 634.

In this manner, the display position of the entire image (or similar image) 638 of the panoramic image may be appropriately changed. Further, the display position may be changed depending on user preferences. For example, the display position may be changed by the user operation (e.g., movement by touch operation).

[Example in which Middle Image is Determined Based on Subject]

In the above-mentioned example, the image of the middle part (middle part in horizontal direction) of the panoramic image is set as the middle image. As described above, for example, the main aims in the case of the live view display are the above-mentioned three points (aims (a) to (c)).

For example, a case where a panoramic image in which the main subject is a person and the background is a distant landscape is captured is assumed. In this case, not only capturing an image having a composition in which a person as the main subject is located at the center of the image but also capturing an image having a composition in which the person is located at a position deviated to either one of the left and the right from the center of the image are performed. In such a case, if the area of the image displayed as the middle image is fixed at the center of the panoramic image (i.e., center of angle of view), it is assumed that an inconvenience may occur. For example, it is also assumed that the main subject (e.g., person) is not included in the middle image displayed as the live view display before imaging. In this case, there is a fear that the above-mentioned aims (a) and (c) cannot be achieved.

Further, for example, a case where, when a butterfly that is about to sit on a flower is imaged as the main subject, capturing an image having a composition in which this butterfly is present on a side of either one of the left and right ends rather than in the vicinity of the center of the panoramic image is performed is assumed. In this case, there is a fear that a timing for checking whether it is a moment when the butterfly sits on the flower and capturing an image cannot be determined. In view of this, an example in which the middle image is determined based on the subject is shown below.

[Example in which Middle Image is Determined Based on Position of Face Included in Panoramic Image]

FIG. 37 is a diagram showing relations between panoramic images 650, 655, and 660 generated by the image generation unit 510 in the first embodiment of the present disclosure and middle images 651, 656, and 661.

In the example of FIG. 37, the middle image is determined with the position of the face included in the panoramic image being a center. Rectangles 654, 659, and 664 shown in Parts “a” to “c” of FIG. 37 indicate positions of faces detected by the image generation unit 510 (face detection unit 282). In this manner, when the face of the person is detected from the panoramic image, the display control unit 550 generates the middle image with the position of the detected face (position in longitudinal direction of panoramic image) being a center.

For example, as shown in Part “a” of FIG. 37, when the face of the person (shown in rectangle 654) is detected from the panoramic image 650, the display control unit 550 generates the middle image 651 with the face being a center. For example, as shown in Part “b” of FIG. 37, when the face of the person (shown in rectangle 659) is detected from the panoramic image 655, the display control unit 550 generates the middle image 656 with the face being a center. For example, as shown in Part “c” of FIG. 37, when the face of the person (shown in rectangle 664) is detected from the panoramic image 660, the display control unit 550 generates the middle image 661 with the face being a center.

In the example shown in FIG. 37, the area of the face of the person detected by the face detection unit 282 during imaging and the area including surroundings thereof are set as the middle image. It should be noted that an area as a focus target during imaging and an area including surroundings thereof may be set as the middle image. Alternatively, an area of a moving body detected by a moving-body detection unit (e.g., CPU 202 shown in FIG. 7) during imaging and an area including surroundings thereof may be set as the middle image. Note that an example in which an area of a moving-body detected from a panoramic image and an area including surroundings thereof are set as the middle image is shown in FIG. 38.

Alternatively, a feature may be detected based on a result of an image analysis other than the above-mentioned processing (face detection, moving-body detection, and focusing) during imaging and an area of the detected feature and an area including surroundings thereof may be set as the middle image.

FIG. 38 is a diagram showing relations between panoramic images 665, 670, and 675 generated by the image generation unit 510 in the first embodiment of the present disclosure and middle images 666, 671, and 676.

In the example of FIG. 38, the middle image is determined with the position of the butterfly included in the panoramic image being a center. Note that the butterfly may be detected as a moving body or may be detected as a specific object by object detection.

In this manner, in order to appropriately check the main subject, an image including a feature detected based on image analysis and surroundings thereof can be displayed as the middle image without fixing the middle image at a center portion of the panoramic image (center portion of angle of view).

[Example in which Coordinates of Feature are Recorded]

The main aims of the postview display are, as described above, for example, to check an image recorded by imaging and to determine whether or not it is necessary to re-capture an image. Note that to check an image recorded by imaging is, for example, to check whether or not the state in which the main subject is recorded is satisfactory (e.g., to check whether moment when butterfly sits on flower is captured when butterfly that is about to sit on flower is imaged). For example, whether or not an angle of view (i.e., area of image recorded by imaging) is satisfactory is checked.

For example, a case where an image in which the main subject is a person and the background is a distant landscape is captured is assumed. In this case, as described above, not capturing an image having a composition in which the main subject (person) is located at the center of the image but capturing an image having a composition in which the person is located at a position deviated to either one of the left and the right from the center of the image may be performed.

In such a case, if the area of the middle image displayed on the display unit 140 is fixed at the center of the angle of view, there is a fear that a check of the image cannot appropriately be performed, for example, during the postview display after imaging. For example, when checking whether or not the state in which the main subject is recorded is satisfactory and determining whether or not it is necessary to re-capture an image, it is assumed that an inconvenience that it is difficult to make a determination because the main subject is not included in the middle image occurs.

Therefore, in order to appropriately perform those checks, it is favorable that, as described above, an area including a feature detected based on image analysis and surroundings thereof are displayed without fixing the area displayed in the middle image at the center portion of the angle of view.

The detection of the position of the subject by image analysis is often performed on an image input into the imaging device during a live view display period before imaging and on an image input into the imaging device when imaging and recording are performed. Further, the detection result is often deleted after imaging. If the detection result of the position of the subject by image analysis is deleted in this manner, the detection result cannot be used during the postview display and during the reproduction display.

In the first embodiment of the present disclosure, a position of a feature detected by image analysis during imaging (coordinates of feature in panoramic image) is recorded in association with the panoramic image. For example, the position of the feature can be recorded in an area other than pixel data of a generated image (or area other than compressed data thereof). For example, the position of the feature can be recorded in a header of image data in an Exif format of a panoramic image to be recorded or a header of an image file in a jpeg form in the image data. For example, the position of the feature can be recorded in the maker note 185 shown in Part “c” of FIG. 27. Then, during the postview display or at an arbitrary point of time of the reproduction display, the middle image including the feature can be displayed using coordinates of a feature recorded in association with the panoramic image as the display target and an area of the surroundings thereof.

Alternatively, for example, in addition to the panoramic image, an image (e.g., middle image) of an area including a feature detected during imaging and surroundings thereof may be recorded at a resolution for a display image. For example, file identification information (e.g., file name) of the display image can be recorded in a header or the like of an image file in a jpeg format of the panoramic image. Then, during the postview display and at an arbitrary point of time of the reproduction display, the display image recorded in association with the panoramic image as the display target can be read out and displayed as the middle image.

Note that, although, in the first embodiment of the present disclosure, the face of the person or the butterfly is detected as the specific target, an object other than the face of the person or the butterfly may be detected and used as the specific target. For example, specific targets such as animals including mammals, reptiles, and fishes (e.g., dog, cat, cow, and horse), an automobile, and a plane may be detected and used.

[Example in which Areas of Images in Panoramic Image are Displayed]

In the above-mentioned example, the entire image of the panoramic image (or image similar to this image) is displayed together with the middle image, the left image, and the right image. For example, it is easy for the user to perform a check and the like if the user can know positions (positions in longitudinal direction) of the displayed images (middle image, left image, and right image) in the panoramic image. In view of this, an example in which areas of displayed images (middle image, left image, and right image) in a panoramic image are displayed is shown below.

FIG. 39 is a diagram of display examples of the panoramic image generated by the image generation unit 510 in the first embodiment of the present disclosure and the images (middle image, left image, and right image). Note that the images shown in FIG. 39 and arrangement thereof are the same as in the example shown in Part “b” of FIG. 35.

In the example shown in Part “a” of FIG. 39, an area of the middle image 634 in the panoramic image 638 is indicated by a frame 681 on the panoramic image 638. In the example shown in Part “b” of FIG. 39, an area of the left image 635 in the panoramic image 638 is indicated by a frame 682 on the panoramic image 638 and an area of the right image 636 in the panoramic image 638 is indicated by a frame 683 on the panoramic image 638. Note that those frames 681 to 693 are displayed by the display control unit 550 based on the positions of the images (middle image, left image, and right image) as the display target.

Note that, although the areas of the images in the panoramic image 638 are indicated by the frames on the panoramic image 638 in the example shown in FIG. 39, another display mode may be adopted. For example, the area of the images in the panoramic image 638 may be covered with semi-transparent hatched lines on the panoramic image 638. Alternatively, the areas of the images in the panoramic image 638 may covered with semi-transparent hatched lines on the panoramic image 638 and the hatched lines may blink. Alternatively, the areas of the images in the panoramic image 638 may be indicated by under lines or arrows on the panoramic image 638. Note that, as shown in Part “b” of FIG. 39, when areas of the left image 635 and the right image 636 in the panoramic image 638 are indicated on the panoramic image 638, the display for indicating the area of the right image and the display for indicating the area of the left image may be performed in different manners. Note that the display for indicating the areas of the left image and the right image may be performed by, for example, frames or semi-transparent hatched lines. For example, when the areas of the images are indicated by frames on the panoramic image (entire image), different display colors may be adopted for the left and right frames.

FIG. 40 is a diagram of a display example in which a panoramic image generated by the image generation unit 510 in the first embodiment of the present disclosure and images (middle image, left image, and right image). In the example of FIG. 40, areas of the images (middle image, left image, and right image) in the panoramic image are indicated by frames on the panoramic image (entire image). Note that FIG. 40 shows a display example obtained by adding and arranging a panoramic image 685 to the display example shown in Part “b” of FIG. 30.

Specifically, an area of a middle image 604 in the panoramic image 685 is indicated by a frame 686 on the panoramic image 685. Further, an area of a left image 605 in the panoramic image 685 is indicated by a frame 687 on the panoramic image 685 and an area of a right image 606 in the panoramic image 685 is indicated by a frame 688 on the panoramic image 685.

Note that, although the areas of the images in the panoramic image 685 are indicated by the frames on the panoramic image 685 in the example shown in FIG. 40, another display mode may be adopted as in FIG. 39. For example, the areas of the images in the panoramic image 685 may be covered with semi-transparent hatched lines on the panoramic image 685. Alternatively, the areas of the images in the panoramic image 685 may be covered with semi-transparent hatched lines on the panoramic image 685 and the hatched lines may flicker. Further, the areas of the images in the panoramic image 685 may be indicated by under lines or arrows on the panoramic image 685.

Note that it is favorable that the display indicating the area of the middle image and the display indicating the areas of the left image and the right image may be in different display modes. For example, the area of the middle image may be covered with semi-transparent hatched lines and the areas of the left image and the right image may be surrounded by frames. In this case, it is favorable that the display indicating the areas of the left image and the right image is in different display modes. For example, different display colors may be adopted in the frames indicating the left image and the right image.

[Example in which Area Display is Changed Depending on Mode]

As mentioned above, it is favorable that the display indicating the areas of the images is performed in order for the user to easily understand the composition and the like of the images during imaging. It should be noted that, during reproduction, it is assumed that it is important to view the panoramic image rather than to check the composition and the like of the images. In this manner, the content that the user desires to check on the display image differs depending on the mode. For example, during the live view display, during the postview display, and during the reproduction display, the content that the user desires to check on the display image differs. In view of this, an example in which the panoramic image is displayed depending on the desire of the user on each mode when the panoramic image is displayed is shown. That is, the example in which the area display is changed depending on the display mode is shown.

For example, in the live view display and the postview display that are mainly aimed to check an image, the display information indicating the areas of the images (e.g., frames 681 to 683 and 686 to 688 shown in FIGS. 39 and 40) is displayed on the panoramic image.

On the other hand, in the reproduction display mainly aimed to view an image, the display information indicating the areas of the images is not displayed in the panoramic image.

Alternatively, when those display methods may be set when the information processing apparatus 100 is shipped from a factory. Alternatively, in each of the live view display, the postview display, and the reproduction display, the user may be capable of individually setting whether or not to display the display information indicating the areas of the images in the panoramic image.

For example, an item-setting screen may be displayed on the display unit 140 of the information processing apparatus 100 and the user may make settings in the item-setting screen.

[Example in which Middle Image is Scroll-Displayed]

In the above-mentioned example, with the positions (positions in longitudinal direction) of the images (middle image, left image, and right image) in the panoramic image, which are displayed on the display unit 140, being fixed, the images are displayed. It is also assumed that the middle image is displayed while moving the position (position in longitudinal direction) of the middle image in the panoramic image. In view of this, an example in which the middle image is displayed while moving the position (position in longitudinal direction) of the middle image in the panoramic image (so-called automatic scroll display) is shown below.

FIG. 41 is a diagram of a transition example of an area of the middle image in the panoramic image generated by the image generation unit 510 in the first embodiment of the present disclosure. Note that the panoramic image shown in FIG. 41 is the same as the panoramic image 600 shown in Part “b” of FIG. 29. Further, in FIG. 41, the area of the middle image in the panoramic image is surrounded and indicated by a frame 690.

Note that, although FIG. 41 shows, for the sake of description, only the four areas as transitions of the area of the middle image in the panoramic image, the area of the middle image can shift by one pixel or several pixels at a time as a moving interval. The moving speed can be set such that the user can easily view the area of the middle image.

FIGS. 42 and 43 show display examples of the panoramic image generated by the image generation unit 510 in the first embodiment of the present disclosure and the images (middle image, left image, and right image). Note that the panoramic image 685, the left image 605, and the right image 606 shown in FIGS. 42 and 43 are the same as those in FIG. 40. It should be noted that, in the example shown in each of FIGS. 42 and 43, only display information (frames 691, 693, 695, and 697) relating to the middle image is displayed concerning the display information indicating the areas of the images.

Further, the transition of the area of the middle image in the panoramic image 685 corresponds to the transition shown in FIG. 41.

In this manner, the middle image is displayed while automatically moving the area of the middle image in the panoramic image. A so-called automatic scroll display of the middle image is performed.

Whether or not to perform the automatic scroll display of the middle image may be set depending on the mode. For example, the automatic scroll display of the middle image is not performed when the live view display for checking a subject before imaging is performed and when the postview display for checking a recorded image before imaging. That is, the middle image is displayed with the position (position in longitudinal direction) of the middle image in the panoramic image being fixed. On the other hand, the automatic scroll display of the middle image is performed when the reproduction display of an image at an arbitrary point of time is performed.

Alternatively, for example, the display control unit 550 may switch the first display method and the second display method based on the user operation during live view or during postview. The first display method is a display method of, for example, displaying the middle image with the position of the middle image in the panoramic image being fixed. Further, the second display method is a display method of displaying an image including an area in which a specific target included in the panoramic image is present, as the middle image. On the other hand, the display control unit 550 may switch the third display method (automatic scroll display) and the second display method based on the user operation during reproduction.

Alternatively, only when the live view display for checking the subject before imaging is performed, a specific area (e.g., area of middle image) may be displayed without performing the automatic scroll display of the middle image. In this case, the automatic scroll display of the middle image may be performed when the postview display for checking a recorded image after imaging is performed and when the reproduction display of an image at an arbitrary point of time is performed. Alternatively, a specific area may be displayed without performing the automatic scroll display of the middle image when the live view display is performed and when the postview display is performed, and the automatic scroll display of the middle image may be performed when the reproduction display of an image at an arbitrary point of time is performed.

Alternatively, for example, the display control unit 550 may switch between the first display method and the second display method based on the user operation during the live view. On the other hand, the display control unit 550 may switch between the third display method and the second display method based on the user operation during postview or during reproduction.

Alternatively, setting of those display methods may be performed when the information processing apparatus 100 is shipped from a factory or when the user uses the information processing apparatus 100. Alternatively, in each of the live view display, the postview display, and the reproduction display, the user may be capable of individually setting whether or not to perform the automatic scroll display of the middle image. Further, for example, it is possible to individually set an image display method by a live view operation, an image display method by a postview operation, and an image display method by a reproduction operation. If such setting is made, the display control unit 550 is capable of displaying images based on the setting. Alternatively, concerning those various settings, an item-setting screen may be displayed on the display unit 140 of the information processing apparatus 100 and the user may manually make those various settings in the item-setting screen. Alternatively, when the function of each of the live view display, the postview display, and the reproduction display is activated, the middle image can be displayed according to the content set in the item-setting screen.

Further, the input unit (e.g., touch panel) that inputs an instruction from the user may be provided to a surface of the casing of the information processing apparatus 100. Then, when the user inputs an instruction through the input unit in a period of each of the live view display, the postview display, and the reproduction display, the display of the middle image may be switched between a still image display and an automatic scroll display for each display period. The automatic scroll display is an example of the display method of displaying the middle image while moving the area displayed as the middle image from one end to other end of the both end portions in the panoramic image. Further, the still image display is an example of the display method of displaying a certain area as the middle image without moving the area displayed as the middle image.

For example, a case where a switching instruction operation relating to the display method for a middle image (still image display and automatic scroll display) is received from the user is assumed. In this case, the display control unit 550 is capable of selecting, based on the switching instruction operation, either one of the automatic scroll display and the still image display and displaying the middle image.

Alternatively, which of the display methods is used as the display method for a middle image at a point of time when the still image display or the automatic scroll display of the middle image is completed may be stored inside the information processing apparatus 100. Then, when the function of each of the live view display, the postview display, and the reproduction display is activated after the storing, the middle image may be displayed according to the stored content.

For example, if the display method for a middle image is switched, a display method according to the switching is stored by the time the display of the middle image based on the switching is completed. Then, when a new panoramic image is displayed after the display of the middle image based on the switching is completed, the middle image in the panoramic image can be displayed using the stored display method.

[Example in which Middle Image is Displayed Based on User Operation]

In the above-mentioned example, the images (middle image, left image, and right image) are automatically displayed on the display unit 140. It is also important to rapidly display a middle image at a position (position in longitudinal direction) that the user desires to view. In view of this, an example in which the middle image is displayed based on the user operation is shown below. That is, the example in which the display area of the middle image is changed based on the user operation is shown.

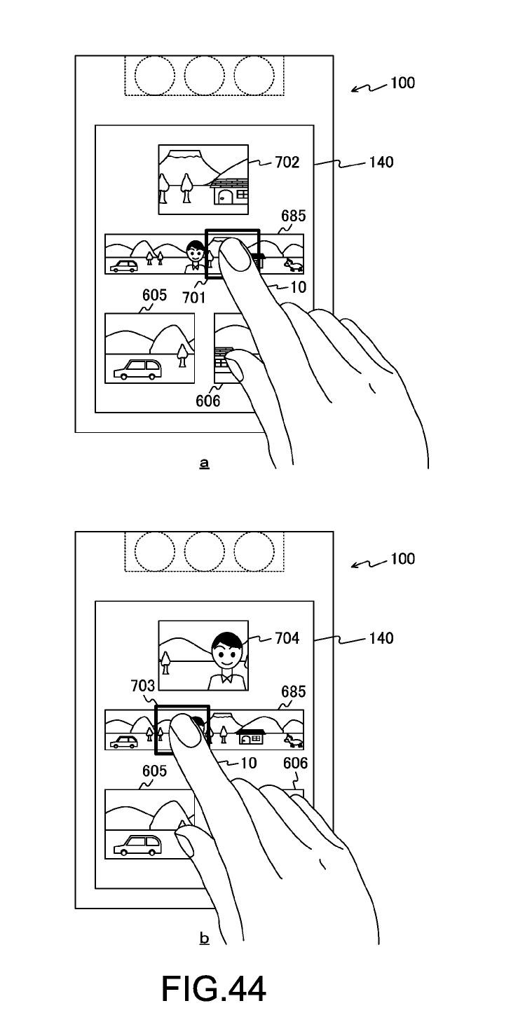

FIG. 44 is a diagram of display examples of the panoramic image generated by the image generation unit 510 in the first embodiment of the present disclosure and the images (middle image, left image, and right image). Note that the panoramic image 685, the left image 605, and the right image 606 shown in FIG. 44 are the same as those in FIG. 40. It should be noted that, in the example shown in FIG. 44, regarding the display information indicating the areas of the images, only display information (frames 701 and 703) relating to the middle image is displayed.

A case where the display unit 140 of the information processing apparatus 100 is constituted of a touch panel is assumed. In this case, for example, when the user depresses the display surface of the display unit 140 with a finger 10, the depression operation is detected as a change in electrical properties such as a resistance change and a capacitance change. Then, when the depression operation is detected during displaying a specific area in the middle image, the middle image with the detected position being a center is generated and displayed. Further, in the case where a touch panel capable of detecting a proximity (e.g., proximity of part of body such as hand and finger) with respect to the display surface of the display unit 140 by the user is used, also when the proximity is detected, the middle image can be displayed as when the depression operation is detected.

A case where the depression operation is detected during the above-mentioned automatic scroll display as another display mode of the middle image is assumed. In this case, the middle image with the detected position being a center is displayed. After the display, the middle image may be continuously displayed as a still image or the automatic scroll display may be re-started with that position being a start point.

For example, a case where the designation operation for specifying a position in the panoramic image is performed is assumed. In this case, when the middle image is displayed by the automatic scroll display, the display control unit 550 displays an image including a position in the panoramic image that is designated by the designation operation and a surrounding area thereof, as a new middle image. Then, the display control unit 550 performs a display of the middle image while performing a movement with that position being a start point. On the other hand, if the middle image is displayed by the still image display when the designation operation is performed, the display control unit 550 displays an image including that position and a surrounding area thereof, as a new middle image.

Note that, for example, a touch panel of an electrostatic type (electrostatic capacitance type), a touch panel of a pressure-sensitive type (resistance film type), or an optical touch panel can be used as the touch panel.

Alternatively, an operation member (e.g., arrow key) other than the touch panel may be used to specify a position at which the middle image should be displayed.

[Modified Example of Two-Row Display]

In the above-mentioned example, the middle image, the left image, and the right image are displayed in two rows in the longitudinal direction of the display unit 140. It should be noted that, depending on the size of each image, the middle image, the left image, and the right image may be displayed in one row in the longitudinal direction of the display unit 140. In view of this, a case where the middle image, the left image, and the right image are displayed in one row in the longitudinal direction of the display unit 140 is shown below.

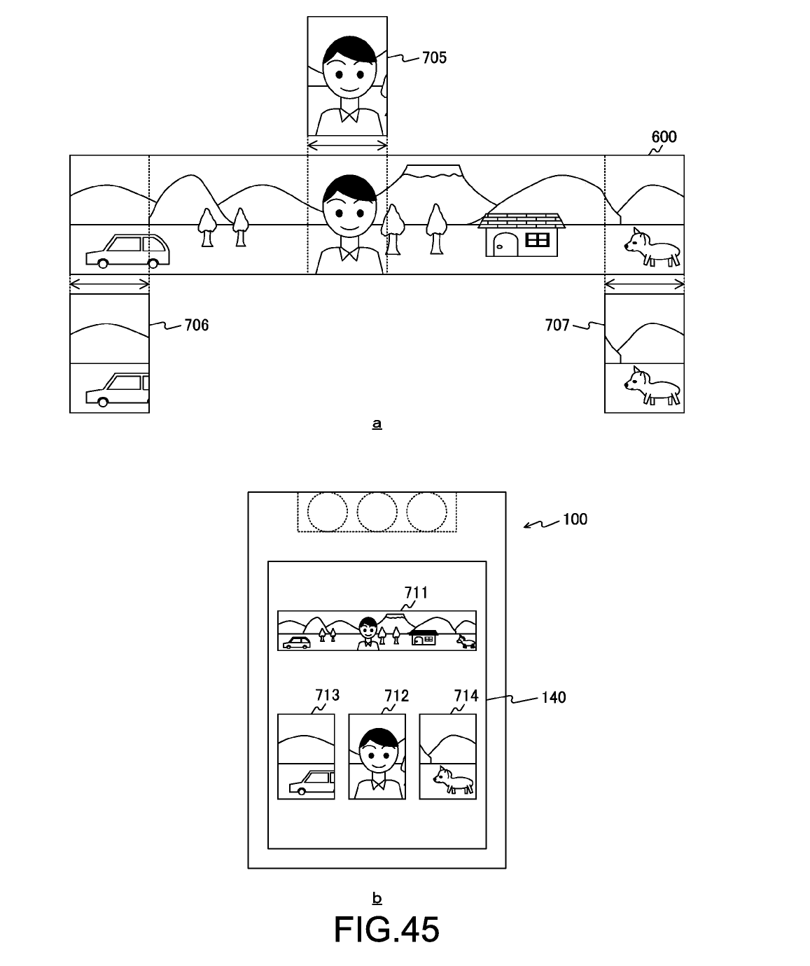

FIG. 45 is a diagram showing a relation between the panoramic image 600 generated by the image generation unit 510 in the first embodiment of the present disclosure and images as the display target and a display example of the display unit 140.

In Part “a” of FIG. 45, the panoramic image 600 generated by the image generation unit 510 is shown. The relation shown in Part “a” of FIG. 45 is the same as the relation shown in Part “a” of FIG. 30 and the like. In Part “b” of FIG. 45, a display example of a panoramic image 711 displayed on the display unit 140 and images (middle image 712, left image 713, and right image 714) is shown.

As shown in Parts “a” and “b” of FIG. 45, by relatively decreasing the horizontal width of the images (middle image 712, left image 713, and right image 714), those images can be displayed in one row in the longitudinal direction of the display unit 140. With this, the images can be displayed to coincide with the horizontal direction of the panoramic image 711.

When a phone call operation of the information processing apparatus such as the smart phone and the cell phone or an operation of creating or reading a document of an e-mail, a casing is often used in a vertical state. Therefore, for example, also when imaging is performed using an information processing apparatus with a camera, the casing and the display unit are often held in the vertical state for imaging, such that a vertically long image is recorded.

In view of this, in the first embodiment of the present disclosure, in the information processing apparatus 100 such as the smart phone and the cell phone, a plurality of imaging systems are arranged in an orthogonal direction orthogonal to the longitudinal direction of the information processing apparatus 100. With this, the panoramic image can be recorded even if the information processing apparatus 100 is in the vertical state for imaging.

Further, during the live view display, during the postview display, or during the reproduction display, when the panoramic image is displayed while the information processing apparatus 100 is in the vertical state, the plurality of images obtained by dividing the panoramic image are displayed in a plurality of rows in the longitudinal direction of the display unit 140. With this, in a portable information processing apparatus 100 with a multi-eye camera, capturing of a multi-eye panoramic image can be easily performed in a state in which the user holds the information processing apparatus 100 in a vertical state. Further, even if the panoramic image is displayed while the information processing apparatus 100 is in the vertical state, the panoramic image can be appropriately displayed.

[Display Example when State (Vertical State and Horizontal State) of Information Processing Apparatus is Changed]

In the above, the display example of the panoramic image when the information processing apparatus 100 is in the vertical state is shown. It should be noted that it is also assumed that some users view the panoramic image while the information processing apparatus 100 is in the horizontal state.

For example, it is also assumed that the same number of display rows is set in the horizontal state and the vertical state. For example, when the panoramic image is displayed in the horizontal state, the panoramic image can be displayed in a large size by displaying the panoramic image with full horizontal width of the display unit 140. However, the height of each of margin areas above and below the panoramic image in the up to down direction is smaller when the panoramic image is displayed with full horizontal width of the display unit 140 in the horizontal state than when the panoramic image is displayed with full horizontal width of the display unit 140 in the vertical state. In this manner, each of the margin areas above and below of the panoramic image is narrower in the case of the horizontal state than the vertical state. Therefore, it is favorable that the number of display rows is made smaller in the case of the horizontal state than the vertical state. In view of this, a display example when the state (vertical state and horizontal state) of the information processing apparatus 100 is changed is shown below.

FIG. 46 is a diagram of a display example when the panoramic image generated by the image generation unit 510 in the first embodiment of the present disclosure is displayed on the display unit 140.

On the left-hand side of each of Parts “a” to “c” of FIG. 46, a display example of the panoramic image when the information processing apparatus 100 is in the horizontal state is shown. On the right-hand side of each of Parts “a” to “c” of FIG. 46, a display example of the panoramic image when the information processing apparatus 100 is in the vertical state is shown.

For example, when the information processing apparatus 100 is in the horizontal state, only a panoramic image 720 or the panoramic image 720 and a middle image 721 is/are displayed on the display unit 140. For example, when the information processing apparatus 100 is in the vertical state, images of a middle image 722, a left image 723, and a right image 724 are displayed on the display unit 140 or a reduced image 725 of the panoramic image is displayed together with those images on the display unit 140.

In this manner, the number of rows of the images when the user holds the information processing apparatus 100 such that the display unit 140 is in the vertical state is made larger than the number of rows of the images when the user holds the information processing apparatus 100 such that the display unit 140 is in the horizontal state. With this, even if the state of the information processing apparatus (vertical state and horizontal state) is changed, the panoramic image can be displayed in such a manner that the user can easily view the panoramic image.

[Modified Examples of Information Processing Apparatus]

Next, modified examples of the information processing apparatus including the plurality of imaging systems will be described.

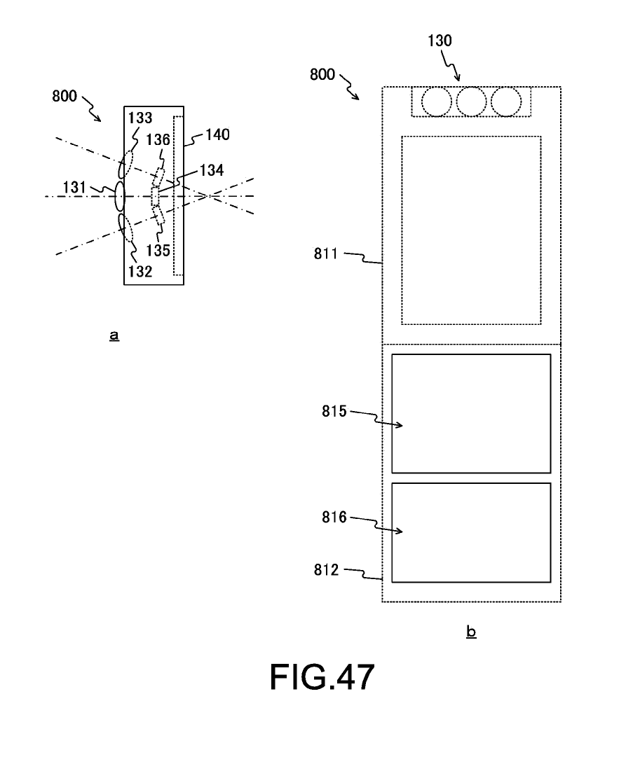

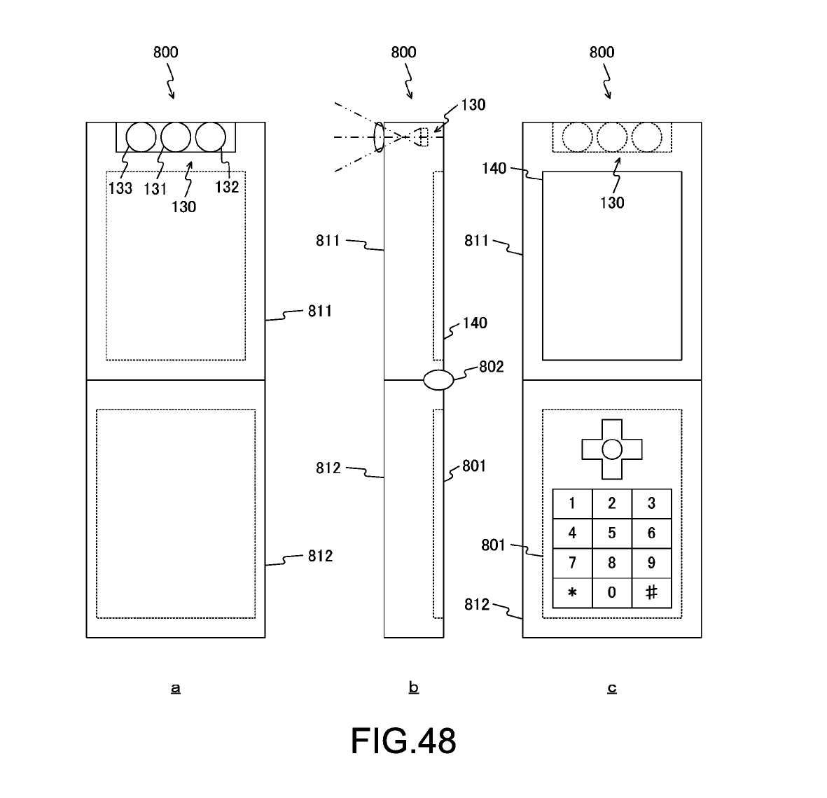

FIGS. 47 and 48 are diagrams showing a modified example of the information processing apparatus 100 in the first embodiment of the present disclosure.

FIGS. 47 and 48 show an information processing apparatus 800 with the display unit 140 and the imaging unit 130 included in different casings (first casing 811 and second casing 812). In Part “a” of FIG. 47, a top view of the information processing apparatus 800 is shown. In Part “b” of FIG. 47, an arrangement example of an electronic substrate of the information processing apparatus 800 is shown. Note that Part “a” of FIG. 47 corresponds to Part “a” of FIG. 1 and Part “b” of FIG. 47 corresponds to Part “e” of FIG. 1. In Part “a” of FIG. 48, a front view of the information processing apparatus 800 is shown. Part “b” of FIG. 48, a side view of the information processing apparatus 800 is shown. In Part “c” of FIG. 48, a rear view of the information processing apparatus 800 is shown. Note that Part “a” of FIG. 48 corresponds to Part “b” of FIG. 1, Part “b” of FIG. 48 corresponds to Part “c” of FIG. 1, and Part “c” of FIG. 48 corresponds to Part “d” of FIG. 1. Portions common to those of the information processing apparatus 100 shown in FIG. 1 are denoted by the same reference symbols.

The information processing apparatus 800 is realized by, for example, an information processing apparatus (e.g., flip phone with multi-eye camera) including a plurality of imaging systems.

The information processing apparatus 800 includes a rotation member 802, the first casing 811, and the second casing 812. The first casing 811 and the second casing 812 are coupled to each other such that the first casing 811 and the second casing 812 can be folded with the rotation member 802 being an axis of rotation. That is, the folding can be performed such that an operation unit 801 and the display unit 140 are opposed to each other with the rotation member 802 being the axis of rotation.

The first casing 811 includes an imaging unit 130 and a display unit 140. The second casing 812 further includes the operation unit 801, an electronic substrate 815, and a battery storage unit 816.

The operation unit 801 is an operation including a numeric keypad, an arrow key, a determination key, and the like.

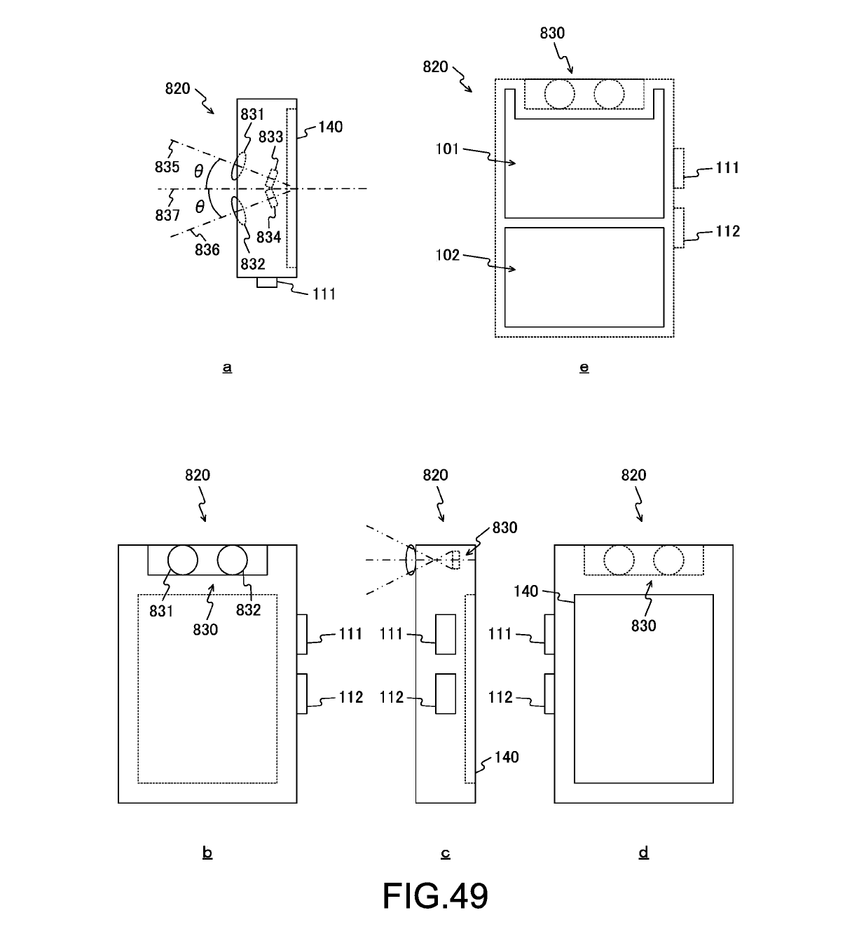

In this manner, the first embodiment of the present disclosure may be applied to the foldable information processing apparatus 800 including the plurality of imaging systems. Note that, in this modified example, the three imaging systems are arranged according to a predetermined rule. It should be noted that the first embodiment of the present disclosure may be applied to an information processing apparatus (e.g., imaging apparatus such as digital still camera and digital video camera (e.g., camera-integrated recorder)) including two or four or more imaging systems. That is, the first embodiment of the present disclosure can be applied by arranging the two or four or more imaging systems according to a predetermined rule. Examples in which two imaging systems are arranged according to a predetermined rule are shown in FIGS. 49 to 51.

FIGS. 49 to 51 are diagrams showing modified examples of the information processing apparatus 100 in the first embodiment of the present disclosure.

FIG. 49 shows an information processing apparatus 820 with a display unit 140 and an imaging unit 830 included in a single casing. In Part “a” of FIG. 49, a top view of the information processing apparatus 820 is shown. In Part “b” of FIG. 49, a front view of the information processing apparatus 820 is shown. In Part “c” of FIG. 49, a side view of the information processing apparatus 820 is shown. In Part “d” of FIG. 49, a rear view of the information processing apparatus 820 is shown. In Part “e” of FIG. 49, an arrangement example of an electronic substrate of the information processing apparatus 820 is shown. Note that Parts “a” to “e” of FIG. 49 correspond to Parts “a” to “e” of FIG. 1, respectively. Portions common to those of the information processing apparatus 100 shown in FIG. 1 are denoted by the same reference symbols.

As shown in Part “a” of FIG. 49, optical axes of two imaging systems (optical systems 831 and 832 and imaging devices 833 and 834) constituting the imaging unit 830 will be referred to as optical axes 835 and 836. In this case, an angle formed by the optical axis 835 and a perpendicular line 837 orthogonal (or almost orthogonal) to a display surface of the display unit 140 is indicated by θ, and an angle formed by the optical axis 836 and the perpendicular line 837 is indicated by θ. That is, the two imaging systems (optical systems 831 and 832 and imaging devices 833 and 834) are arranged such that the optical axes 835 and 836 of the two imaging systems (optical systems 831 and 832 and imaging devices 833 and 834) are located at line-symmetric positions with respect to the perpendicular line 837.

The information processing apparatus 820 is realized by an information processing apparatus (e.g., smart phone with multi-eye camera and cell phone with multi-eye camera) including, for example, a plurality of imaging systems.

The information processing apparatus 820 includes an electronic substrate 101, a battery storage unit 102, a changeover switch 111, a determination key 112, a display unit 140, and an imaging unit 830. Note that the information processing apparatus 820 is the same as the information processing apparatus 100 shown in FIG. 1 except for a point that two imaging systems (optical systems 831 and 832 and imaging devices 833 and 834) constituting the imaging unit 830 are provided. Therefore, a detailed description is omitted here.

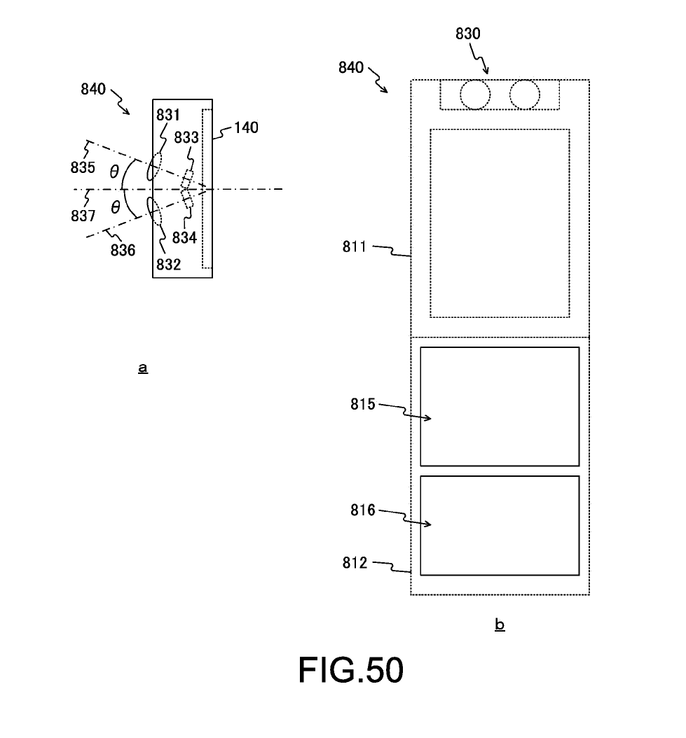

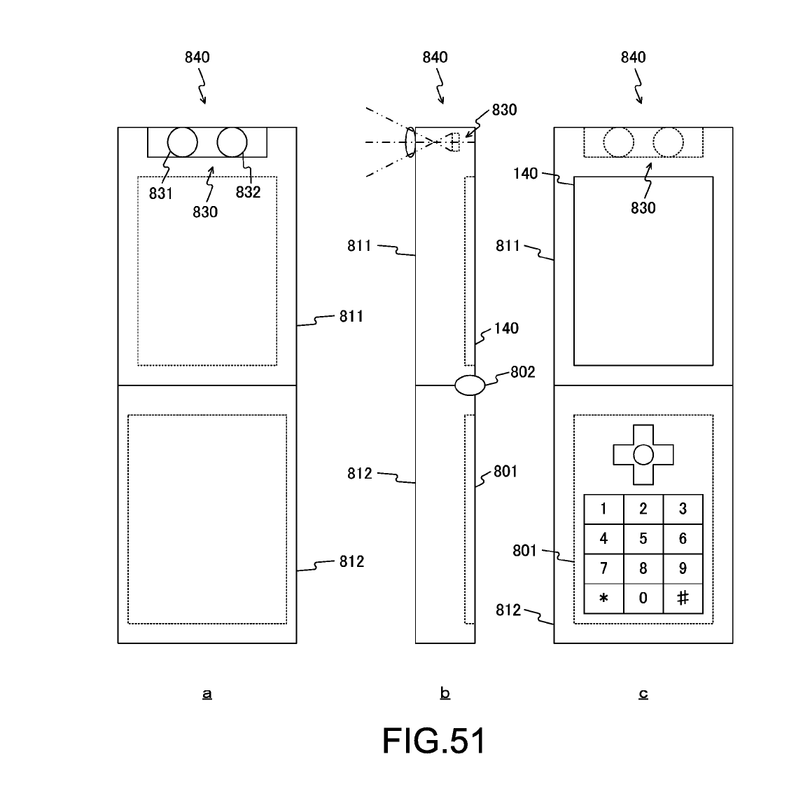

FIGS. 50 and 51 show an information processing apparatus 840 with a display unit 140 and an imaging unit 830 included in different casings (first casing 811 and second casing 812). In Part “a” of FIG. 50, a top view of the information processing apparatus 840 is shown. In Part “b” of FIG. 50, an arrangement example of an electronic substrate of the information processing apparatus 840 is shown. In Part “a” of FIG. 51, a front view of the information processing apparatus 840 is shown. In Part “b” of FIG. 51, a side view of the information processing apparatus 840 is shown. In Part “c” of FIG. 51, a rear view of the information processing apparatus 840 is shown. Note that Parts “a” and “b” of FIG. 50 and Parts “a” to “c” of FIG. 51 correspond to Parts “a” and “b” of FIG. 47 and Parts “a” to “c” of FIG. 48, respectively. Portions common to those of the information processing apparatus 800 shown in FIGS. 47 and 48 and those of the information processing apparatus 820 shown in FIG. 49 are denoted by the same reference symbols.

The information processing apparatus 840 is realized by an information processing apparatus (e.g., flip phone with multi-eye camera) including, for example, a plurality of imaging systems.

The information processing apparatus 840 includes a rotation member 802, the first casing 811, and the second casing 812. Note that the information processing apparatus 840 is the same as the information processing apparatus 800 shown in FIGS. 47 and 48 except for a point that two imaging systems (optical systems 831 and 832 and imaging devices 833 and 834) constituting the imaging unit 830. Therefore, a detailed description is omitted here.

[Display Example of Panoramic Image and Other Images]

As mentioned above, the panoramic image generated by the information processing apparatus including the plurality of imaging systems can be displayed. The information processing apparatus including the plurality of imaging systems is also capable of generating normal images (e.g., images having aspect ratio of 3:4), and hence it is also important to appropriately display those images.

In view of this, an example in which images generated by an information processing apparatus including a plurality of imaging systems are appropriately displayed is shown below.

[Display Example of Information Processing Apparatus Including Three Imaging Units]

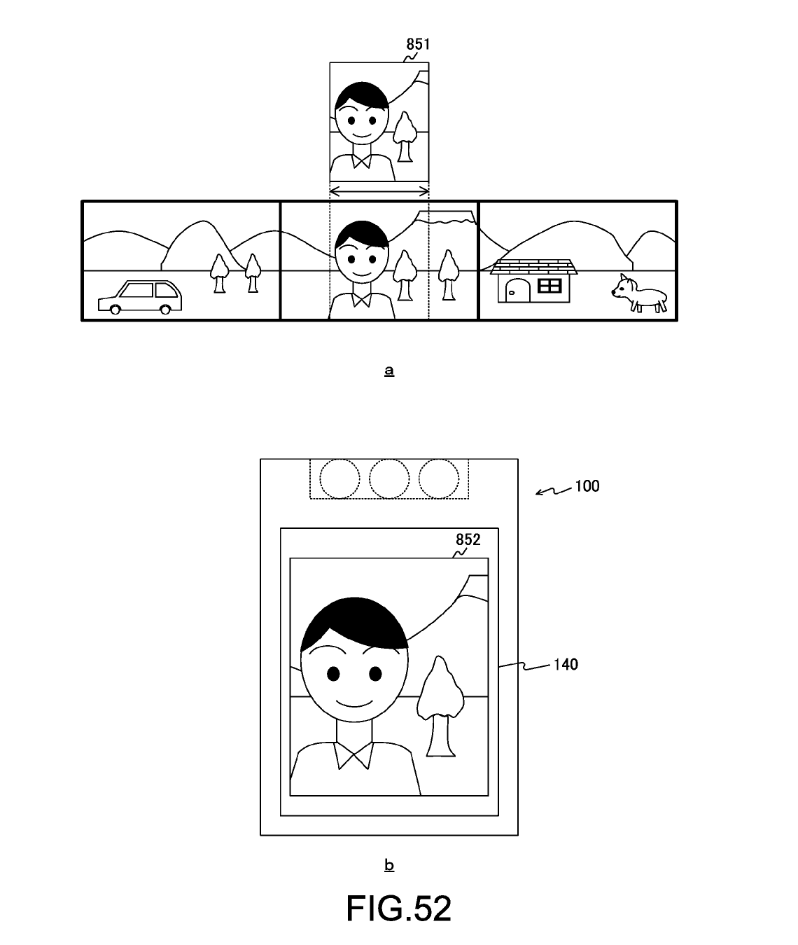

FIGS. 52 to 54 are diagrams each showing a display example of an image(s) generated by the information processing apparatus in the first embodiment of the present disclosure. FIGS. 52 to 54 show a relation between each of image read-out areas (indicated by thick rectangles) in three imaging devices and the image(s) displayed on the display unit 140 by the display control unit 550. Note that those images are generated by the information processing apparatus 100 shown in FIG. 1 or the information processing apparatus 800 shown in FIGS. 47 and 48, for example.

In Part “a” of FIG. 52, a display example when an image (e.g., vertically long 3:4 image) 851 is generated using part of one imaging device (middle imaging device) of the three imaging devices is shown. In this case, as shown in Part “b” of FIG. 52, a whole of an image 852 generated by the one imaging device is displayed. That is, when the image (e.g., vertically long 3:4 images) is displayed on a display screen of the display unit 140, the image can be displayed in a smaller number of rows (e.g., one row) than the number of rows when the panoramic image is displayed.

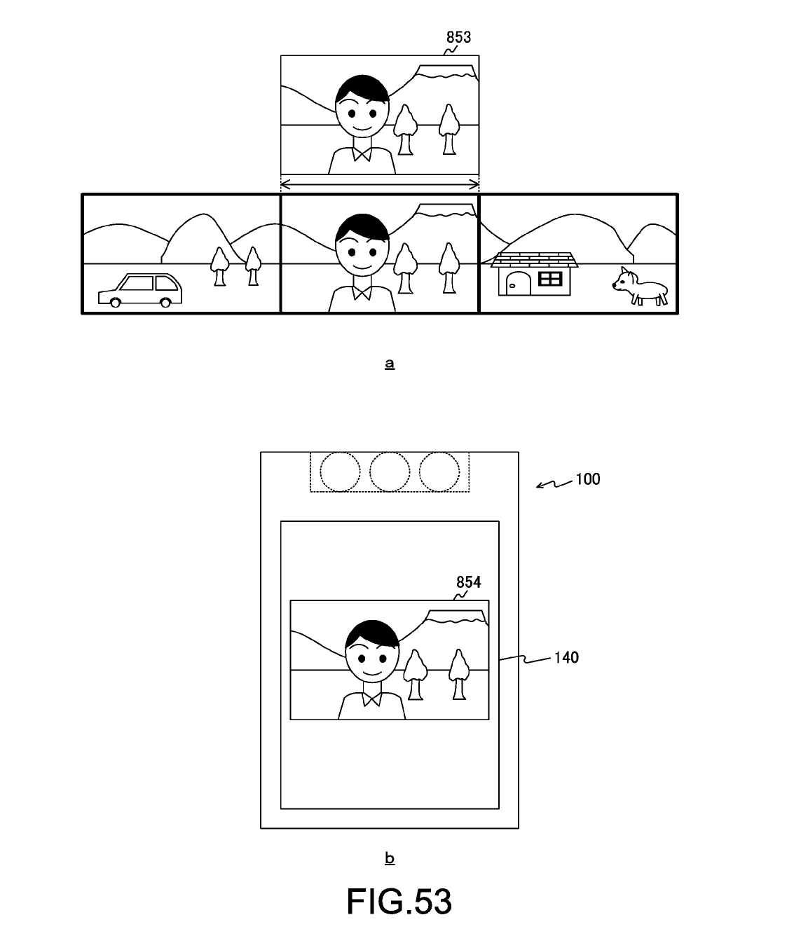

In Part “a” of FIG. 53, a display example when an image (e.g., horizontally long 4:3 image) 853 is generated using a whole of the one imaging device (middle imaging device) of the three imaging devices is shown. In this case, as shown in Part “b” of FIG. 53, a whole of an image 854 generated by the one imaging device is displayed. That is, when the image (e.g., horizontally long 4:3 image) is displayed on the display screen of the display unit 140, the image can be displayed in a smaller number of rows (e.g., one row) than the number of rows when the panoramic image is displayed.

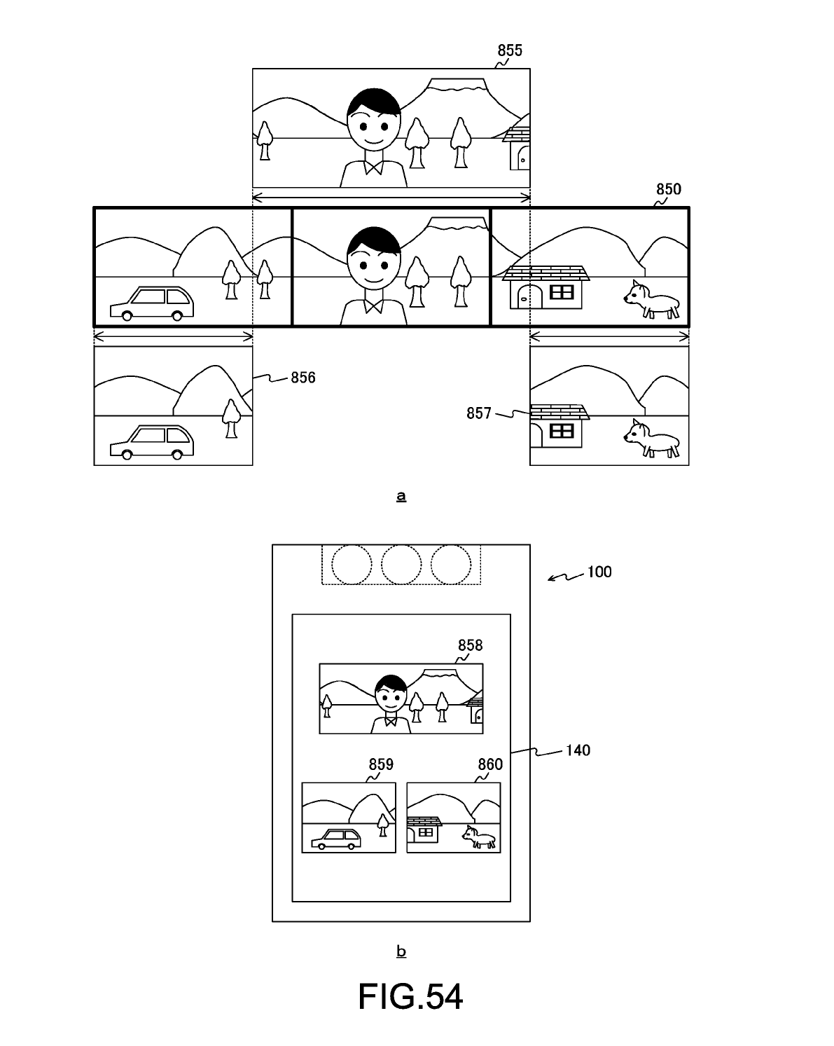

In Part “a” of FIG. 54, a display example when a panoramic image 850 is generated using three imaging devices is shown. In this case, as shown in Part “b” of FIG. 54, the panoramic image 850 is divided and displayed. For example, a plurality of images 855 to 857 obtained by dividing the panoramic image 850 are displayed as a middle image 858, a left image 859, and a right image 860.

[Display Example of Information Processing Apparatus Including Two Imaging Units]

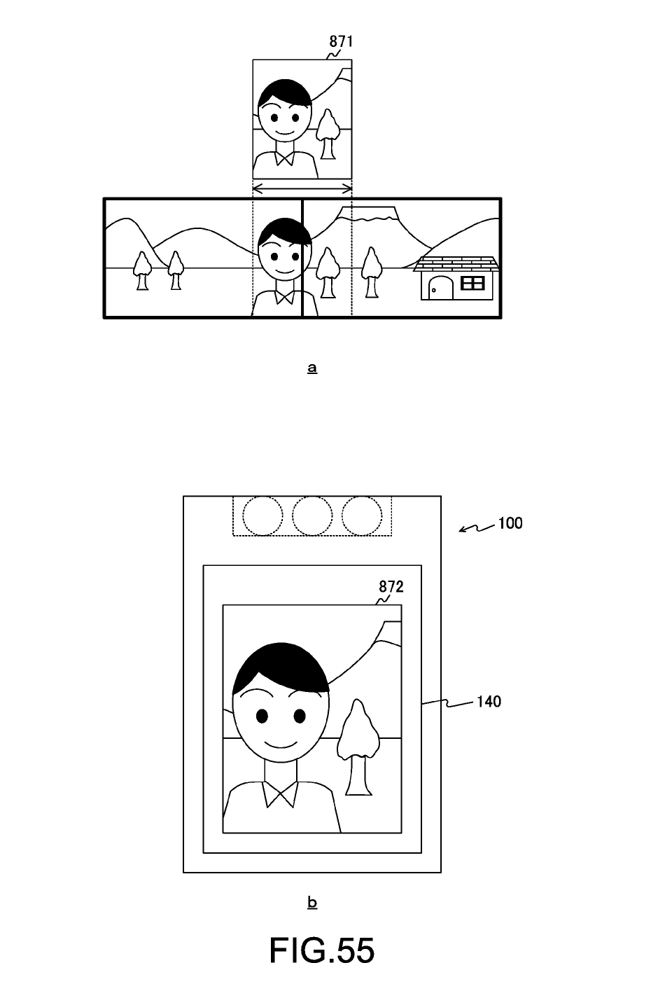

FIGS. 55 to 57 are diagrams each showing a display example of an image(s) generated by the information processing apparatus in the first embodiment of the present disclosure. FIGS. 55 to 57 show a relation between each of image read-out areas (indicated by thick rectangles) in two imaging units and the image(s) displayed on the display unit 140 by the display control unit 550. Note that those images are generated by the information processing apparatus 820 shown in FIG. 49 or the information processing apparatus 840 shown in FIGS. 50 and 51, for example.

In Part “a” of FIG. 55, a display example when an image (e.g., vertically long 3:4 image) 871 is generated using part of the two imaging devices is shown. In this case, as shown in Part “b” of FIG. 55, a whole of an image 872 generated by the part of the two imaging devices is displayed. That is, when the image (e.g., vertically long 3:4 image) is displayed on the display screen of the display unit 140, the image can be displayed in a smaller number of rows (e.g., one row) than the number of rows when the panoramic image is displayed.

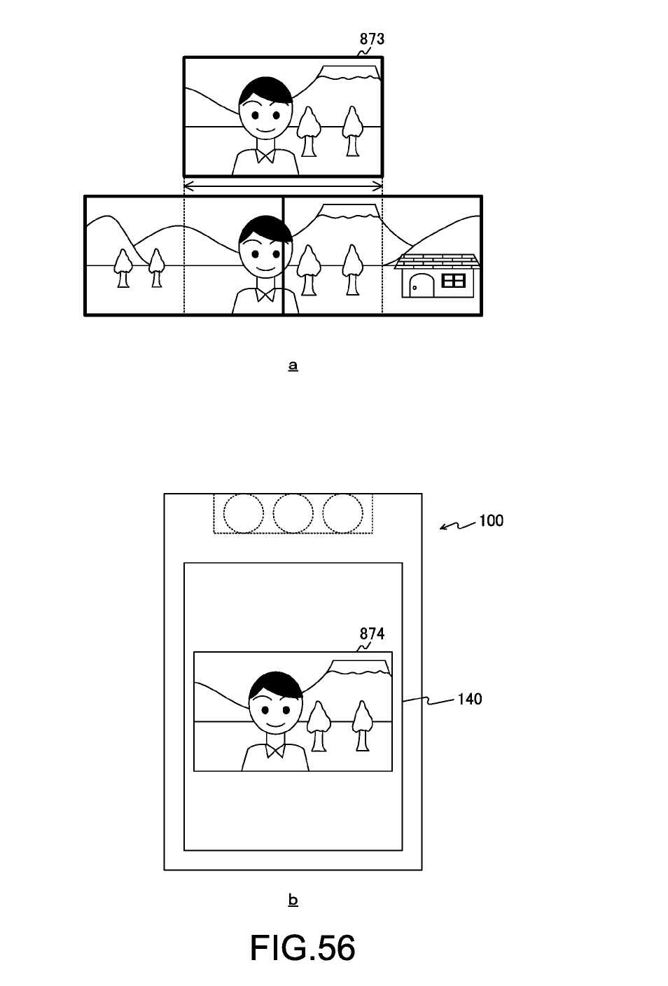

In Part “a” of FIG. 56, a display example when an image (e.g., horizontally long 4:3 image) 873 is generated using the part of the two imaging devices is shown. In this case, as shown in Part “b” of FIG. 56, a whole of an image 874 generated by the part of the two imaging devices is displayed. That is, when an image (e.g., horizontally long 4:3 image) is displayed on the display screen of the display unit 140, the image can be displayed in a smaller number of rows (e.g., one row) than the number of rows when the panoramic image is displayed.

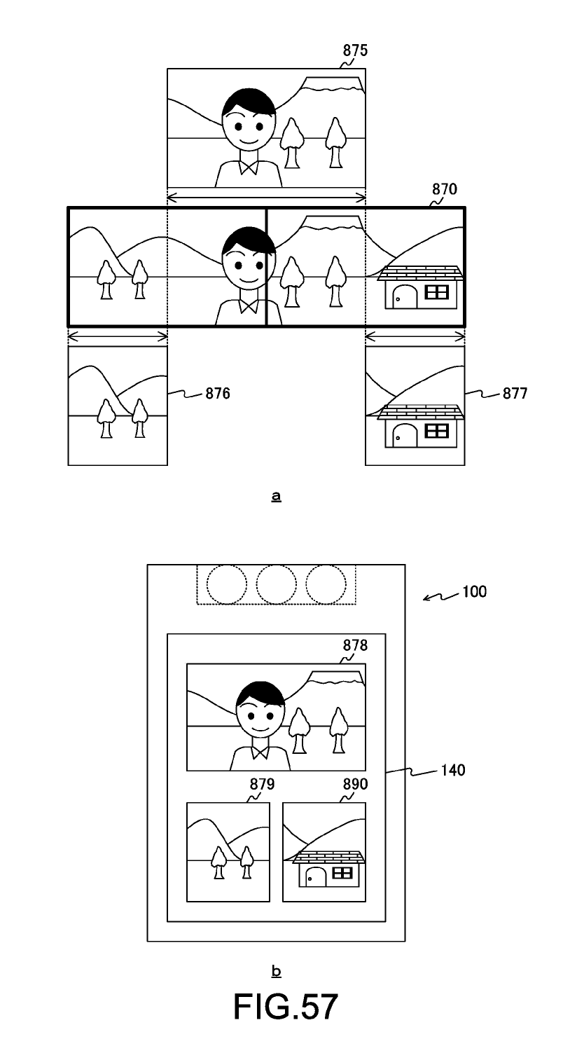

In Part “a” of FIG. 57, a display example when a panoramic image 870 is generated using the two imaging devices is shown. In this case, as shown in Part “b” of FIG. 57, the panoramic image 870 is divided and displayed. For example, a plurality of images 875 to 877 obtained by dividing the panoramic image 870 are displayed as a middle image 878, a left image 879, and a right image 880.

[Operation Example of Information Processing Apparatus]

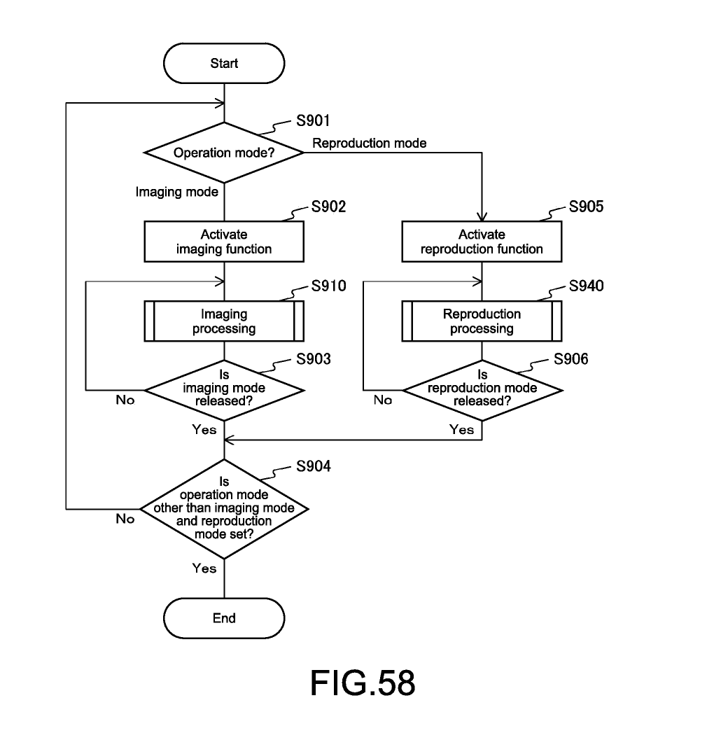

FIG. 58 is a flow chart showing an example of a processing procedure of display control processing by the information processing apparatus 100 in the first embodiment of the present disclosure.

First, a determination is made as to whether or not an imaging mode or a reproduction mode is set as an operation mode (Step S901). Note that, if an operation mode other than the imaging mode and the reproduction mode is set, processing depending on the set operation mode is performed.

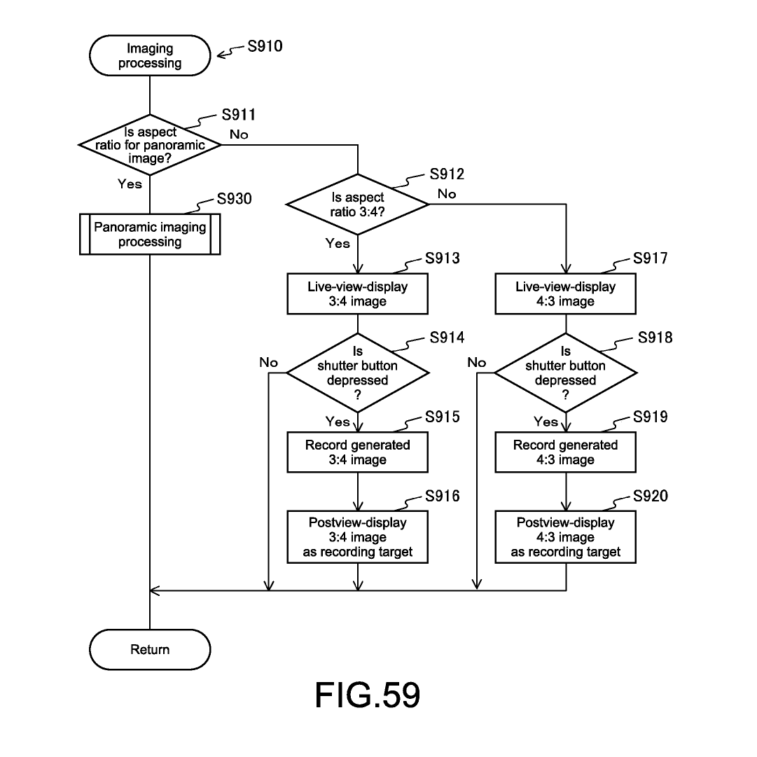

If the imaging mode is set (Step S901), an imaging function is activated (Step S902) and imaging processing is performed (Step S910). This imaging processing will be described in detail with reference to FIG. 59.

Subsequently, a determination is made as to whether or not the imaging mode is released (Step S903), and, if the imaging mode is not released, the processing returns to Step S910. On the other hand, if the imaging mode is released (Step S903), a determination is made as to whether or not the operation mode other than the imaging mode and the reproduction mode is set (Step S904). Then, if the operation mode other than the imaging mode and the reproduction mode is not set (Step S904), the processing returns to Step S901. On the other hand, if the operation mode other than the imaging mode and the reproduction mode is set (Step S904), the operation of the display control processing is terminated.

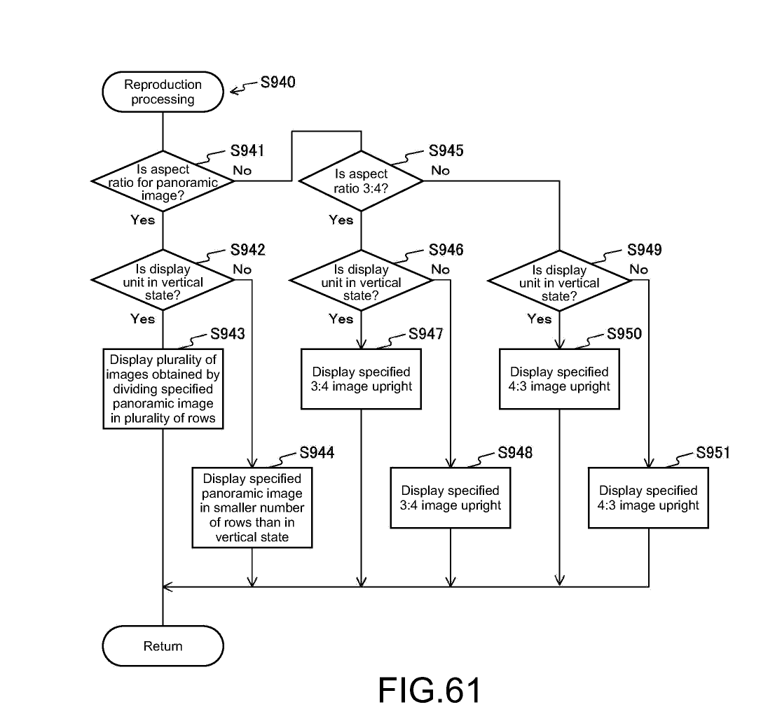

Further, if the reproduction mode is set (Step S901), a reproduction function is activated (Step S905) and reproduction processing is performed (Step S940). This reproduction processing will be described in detail with reference to FIG. 61. Note that Step S940 is an example of a display control procedure described in scope of claims.

Subsequently, a determination is made as to whether or not the reproduction mode is released (Step S906), and, if the reproduction mode is not released, the processing returns to Step S940. On the other hand, if the reproduction mode is released (Step S906), a determination is made as to whether or not the operation mode other than the imaging mode and the reproduction mode is set (Step S904).

FIG. 59 is a flowchart showing an example of an imaging processing procedure (processing procedure in Step S910 of FIG. 58) of a display control processing procedure by the information processing apparatus 100 in the first embodiment of the present disclosure.

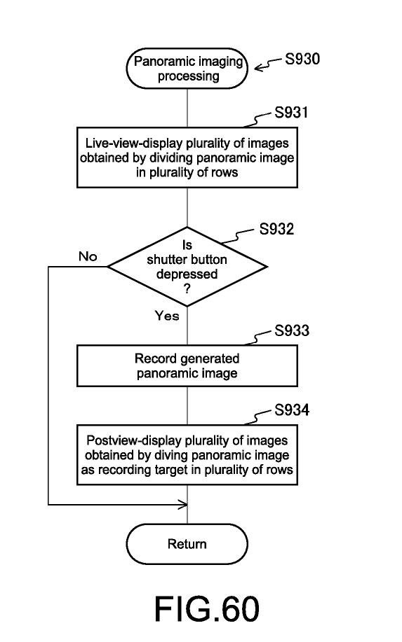

First, the display control unit 550 determines whether or not the aspect ratio of an image generated by the image generation unit 510 is for a panoramic image (Step S911). Then, if the aspect ratio of the image is for a panoramic image (Step S911), panoramic imaging processing is performed (Step S930). Note that this panoramic imaging processing will be described in detail with reference to FIG. 60.

Otherwise, if the aspect ratio of the image is not for a panoramic image (Step S911), the display control unit 550 determines whether or not the aspect ratio of the image is 3:4 (Step S912). Then, if the aspect ratio of the image is 3:4 (Step S912), the display control unit 550 causes the display unit 140 to display an image (3:4 image) generated by the image generation unit 510 (Step S913). That is, the 3:4 image is live-view-displayed.

Subsequently, a determination is made as to whether or not the shutter button (e.g., determination key 112) is depressed (Step S914), and, if the shutter button is not depressed, the operation of the imaging processing is terminated. On the other hand, if the shutter button is depressed (Step S914), the record control unit 530 records an image (3:4 image) generated at a timing of the depression in the storage unit 540 (Step S915). Subsequently, the display control unit 550 causes the display unit 140 to display an image (3:4 image) as a recording target in the storage unit 540 (Step S916). That is, the 3:4 image is postview-displayed.

Otherwise, if the aspect ratio of the image is not 3:4 (if aspect ratio of image is 4:3) (Step S912), the display control unit 550 causes the display unit 140 to display an image (4:3 image) generated by the image generation unit 510 (Step S917). That is, the 4:3 image is live-view-displayed.

Subsequently, a determination is made as to whether or not the shutter button is depressed (Step S918), and, if the shutter button is not depressed, the operation of the imaging processing is terminated. On the other hand, if the shutter button is depressed (Step S918), the record control unit 530 records an image (4:3 image) generated at a timing of the depression in the storage unit 540 (Step S919). Subsequently, the display control unit 550 causes the display unit 140 to display an image (4:3 image) as a recording target in the storage unit 540 (Step S920). That is, the 4:3 image is postview-displayed.

FIG. 60 is a flowchart showing an example of a panoramic imaging processing procedure (processing procedure in Step S930 of FIG. 59) of the display control processing procedure by the information processing apparatus 100 in the first embodiment of the present disclosure.

First, the display control unit 550 causes the display unit 140 to display an image (panoramic image) generated by the image generation unit 510 (Step S931). In this case, a plurality of images obtained by dividing the panoramic image are live-view-displayed in a plurality of rows (plurality of rows in longitudinal direction of display unit 140) (Step S931). For example, as shown in FIG. 32 and the like, live view images are displayed. In this case, if a feature is detected, as shown in FIGS. 37 and 38, an image including the feature may be displayed as the middle image.

Subsequently, a determination is made as to whether or not the shutter button is depressed (Step S932), and, if the shutter button is not depressed, the operation of the panoramic imaging processing is terminated. On the other hand, if the shutter button is depressed (Step S932), the record control unit 530 records an image (panoramic image) generated at a timing of the depression in the storage unit 540 (Step S933). In this case, if a feature is detected, information on the feature (e.g., coordinates of feature in panoramic image) is recorded in association with the panoramic image. Alternatively, in addition to the panoramic image, a peripheral image including the feature may be recorded in association with the panoramic image. The peripheral image including the feature can be recorded as, for example, a display image (e.g., thumbnail image).

Subsequently, the display control unit 550 causes the display unit 140 to display the image (panoramic image) as a recording target in the storage unit 540 (Step S934). In this case, a plurality of images obtained by diving the panoramic image are postview-displayed in a plurality of rows (plurality of rows in longitudinal direction of display unit 140) (Step S934). For example, as shown in FIG. 32 and the like, postview images are displayed. In this case, if a feature is detected, as shown in FIGS. 37 and 38, an image including the feature may be displayed as the middle image. Note that Step S933 is an example of an imaging procedure described in scope of claims. Further, Steps S931 and S934 are examples of the display control procedure described in scope of claims.

FIG. 61 is a flowchart showing an example of a reproduction processing procedure (processing procedure in Step S940 of FIG. 58) of the display control processing procedure by the information processing apparatus 100 in the first embodiment of the present disclosure.

First, the display control unit 550 determines whether or not the aspect ratio of an image (image stored in storage unit 540) that the user instructs to reproduce is for a panoramic image (Step S941). Then, if the aspect ratio of the image is for a panoramic image (Step S941), the display control unit 550 determines, based on attitude information from the attitude detection unit 150, whether or not the display unit 140 is in a vertical state (Step S942).

Then, if the display unit 140 is in the vertical state (Step S942), the display control unit 550 causes the display unit 140 to display the panoramic image (panoramic image stored in storage unit 540) that the user instructs to reproduce (Step S943). In this case, a plurality of images obtained by dividing the panoramic image are displayed in a plurality of rows (plurality of rows in longitudinal direction of display unit 140) (Step S943). For example, as shown in FIG. 32 and the like, images are displayed. In this case, if a feature is recorded in association with the panoramic image, as shown in FIGS. 37 and 38, an image including the feature may be displayed as the middle image.

Further, if the display unit 140 is not in the vertical state (if display unit 140 is in horizontal state) (Step S942), the display control unit 550 causes the display unit 140 to display the panoramic image (panoramic image stored in storage unit 540) that the user instructs to reproduce (Step S944). In this case, the panoramic image is displayed in a smaller number of rows (number of rows in longitudinal direction of display unit 140) than the number of rows when displayed in the vertical state (Step S944). For example, as shown on the left-hand side of Parts “a” to “c” of FIG. 46, an image(s) is displayed.

Otherwise, if the aspect ratio of the image is not for a panoramic image (Step S941), the display control unit 550 determines whether or not the aspect ratio of the image is 3:4 (Step S945). Then, if the aspect ratio of the image is 3:4 (Step S945), the display control unit 550 determines, based on the attitude information from the attitude detection unit 150, whether or not the display unit 140 is in a vertical state (Step S946).

Then, if the display unit 140 is in the vertical state (Step S946), the display control unit 550 causes the display unit 140 to display an image (3:4 image stored in storage unit 540) that the user instructs to reproduce (Step S947). In this case, the 3:4 image instructed to be reproduced is displayed upright (Step S947). For example, as shown in FIGS. 52 and 55, an image is displayed.

Otherwise, if the display unit 140 is not in the vertical state (if display unit 140 is in horizontal state) (Step S946), the display control unit 550 causes the display unit 140 to display an image (3:4 image stored in storage unit 540) that the user instructs to reproduce (Step S948). In this case, the 3:4 image instructed to be reproduced is displayed upright (Step S948).

Otherwise, if the aspect ratio of the image is not 3:4 (if aspect ratio is 4:3) (Step S949), the display control unit 550 determines, based on the attitude information from the attitude detection unit 150, whether or not the display unit 140 is in a vertical state (Step S949).

Then, if the display unit 140 is in the vertical state (Step S950), the display control unit 550 causes the display unit 140 to display an image (4:3 image stored in storage unit 540) that the user instructs to reproduce (Step S950). In this case, the 4:3 image instructed to be reproduced is displayed upright (Step S950). For example, as shown in FIGS. 53 and 56, an image is displayed.

Otherwise, if the display unit 140 is not in the vertical state (if display unit 140 is in horizontal state) (Step S949), the display control unit 550 causes the display unit 140 to display the image (4:3 image stored in storage unit 540) that the user instructs to reproduce (Step S951). In this case, the 4:3 image instructed to be reproduced is displayed upright (Step S951).

[Operation Example when Middle Image is Scroll-Displayed]

In the above, the operation example when a display is performed with the positions (positions in longitudinal direction) of the images (middle image, left image, and right image), which are displayed on the display unit 140, in the panoramic image being fixed. An operation example when a display (so-called automatic scroll display) is performed while moving the position (position in longitudinal direction) of the middle image in the panoramic image is shown below.

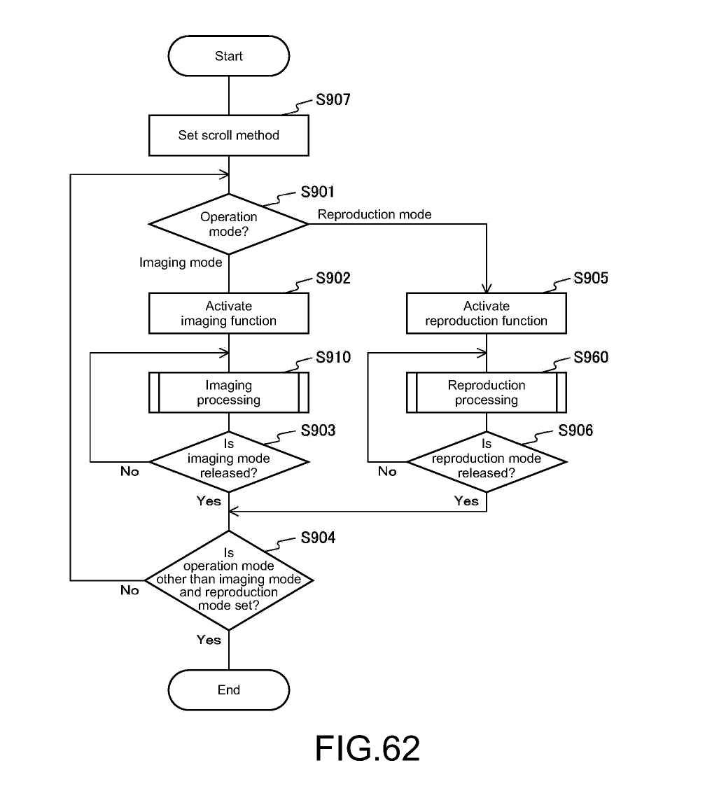

FIG. 62 is a flowchart showing an example of the processing procedure of the display control processing by the information processing apparatus 100 in the first embodiment of the present disclosure. Note that FIG. 62 is a modified example of FIG. 58, and hence portions common to those in FIG. 58 are denoted by the same reference symbols and some descriptions thereof are omitted.

First, the scroll method is set (Step S907). In the setting of the scroll method, whether or not to perform a scroll display during each display is set. Further, the setting of the scroll method is performed, for example, manually by the user or automatically. The setting content is stored in, for example, the display control unit 550.

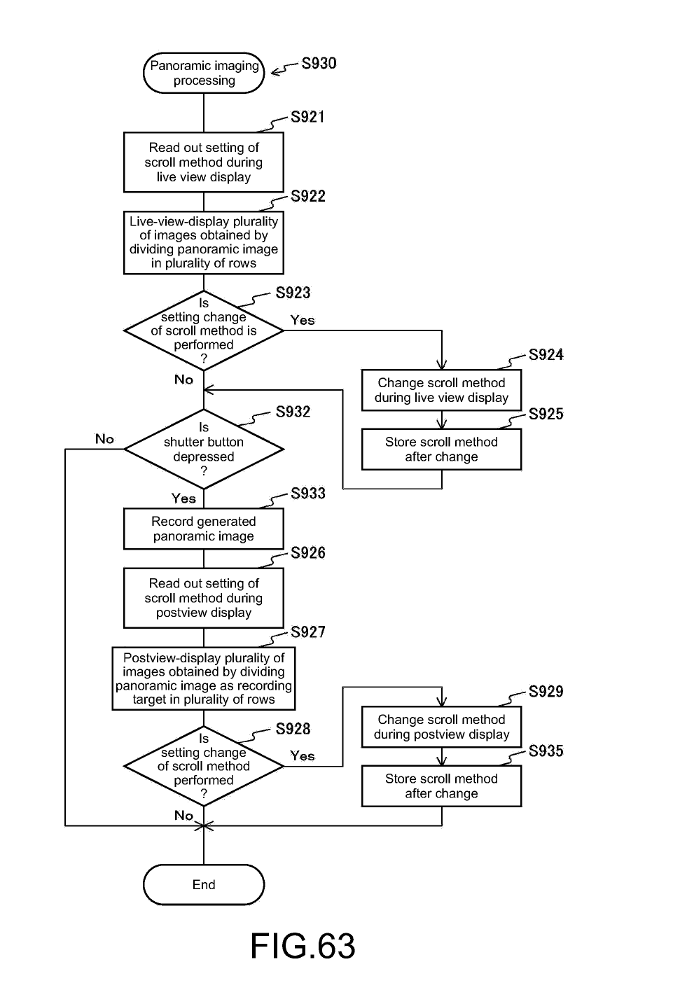

Otherwise, if the imaging mode is set (Step S901), the imaging function is activated (Step S902) and the imaging processing is performed (Step S910). The panoramic imaging processing (Step S930 of FIG. 59) in this imaging processing (shown in FIG. 59) will be described in detail with reference to FIG. 63.

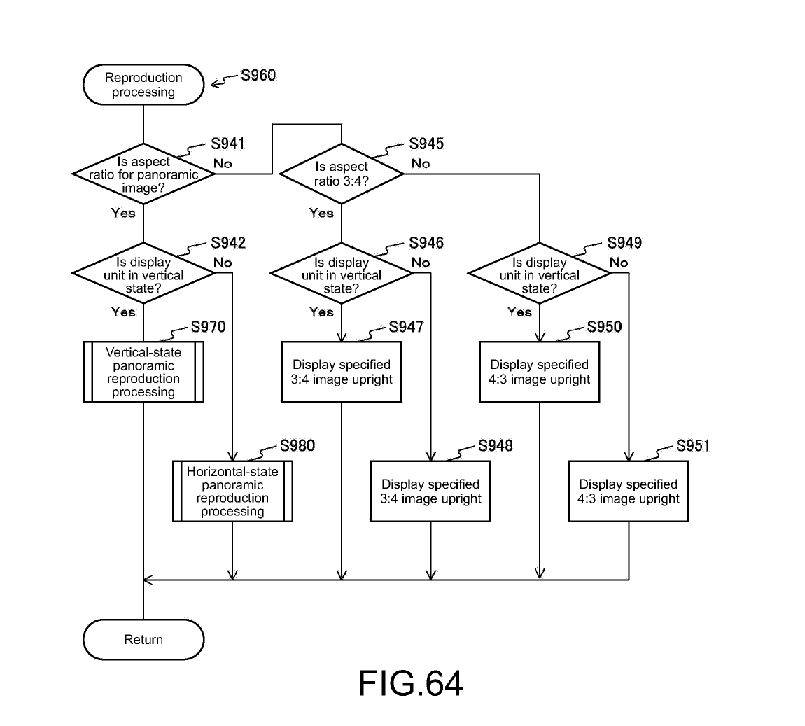

Otherwise, if the reproduction mode is set (Step S901), the reproduction function is activated (Step S905) and the reproduction processing is performed (Step S960). This reproduction processing will be described in detail with reference to FIG. 64.

FIG. 63 is a flowchart showing an example of the panoramic imaging processing procedure (processing procedure in Step S930 of FIG. 59) of the display control processing procedure by the information processing apparatus 100 in the first embodiment of the present disclosure. Note that FIG. 63 is a modified example of FIG. 60, and hence portions common to those in FIG. 60 are denoted by the same reference symbols and some descriptions thereof are omitted.

First, the display control unit 550 reads out the setting of the scroll method during the live view display (Step S921). Subsequently, based on the read-out setting of the scroll method, the display control unit 550 causes the display unit 140 to display an image (panoramic image) generated by the image generation unit 510 (Step S922). For example, if the setting to perform the scroll during the live view display is made, as shown in FIGS. 42 and 43, a display of the middle image is performed while moving the position (position in longitudinal direction) of the middle image in the panoramic image. On the other hand, if the setting not to perform the scroll during the live view display is made, the middle image is displayed with the position of the middle image in the panoramic image being fixed.

Subsequently, a determination is made as to whether or not the setting change of the scroll method is performed (Step S923). For example, during the live view display, a setting change of the scroll method (e.g., from performing scroll display to not performing scroll display or from not performing scroll display to performing scroll display) is performed by a manual operation by the user. Then, if a setting change of the scroll method is performed (Step S923), the scroll method during the live view display is changed (Step S924), and a scroll method after the change is stored (Step S925).

Subsequently, the display control unit 550 reads out the setting of the scroll method during the postview display (Step S926). Subsequently, the display control unit 550 causes, based on the read-out setting of the scroll method, the display unit 140 to display an image (panoramic image) as a recording target in the storage unit 540 (Step S927). For example, if the setting to perform the scroll during the postview display is made, as shown in FIGS. 42 and 43, the middle image is displayed while moving the position (position in longitudinal direction) of the middle image in the panoramic image. On the other hand, if the setting not to perform the scroll during the postview display is made, the middle image is displayed with the position of the middle image in the panoramic image being fixed.

Subsequently, a determination is made as to whether or not a setting change of the scroll method is performed (Step S928). For example, during the postview display, a setting change of the scroll method (e.g., from performing scroll display to not performing scroll display or from not performing scroll display to performing scroll display) is performed by a manual operation by the user. Then, if a setting change of the scroll method is performed (Step S928), the scroll method during the postview display is changed (Step S929), and a scroll method after the change is stored (Step S935).

FIG. 64 is a flowchart showing an example of a reproduction processing procedure (processing procedure in Step S960 of FIG. 62) of the display control processing procedure by the information processing apparatus 100 in the first embodiment of the present disclosure. Note that FIG. 64 is a modified example of FIG. 61, and hence portions common to those in FIG. 61 are denoted by the same reference symbols and some descriptions thereof are omitted.

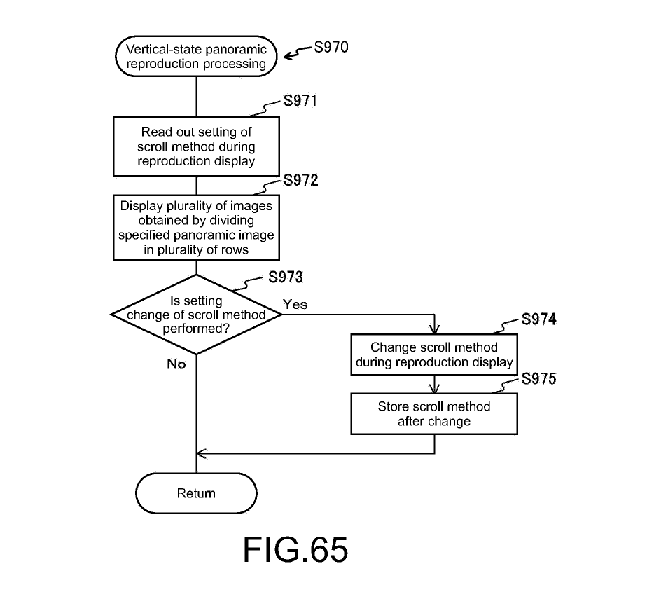

If the display unit 140 is in the vertical state (Step S942), vertical-state panoramic reproduction processing is performed (Step S970). The vertical-state panoramic reproduction processing will be described in detail with reference to FIG. 65.

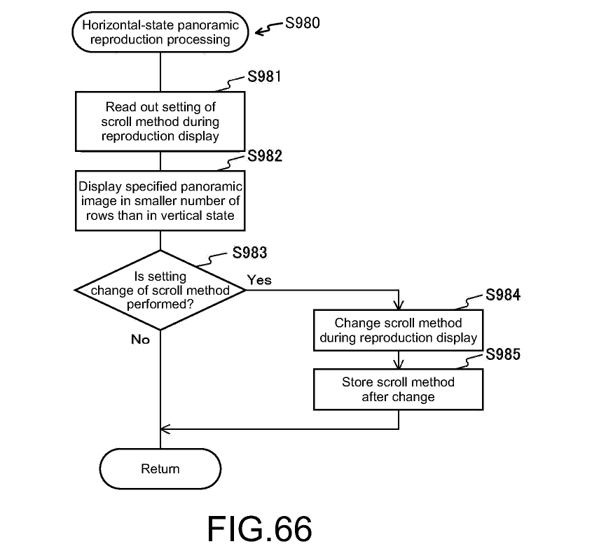

Otherwise, if the display unit 140 is not in the vertical state (display unit 140 is in horizontal state) (Step S942), horizontal-state panoramic reproduction processing is performed (Step S980). The horizontal-state panoramic reproduction processing will be described in detail with reference to FIG. 66.

FIG. 65 is a flowchart showing an example of the vertical-state panoramic reproduction processing procedure (processing procedure in Step S970 of FIG. 64) of the display control processing procedure by the information processing apparatus 100 in the first embodiment of the present disclosure.

First, the display control unit 550 reads out the setting of the scroll method during the reproduction display (Step S971). Subsequently, the display control unit 550 causes, based on the read-out setting of the scroll method, the display unit 140 to display an image that the user instructs to reproduce (panoramic image stored in storage unit 540) (Step S972). For example, if the setting to perform the scroll during the reproduction display is made, as shown in FIGS. 42 and 43, the middle image is displayed while moving the position (position in longitudinal direction) of the middle image in the panoramic image. On the other hand, if the setting not to perform the scroll during the reproduction display is made, the middle image is displayed with the position of the middle image in the panoramic image being fixed.

Subsequently, a determination is made as to whether or not a setting change of the scroll method is performed (Step S973). For example, during the reproduction display, a setting change of the scroll method (e.g., from performing scroll display to not performing scroll display or from not performing scroll display to performing scroll display) is performed by a manual operation by the user. Then, if the setting change of the scroll method is performed (Step S973), the scroll method during the reproduction display is changed (Step S974), and a scroll method after the change is stored (Step S975).

FIG. 66 is a flowchart showing an example of the horizontal-state panoramic reproduction processing procedure (processing procedure in Step S980 of FIG. 64) of the display control processing procedure by the information processing apparatus 100 in the first embodiment of the present disclosure.

First, the display control unit 550 reads out the setting of the scroll method during the reproduction display (Step S981). Subsequently, the display control unit 550 causes, based on the read-out setting of the scroll method, the display unit 140 to display an image (panoramic image stored in storage unit 540) that the user instructs to reproduce (Step S982). For example, when the setting to perform the scroll during the reproduction display is made, as shown in FIGS. 42 and 43, the middle image is displayed while moving the position (position in longitudinal direction) of the middle image in the panoramic image. On the other hand, if the setting not to perform the scroll during the reproduction display is made, the middle image is displayed with the position of the middle image in the panoramic image being fixed.

Subsequently, a determination is made as to whether or not a setting change of the scroll method is performed (Step S983). For example, during the reproduction display, a setting change of the scroll method (e.g., from performing scroll display to not performing scroll display or from not performing scroll display to performing scroll display) is performed by a manual operation by the user. Then, if the setting change of the scroll method is performed (Step S983), the scroll method during the reproduction display is changed (Step S984), a scroll method after the change is stored (Step S985).

### 2. Second Embodiment

In the first embodiment of the present disclosure, the example in which the imaging unit is fixedly provided in the information processing apparatus is shown above. It should be noted that the first embodiment of the present disclosure may also be applied to an information processing apparatus in which an imaging unit is movably provided.

In a second embodiment of the present disclosure, an example of an information processing apparatus in which an imaging unit is movably provided is shown.

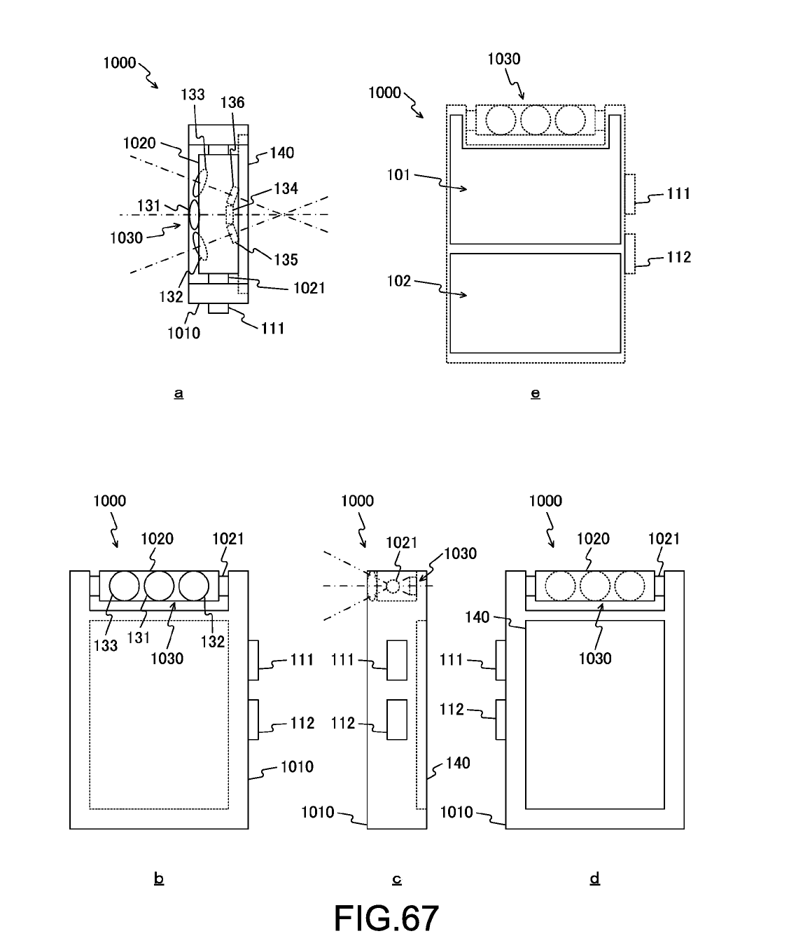

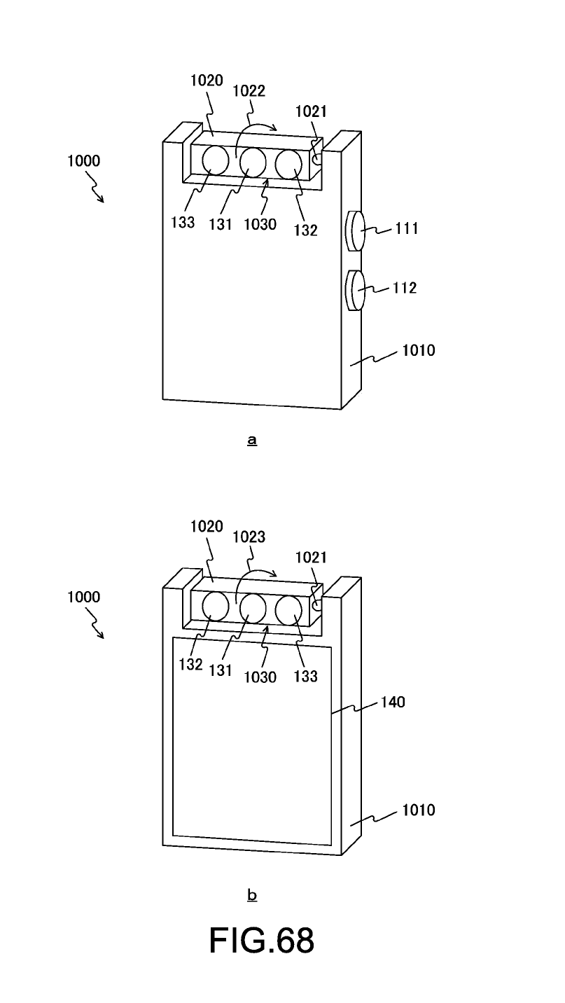

FIGS. 67 and 68 are diagrams showing an outer-appearance configuration example of an information processing apparatus 1000 in the second embodiment of the present disclosure.

FIGS. 67 and 68 show an information processing apparatus 1000 in which an imaging unit 1030 is movably provided. In Part “a” of FIG. 67, a top view of the information processing apparatus 1000 is shown. In Part “b” of FIG. 67, a front view of the information processing apparatus 1000 is shown. In Part “c” of FIG. 67, a side view of the information processing apparatus 1000 is shown. In Part “d” of FIG. 67, a rear view of the information processing apparatus 1000 is shown. In Part “e” of FIG. 67, an arrangement example of an electronic substrate of the information processing apparatus 1000 is shown. Note that Parts “a” to “e” of FIG. 67 correspond to Parts “a” to “e” of FIG. 1, respectively. Further, portions corresponding to those of the information processing apparatus 100 shown in FIG. 1 are denoted by the same reference symbols. In Part “a” of FIG. 68, a perspective view on a front side of the information processing apparatus 1000 is shown. In Part “b” of FIG. 68, a perspective view on a rear side of the information processing apparatus 1000 is shown.

The information processing apparatus 1000 is realized by, for example, an information processing apparatus (e.g., cell phone with movable multi-eye camera) including a plurality of imaging systems.

The information processing apparatus 1000 includes a first casing 1010, a second casing 1020, and a rotation member 1021. The second casing 1020 is a casing attached to the first casing 1010 that houses a display unit 140. Further, the second casing 1020 is a rotatable casing including an axis of rotation parallel (or almost parallel) to a short side of the display unit 140. Further, three imaging systems (optical systems 131 to 133 and imaging devices 134 to 136) constituting the imaging unit 1030 are arranged in a direction parallel (or almost parallel) to the axis of rotation of the second casing 1020 on a surface of the second casing 1020. The imaging unit 1030 is movably provided in this manner, and hence the imaging unit 1030 can be rotated in directions of the arrows 1022 and 1023 of FIG. 68 within a range of 180 degrees with the rotation member 1021 being an axis of rotation. For example, when the user holds the information processing apparatus 1000 in the state shown in Part “b” of FIG. 68, the user can capture a horizontally long image including the user while viewing the display unit 140. Otherwise, for example, when the user holds the information processing apparatus 1000 in a state in which the optical axis of the imaging unit 1030 is parallel (or almost parallel) to the direction of gravitational force, the user can also capture a horizontally long image with an upper side (e.g., sky) being a subject while viewing the display unit 140.

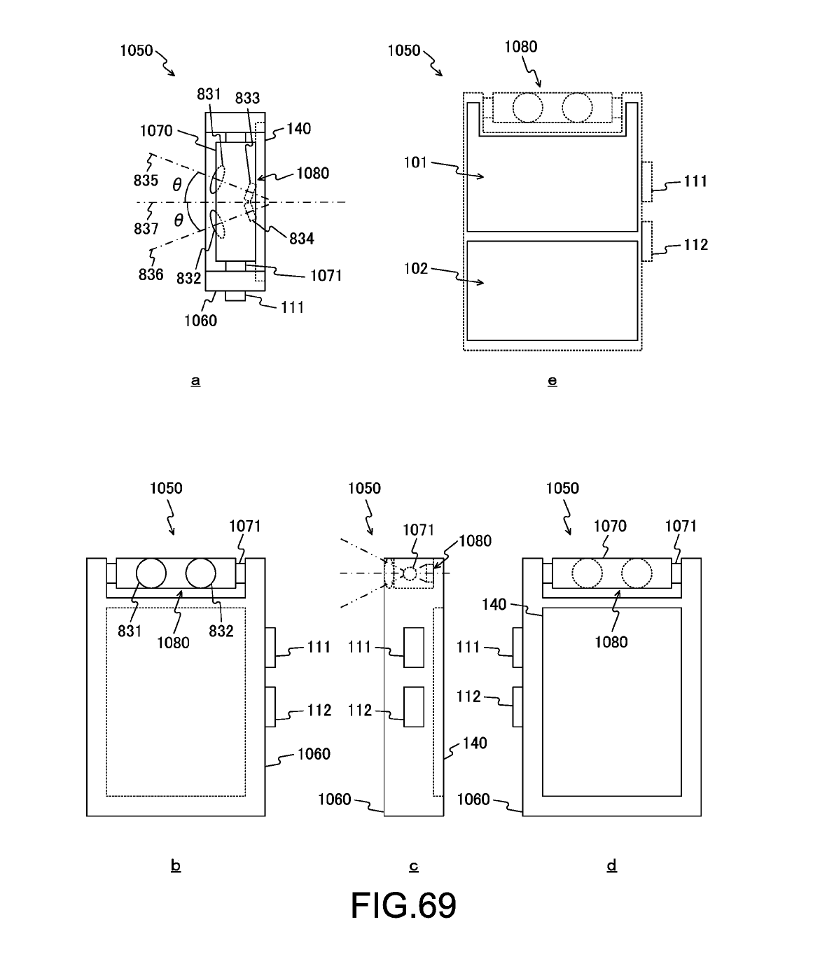

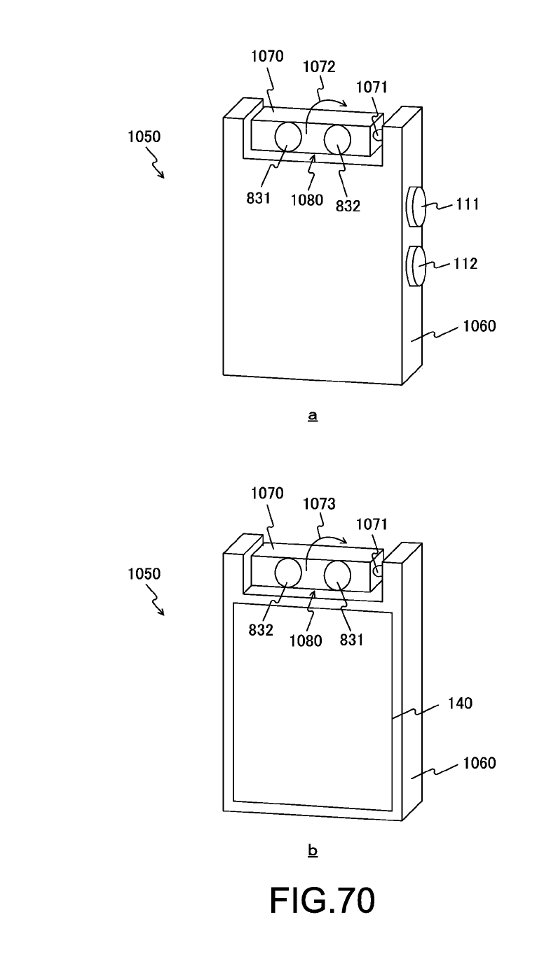

In this manner, the first embodiment of the present disclosure may be applied to the information processing apparatus 1000 including the plurality of imaging systems, in which the imaging system of the plurality of imaging systems is movably provided. Note that, in this example, the three imaging systems are arranged according to a predetermined rule. It should be noted that the first embodiment of the present disclosure may also be applied to an information processing apparatus (e.g., imaging apparatus such as digital still camera and digital video camera (e.g., camera-integrated recorder)) including two or four or more imaging systems. An Example in which two imaging systems are arranged according to a predetermined rule is shown in FIGS. 69 and 70.

FIGS. 69 and 70 are diagrams showing an outer-appearance configuration example of an information processing apparatus 1050 in the second embodiment of the present disclosure.

FIGS. 69 and 70 show the information processing apparatus 1050 in which an imaging unit 1080 including two imaging systems is movably provided. In Part “a” of FIG. 69, a top view of the information processing apparatus 1050 is shown. In Part “b” of FIG. 69, a front view of the information processing apparatus 1050 is shown. In Part “c” of FIG. 69, a side view of the information processing apparatus 1050 is shown. In Part “d” of FIG. 69, a rear view of the information processing apparatus 1050 is shown. In Part “e” of FIG. 69, an arrangement example of an electronic substrate of the information processing apparatus 1050 is shown. Note that Parts “a” to “e” of FIG. 69 correspond to Parts “a” to “e” of FIG. 49, respectively. Further, portions corresponding to those of the information processing apparatus 820 shown in FIG. 49 are denoted by the same reference symbols. In Part “a” of FIG. 70, a perspective view on a front side of the information processing apparatus 1050 is shown. In Part “b” of FIG. 70, a perspective view on a rear side of the information processing apparatus 1050 is shown.

The information processing apparatus 1050 is realized by, for example, an information processing apparatus (e.g., cell phone with movable multi-eye camera) including two imaging systems.

The information processing apparatus 1050 includes a first casing 1060, a second casing 1070, and a rotation member 1071. The second casing 1070 is a casing attached to the first casing 1060 that houses a display unit 140. Further, the second casing 1070 is a rotatable casing including an axis of rotation parallel (or almost parallel) to a short side of the display unit 140. Further, the two imaging systems (optical systems 831 and 832 and imaging devices 833 and 834) constituting the imaging unit 1080 are arranged in a direction parallel (or almost parallel) to the axis of rotation of the second casing 1070 on a surface of the second casing 1070. The imaging unit 1080 is movably provided in this manner, and hence the imaging unit 1080 can be rotated in the directions of the arrows 1072 and 1073 of FIG. 70 within a range of 180 degrees with the rotation member 1071 being an axis of rotation. With this, for example, as in the example shown in FIGS. 67 and 68, the user can capture a horizontally long image including the user while viewing the display unit 140 and can also capture a horizontally long image with an upper side (e.g., sky) being a subject while viewing the display unit 140.

In this manner, the first embodiment of the present disclosure may be applied to the information processing apparatus 1050 including the two imaging systems, in which the imaging system of the two imaging systems are movably provided. Note that, in FIGS. 67 to 70, the example in which the information processing apparatus capable of rotating the imaging unit within the range of 180 degrees with the rotation member being the axis of rotation is shown. It should be noted that the rotation range may be a range other than the range of 180 degrees. For example, the imaging unit 1030 may be provided so as to be rotated in the direction of the arrow 1022 from the state shown in Part “a” of FIG. 68 with the rotation member 1071 being the axis of rotation within a range of 90 degrees.

Note that the first embodiment of the present disclosure may be applied to an information processing apparatus (electronic apparatus, image processing apparatus, display apparatus, or display control apparatus) capable of causing a display apparatus (built-in display apparatus or external display apparatus) to display a panoramic image. For example, the first embodiment of the present disclosure may be applied to apparatuses such as a multi-eye imaging apparatus, a digital photo frame, a tablet terminal, a digital signage terminal (e.g., rotation type), a navigation apparatus, a personal computer, a portable medium player. Further, the first embodiment of the present disclosure may also be applied to an apparatus having no imaging function (e.g., tablet terminal having no imaging function (e.g., apparatus that displays panoramic image on a web site)). Note that the multi-eye imaging apparatus is, for example, a multi-eye digital still camera or a multi-eye digital video camera (e.g., camera-integrated recorder).

The display method in the first embodiment of the present disclosure may also be applied to an imaging apparatus other than the multi-eye imaging apparatus. For example, the display method may be applied to a single-eye imaging apparatus (e.g., single-eye camera capable of capturing horizontally longer panoramic image in comparison with 16:9 in direction of short side of casing) including a wide-angle lens and an imaging device.

The embodiments of the present invention are shown as an example for implementing the present invention. The matters in the embodiments of the present invention have corresponding relations to the invention specifying matters in the claims. Similarly, the invention specifying matters in the claims have corresponding relations to the matters in the embodiments of the present invention having the same names as the invention specifying matters. However, the present invention is not limited to the embodiments, and various modifications can be made in the range without departing from the subject matter of the present invention.

In addition, the processing procedures described in the embodiments of the present invention may be grasped as the methods including the series of procedures. Moreover, the series of procedures may be grasped as the programs for making a computer execute the series of the procedures, or a recording medium storing the programs. As the recording medium, a compact disc (CD), a MiniDisc (MD), a digital versatile disc (DVD), a memory card, a blu-ray disc (registered trademark), and the like may be used.

Note that the present disclosure may also take the following configurations.

(1) An information processing apparatus, including:
a plurality of imaging units that are arranged, on a surface almost parallel to a display surface of a display unit, in a direction almost orthogonal to a long side of the display unit; and
a display control unit configured to control, in a state in which the long side of the display unit is almost parallel to a direction of gravitational force, the display unit to display a plurality of areas of a horizontally long image in a plurality of rows in a longitudinal direction of the display unit, the horizontally long image being obtained by connecting a plurality of images generated by the plurality of imaging units, the display control unit being configured to control the display unit to display, as the plurality of areas of the horizontally long image,
   a first image and a second image being two images including areas of both end portions in a longitudinal direction of the horizontally long image, and
   a third image being an image including an area present between the both end portions.
      (2) An information processing apparatus, including:
a plurality of imaging units that are housed in a second casing being a casing attached to a first casing that houses a display unit and rotatable about an axis of rotation almost parallel to a short side of the display unit, and that are arranged on a surface of the second casing in a direction almost parallel to the axis of rotation; and
a display control unit configured to control, in a state in which a long side of the display unit is almost parallel to a direction of gravitational force, the display unit to display a plurality of areas of a horizontally long image in a plurality of rows in a longitudinal direction of the display unit, the horizontally long image being obtained by connecting a plurality of images generated by the plurality of imaging units, the display control unit being configured to control the display unit to display, as the plurality of areas of the horizontally long image,
   a first image and a second image being two images including areas of both end portions in a longitudinal direction of the horizontally long image, and
   a third image being an image including an area present between the both end portions.
      (3) The information processing apparatus according to Item (1) or (2), in which
the display control unit is configured to control the display unit to display the first image and the second image in the same row and the third image in another row.
   (4) The information processing apparatus according to Item (3), in which
the display control unit is configured to control the display unit to display the third image in a row above a row in which the first image and the second image are displayed.
   (5) The information processing apparatus according to Item (3) or (4), in which
the display unit is configured to control the display unit to display the first image to the third image such that the third image has a horizontal size larger than a horizontal size of each of the first image and the second image.
   (6) The information processing apparatus according to any one of Items (1) to (5), in which
the display control unit is configured to control the display unit to display an image in an area other than display areas of the first image to the third image, the image being obtained by reducing a whole of the horizontally long image.
   (7) The information processing apparatus according to any one of Items (1) to (6), further including
an attitude detection unit configured to detect an attitude of the information processing apparatus, in which
the display control unit is configured to control, when the long side of the display unit is almost perpendicular to the direction of gravitational force, the display unit to display the first image to the third image in a smaller number of rows than the number of rows when the long side of the display unit is almost parallel to the direction of gravitational force.
   (8) The information processing apparatus according to any one of Items (1) to (7), in which
the display control unit is configured to control, when controlling the display unit to display an image being a display target that has a ratio of a horizontal size to a vertical size smaller than a ratio of a horizontal size to a vertical size of the horizontally long image, the display unit to display the first image to the third image in a smaller number of rows than the number of rows when the horizontally long image is displayed.
   (9) The information processing apparatus according to any one of Items (1) to (8), further including
a specific-target detection unit configured to detect a specific target included in the horizontally long image, in which
the display control unit is configured to control the display unit to display an image including an area in which the detected specific target is present, as the third image.
   (10) The information processing apparatus according to Item (9), further including
a record control unit configured to record, when recording the horizontally long image, specific-target information on a recording medium in association with the horizontally long image, the specific-target information relating to the area in which the specific target is present, in which
the display control unit is configured to control, when controlling the display unit to display the horizontally long image recorded on the recording medium, the display unit to display an image relating to the area in which the specific target is present using the specific-target information recorded in association with the horizontally long image.
   (11) The information processing apparatus according to any one of Items (1) to (10), in which
the display control unit is configured to control the display unit to display the third image while moving an area displayed as the third image from one end portion to the other end portion of the both end portions.
   (12) The information processing apparatus according to any one of Items (1) to (11), further including
an operation receiving unit configured to receive a switching instruction operation from a user that relates to a display method for the third image, in which
the display control unit is configured to select, based on the switching instruction operation, either one of
   a display method of displaying the third image while moving an area displayed as the third image from one end portion to the other end portion of the both end portions, and
   a display method of displaying a certain area as the third image without moving the area displayed as the third image, and to control the display unit to display the third image.
      (13) The information processing apparatus according to Item (12), in which
when the display method for the third image is switched, a display method according to the switching is stored by the time a display of the third image based on the switching is completed, and
when the horizontally long image is newly displayed after the display of the third image based on the switching is completed, the third image in the horizontally long image is displayed using the stored display method.
   (14) The information processing apparatus according to any one of Items (1) to (11), further including
an operation receiving unit configured to receive, when a reduced image obtained by reducing a whole of the horizontally long image is displayed in an area other than display areas of the first image to the third image, a designation operation for designating a position in the reduced image, in which
the display control unit is configured to
   control, if the third image is displayed by a display method of displaying the third image while moving an area displayed as the third image from one end portion to the other end portion of the both end portions when the designation operation is performed, the display unit to display an image including the position in the reduced image designated by the designation operation and a peripheral area thereof as a new third image, and perform a display of the third image while performing the movement with the position being a start point, and
   control, if the third image is displayed by a display method of displaying a certain area as the third image without moving the area displayed as the third image when the designation operation is performed, the display unit to display an image including the position and a peripheral area thereof as a new third image.
      (15) The information processing apparatus according to any one of Items (1) to (11), in which
the display control unit is configured to
   switch, during live view or during postview in accordance with a user operation, between
      a first display method of displaying the third image with a position of the third image in the horizontally long image being fixed and
      a second display method of displaying an image including an area in which a specific target included in the horizontally long image is present as the third image, and
   switch, during reproduction in accordance with a user operation, between
      a third display method of displaying the third image while moving an area displayed as the third image from one end portion to the other end portion of the both end portions and
      the second display method.
         (16) The information processing apparatus according to any one of Items (1) to (11), in which
the display control unit is configured to
   switch, during live view in accordance with a user operation, between
      a first display method of displaying the third image with a position of the third image in the horizontally long image being fixed and
      a second display method of displaying an image including an area in which a specific target included in the horizontally long image is present as the third image, and
   switch, during postview or reproduction in accordance with a user operation, between
      a third display method of displaying the third image while moving an area displayed as the third image from one end portion to the other end portion of the both end portions and
      the second display method.
         (17) The information processing apparatus according to any one of Items (1) to (16), in which
the display control unit is configured to control, when the information processing apparatus is shipped from a factory or when a user uses the information processing apparatus, if an image display method by a live view operation of displaying an image generated by the imaging unit on the display unit before the user records the image, an image display method by a postview operation of displaying the recorded image on the display unit immediately after the user records the image, and an image display method by a reproduction operation of displaying an image specified by the user on the display unit are individually set, the display unit to display each image based on the setting.
   (18) A display apparatus, including:
a display unit configured to display an image; and
a display control unit configured to control, when controlling the display unit to display a horizontally long image in a state in which a long side of the display unit is almost parallel to a direction of gravitational force, the display unit to display a plurality of areas of the horizontally long image in a plurality of rows in a longitudinal direction of the display unit, the display control unit being configured to control the display unit to display, as the plurality of areas of the horizontally long image,
   a first image and a second image being two images including areas of both end portions in a longitudinal direction of the horizontally long image, and
   a third image being an image including an area present between the both end portions.
      (19) The display apparatus according to Item (18), in which
the display control unit is configured to control the display unit to display the first image and the second image in the same row and the third image in another row.
   (20) The display apparatus according to Item (19), in which
the display control unit is configured to control the display unit to display the third image in a row above a row in which the first image and the second image are displayed.
   (21) The display apparatus according to Item (19) or (20), in which
the display unit is configured to control the display unit to display the first image to the third image such that the third image has a horizontal size larger than a horizontal size of each of the first image and the second image.
   (22) The display apparatus according to any one of Items (18) to (21), in which
the display control unit is configured to control the display unit to display an image in an area other than display areas of the first image to the third image, the image being obtained by reducing a whole of the horizontally long image.
   (23) The display apparatus according to any one of Items (18) to (22), further including
an attitude detection unit configured to detect an attitude of the display apparatus, in which
the display control unit is configured to control, when the long side of the display unit is almost perpendicular to the direction of gravitational force, the display unit to display the first image to the third image in a smaller number of rows than the number of rows when the long side of the display unit is almost parallel to the direction of gravitational force.
   (24) The display apparatus according to any one of Items (18) to (23), in which
the display control unit is configured to control, when controlling the display unit to display an image being a display target that has a ratio of a horizontal size to a vertical size smaller than a ratio of a horizontal size to a vertical size of the horizontally long image, the display unit to display the first image to the third image in a smaller number of rows than the number of rows when the horizontally long image is displayed.
   (25) A control method for an information processing apparatus, including:
an imaging procedure of generating a plurality of images by a plurality of imaging units that are arranged, on a surface almost parallel to a display surface of a display unit, in a direction almost orthogonal to a long side of the display unit; and
a display control procedure of controlling, in a state in which the long side of the display unit is almost parallel to a direction of gravitational force, the display unit to display a plurality of areas of a horizontally long image obtained by connecting the plurality of images, in a plurality of rows in a longitudinal direction of the display unit, the display control procedure including controlling the display unit to display, as the plurality of areas of the horizontally long image,
   a first image and a second image being two images including areas of both end portions in a longitudinal direction of the horizontally long image, and
   a third image being an image including an area present between the both end portions.
      (26) A program that causes a computer to execute:
an imaging procedure of generating a plurality of images by a plurality of imaging units that are arranged, on a surface almost parallel to a display surface of a display unit, in a direction almost orthogonal to a long side of the display unit; and
a display control procedure of controlling, in a state in which the long side of the display unit is almost parallel to a direction of gravitational force, the display unit to display a plurality of areas of a horizontally long image obtained by connecting the plurality of images, in a plurality of rows in a longitudinal direction of the display unit, the display control procedure including controlling the display unit to display, as the plurality of areas of the horizontally long image,
   a first image and a second image being two images including areas of both end portions in a longitudinal direction of the horizontally long image, and
   a third image being an image including an area present between the both end portions.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a plurality of imaging units that are arranged, on a surface almost parallel to a display surface of a display unit, in a direction almost orthogonal to a long side of the display unit; and
a display control unit configured to control, in a state in which the long side of the display unit is almost parallel to a direction of gravitational force, the display unit to display a plurality of areas of a horizontally long image in a plurality of rows in a longitudinal direction of the display unit, the horizontally long image being obtained by connecting a plurality of images generated by the plurality of imaging units, the display control unit being configured to control the display unit to display, as the plurality of areas of the horizontally long image,
a first image and a second image being two images including areas of both end portions in a longitudinal direction of the horizontally long image, and
a third image being an image including an area present between the both end portions.

2. An information processing apparatus, comprising:
a plurality of imaging units that are housed in a second casing being a casing attached to a first casing that houses a display unit and rotatable about an axis of rotation almost parallel to a short side of the display unit, and that are arranged on a surface of the second casing in a direction almost parallel to the axis of rotation; and
a display control unit configured to control, in a state in which a long side of the display unit is almost parallel to a direction of gravitational force, the display unit to display a plurality of areas of a horizontally long image in a plurality of rows in a longitudinal direction of the display unit, the horizontally long image being obtained by connecting a plurality of images generated by the plurality of imaging units, the display control unit being configured to control the display unit to display, as the plurality of areas of the horizontally long image,
a first image and a second image being two images including areas of both end portions in a longitudinal direction of the horizontally long image, and
a third image being an image including an area present between the both end portions.

3. The information processing apparatus according to claim 1, wherein
the display control unit is configured to control the display unit to display the first image and the second image in the same row and the third image in another row.

4. The information processing apparatus according to claim 3, wherein
the display control unit is configured to control the display unit to display the third image in a row above a row in which the first image and the second image are displayed.

5. The information processing apparatus according to claim 3, wherein
the display unit is configured to control the display unit to display the first image to the third image such that the third image has a horizontal size larger than a horizontal size of each of the first image and the second image.

6. The information processing apparatus according to claim 1, wherein
the display control unit is configured to control the display unit to display an image in an area other than display areas of the first image to the third image, the image being obtained by reducing a whole of the horizontally long image.

7. The information processing apparatus according to claim 1, further comprising
an attitude detection unit configured to detect an attitude of the information processing apparatus, wherein
the display control unit is configured to control, when the long side of the display unit is almost perpendicular to the direction of gravitational force, the display unit to display the first image to the third image in a smaller number of rows than the number of rows when the long side of the display unit is almost parallel to the direction of gravitational force.

8. The information processing apparatus according to claim 1, wherein
the display control unit is configured to control, when controlling the display unit to display an image being a display target that has a ratio of a horizontal size to a vertical size smaller than a ratio of a horizontal size to a vertical size of the horizontally long image, the display unit to display the first image to the third image in a smaller number of rows than the number of rows when the horizontally long image is displayed.

9. The information processing apparatus according to claim 1, further comprising
a specific-target detection unit configured to detect a specific target included in the horizontally long image, wherein
the display control unit is configured to control the display unit to display an image including an area in which the detected specific target is present, as the third image.

10. The information processing apparatus according to claim 9, further comprising
a record control unit configured to record, when recording the horizontally long image, specific-target information on a recording medium in association with the horizontally long image, the specific-target information relating to the area in which the specific target is present, wherein
the display control unit is configured to control, when controlling the display unit to display the horizontally long image recorded on the recording medium, the display unit to display an image relating to the area in which the specific target is present using the specific-target information recorded in association with the horizontally long image.

11. The information processing apparatus according to claim 1, wherein
the display control unit is configured to control the display unit to display the third image while moving an area displayed as the third image from one end portion to the other end portion of the both end portions.

12. The information processing apparatus according to claim 1, further comprising
an operation receiving unit configured to receive a switching instruction operation from a user that relates to a display method for the third image, wherein
the display control unit is configured to select, based on the switching instruction operation, either one of
a display method of displaying the third image while moving an area displayed as the third image from one end portion to the other end portion of the both end portions, and
a display method of displaying a certain area as the third image without moving the area displayed as the third image, and to control the display unit to display the third image.

13. The information processing apparatus according to claim 12, wherein
when the display method for the third image is switched, a display method according to the switching is stored by the time a display of the third image based on the switching is completed, and
when the horizontally long image is newly displayed after the display of the third image based on the switching is completed, the third image in the horizontally long image is displayed using the stored display method.

14. The information processing apparatus according to claim 1, further comprising
an operation receiving unit configured to receive, when a reduced image obtained by reducing a whole of the horizontally long image is displayed in an area other than display areas of the first image to the third image, a designation operation for designating a position in the reduced image, wherein
the display control unit is configured to
control, if the third image is displayed by a display method of displaying the third image while moving an area displayed as the third image from one end portion to the other end portion of the both end portions when the designation operation is performed, the display unit to display an image including the position in the reduced image designated by the designation operation and a peripheral area thereof as a new third image, and perform a display of the third image while performing the movement with the position being a start point, and
control, if the third image is displayed by a display method of displaying a certain area as the third image without moving the area displayed as the third image when the designation operation is performed, the display unit to display an image including the position and a peripheral area thereof as a new third image.

15. The information processing apparatus according to claim 1, wherein
the display control unit is configured to
switch, during live view or during postview in accordance with a user operation, between
a first display method of displaying the third image with a position of the third image in the horizontally long image being fixed and
a second display method of displaying an image including an area in which a specific target included in the horizontally long image is present as the third image, and
switch, during reproduction in accordance with a user operation, between
a third display method of displaying the third image while moving an area displayed as the third image from one end portion to the other end portion of the both end portions and
the second display method.

16. The information processing apparatus according to claim 1, wherein
the display control unit is configured to
switch, during live view in accordance with a user operation, between
a first display method of displaying the third image with a position of the third image in the horizontally long image being fixed and
a second display method of displaying an image including an area in which a specific target included in the horizontally long image is present as the third image, and
switch, during postview or reproduction in accordance with a user operation, between
a third display method of displaying the third image while moving an area displayed as the third image from one end portion to the other end portion of the both end portions and
the second display method.

17. The information processing apparatus according to claim 1, wherein
the display control unit is configured to control, when the information processing apparatus is shipped from a factory or when a user uses the information processing apparatus, if an image display method by a live view operation of displaying an image generated by the imaging unit on the display unit before the user records the image, an image display method by a postview operation of displaying the recorded image on the display unit immediately after the user records the image, and an image display method by a reproduction operation of displaying an image specified by the user on the display unit are individually set, the display unit to display each image based on the setting.

18. A display apparatus, comprising:
a display unit configured to display an image; and
a display control unit configured to control, when controlling the display unit to display a horizontally long image in a state in which a long side of the display unit is almost parallel to a direction of gravitational force, the display unit to display a plurality of areas of the horizontally long image in a plurality of rows in a longitudinal direction of the display unit, the display control unit being configured to control the display unit to display, as the plurality of areas of the horizontally long image,
a first image and a second image being two images including areas of both end portions in a longitudinal direction of the horizontally long image, and
a third image being an image including an area present between the both end portions.

19. The display apparatus according to claim 18, wherein
the display control unit is configured to control the display unit to display the first image and the second image in the same row and the third image in another row.

20. The display apparatus according to claim 19, wherein
the display control unit is configured to control the display unit to display the third image in a row above a row in which the first image and the second image are displayed.

21. The display apparatus according to claim 19, wherein
the display unit is configured to control the display unit to display the first image to the third image such that the third image has a horizontal size larger than a horizontal size of each of the first image and the second image.

22. The display apparatus according to claim 18, wherein
the display control unit is configured to control the display unit to display an image in an area other than display areas of the first image to the third image, the image being obtained by reducing a whole of the horizontally long image.

23. The display apparatus according to claim 18, further comprising
an attitude detection unit configured to detect an attitude of the display apparatus, wherein
the display control unit is configured to control, when the long side of the display unit is almost perpendicular to the direction of gravitational force, the display unit to display the first image to the third image in a smaller number of rows than the number of rows when the long side of the display unit is almost parallel to the direction of gravitational force.

24. The display apparatus according to claim 18, wherein
the display control unit is configured to control, when controlling the display unit to display an image being a display target that has a ratio of a horizontal size to a vertical size smaller than a ratio of a horizontal size to a vertical size of the horizontally long image, the display unit to display the first image to the third image in a smaller number of rows than the number of rows when the horizontally long image is displayed.

25. A control method for an information processing apparatus, comprising:
an imaging procedure of generating a plurality of images by a plurality of imaging units that are arranged, on a surface almost parallel to a display surface of a display unit, in a direction almost orthogonal to a long side of the display unit; and
a display control procedure of controlling, in a state in which the long side of the display unit is almost parallel to a direction of gravitational force, the display unit to display a plurality of areas of a horizontally long image obtained by connecting the plurality of images, in a plurality of rows in a longitudinal direction of the display unit, the display control procedure including controlling the display unit to display, as the plurality of areas of the horizontally long image,
a first image and a second image being two images including areas of both end portions in a longitudinal direction of the horizontally long image, and
a third image being an image including an area present between the both end portions.

26. A program that causes a computer to execute:
an imaging procedure of generating a plurality of images by a plurality of imaging units that are arranged, on a surface almost parallel to a display surface of a display unit, in a direction almost orthogonal to a long side of the display unit; and
a display control procedure of controlling, in a state in which the long side of the display unit is almost parallel to a direction of gravitational force, the display unit to display a plurality of areas of a horizontally long image obtained by connecting the plurality of images, in a plurality of rows in a longitudinal direction of the display unit, the display control procedure including controlling the display unit to display, as the plurality of areas of the horizontally long image,
a first image and a second image being two images including areas of both end portions in a longitudinal direction of the horizontally long image, and
a third image being an image including an area present between the both end portions.
